(19) United States
(12) Patent Application Publication
(10) Pub. No.: US 2024/0276595 A1
(43) Pub. Date: Aug. 15, 2024

(54) SUPPORT FOR TRANSMITTER (TX) PROFILE BASED DEVICE-TO-DEVICE (D2D) COMMUNICATION

(71) Applicant: Telefonaktiebolaget LM Ericsson (publ), Stockholm (SE)

(72) Inventors: Ricardo Blasco Serrano, Espoo (FI); Min Wang, Luleå (SE); Zhang Zhang, Beijing (CN); Hieu Do, Järfälla (SE); Shehzad Ali Ashraf, Munich (DE); Antonino Orsino, Kirkkonummi (FI)

(21) Appl. No.: 18/566,125

(22) PCT Filed: Jun. 7, 2022
(86) PCT No.: PCT/CN2022/097303

§ 371 Date: Dec. 1, 2023

(30) Foreign Application Priority Data
Jun. 7, 2021 (WO) PCT/CN2021/098609
Jun. 9, 2021 (WO) PCT/EP2021/065500
Jun. 21, 2021 (WO) PCT/CN2021/101280
Aug. 4, 2021 (WO) PCT/CN2021/110625

(51) Int. Cl. H04W 76/28; H04W 28/02; H04W 92/18

(52) U.S. Cl. CPC H04W 76/28; H04W 28/0205; H04W 92/18

(57) ABSTRACT

The present disclosure is related to User Equipments (UEs) and methods at the UEs for Transmitter (TX) profile based sidelink (SL) communication. A method at a UE for SL communication comprises: determining whether SL Discontinuous Reception (DRX) is to be applied for the SL communication or not at least based on multiple associated TX profiles, at least one of the multiple associated TX profiles being mapped to a feature or a feature group; and performing the SL communication with or without the SL DRX applied at least based on the determination of whether the SL DRX is to be used for the SL communication or not.

### CROSS-REFERENCE TO RELATED APPLICATION(S)

This application claims priorities to (1) the PCT International Application No. PCT/CN2021/098609, entitled “SUPPORT FOR COMMUNICATION PROFILE BASED DEVICE-TO-DEVICE (D2D) COMMUNICATION”, filed on Jun. 7, 2021, (2) the PCT International Application No. PCT/EP2021/065500, entitled “TERMINAL DEVICE, NETWORK NODE, AND METHODS THEREIN FOR COEXISTENCE OF TERMINAL DEVICES”, filed on Jun. 9, 2021, (3) the PCT International Application No. PCT/CN2021/101280, entitled “TERMINAL DEVICE, NETWORK NODE, AND METHODS THEREIN FOR FACILITATING SIDELINK COMMUNICATION”, filed on Jun. 21, 2021, and (4) the PCT International Application No. PCT/CN2021/110625, entitled “METHOD AND APPARATUS FOR HANDLING USER EQUIPMENT COEXISTENCE”, filed on Aug. 4, 2021, which are incorporated herein by reference in their entireties.

### TECHNICAL FIELD

The present disclosure is related to the field of telecommunications, and in particular, to a user equipments (UEs) and methods performed by the UEs for supporting transmitter (TX) profile based device-to-device (D2D) communication.

### BACKGROUND

Networks have always been hierarchical in nature. Devices have connected to and communicated with one or more base stations ever since the birth of cellular communications. However, new technology enablers in 5G New Radio (NR) will allow devices to connect directly to one another using a technique called sidelink communications. Sidelink is the new communication paradigm in which cellular devices are able to communicate without relaying their data via the network. That means vehicles, robots, and even consumer gadgets could create their own ad hoc networks without using the radio access network as an intermediary.

In the past decade new types of cellular services that go beyond traditional mobile broadband have had a strong impact on the scoping and development of the 5G NR standard. These new cellular services were motivated by the business and economic needs of making the 3GPP ecosystem capable of supporting industrial requirements ranging from direct automotive communication between vehicles to industrial automation with Ultra-Reliable Low-Latency Communication (URLLC) for mission- and business-critical applications. However, these same technologies can also be used for consumers to enhance their communication experience. For instance, sidelink proximity services would allow devices to discover and communicate with one another at extremely high data rates and low latency, making them ideal for peer-to-peer gaming and streaming services as well as enhanced AR, VR, and other wearable device communications.

In contrast with uplink and downlink between a user equipment (UE) and a base station, where resource allocation and link adaptation are controlled by the network, in sidelink the device performs both functions autonomously. In other words, the device gains more control of how to use network resources. At the same time, it is expected that 3GPP upcoming Release will introduce support for sidelink-based relaying and that in future releases multi-link relay will also be considered. Sidelink is also a candidate for future releases as an Industrial Internet of Things (IoT) enabler. By restricting the communication link to one hop, latency is greatly reduced, which is key to mission-critical industrial applications. Furthermore, sidelink is a potential solution for public safety ensuring direct communication or relayed communication between devices.

Another potential use case is multi-hop relaying where multiple sidelink connections are used to leap from/to device to achieve less power consumption, overcome link budget constraints, and enhance latency and reliability. Gaming and entertainment services with AR/VR can also take advantage of sidelink, as will body networks, using direct 5G connections to replace the Bluetooth and eventually Wi-Fi links that currently connect these devices. The result could be a revolutionary change in the communication architecture for many consumer devices. Instead of providing a different radio interface for every use case, device vendors could rely solely on 5G as the link for wide-area, local-area, and personal-area communications.

### SUMMARY

According to an aspect of the present disclosure, a method at a UE for sidelink (SL) communication is provided. The method comprises: determining whether SL discontinuous reception (DRX) is to be applied for the SL communication or not at least based on multiple associated transmitter (TX) profiles, at least one of the multiple associated TX profiles being mapped to a feature or a feature group; and performing the SL communication with or without the SL DRX applied at least based on the determination of whether the SL DRX is to be used for the SL communication or not.

In some embodiments, when the UE is a TX UE in the SL communication, the step of determining whether SL DRX is to be applied for the SL communication or not at least based on multiple associated TX profiles comprises: determining whether the multiple associated TX profiles support the SL DRX or not; and determining that the SL DRX is to be applied for the SL communication in response to determining that all of the multiple associated TX profiles support the SL DRX. In some embodiments, when the UE is a TX UE in the SL communication, the step of determining whether SL DRX is to be applied for the SL communication or not at least based on multiple associated TX profiles comprises: determining whether the multiple associated TX profiles support the SL DRX or not; and determining that the SL DRX is not to be applied for the SL communication in response to determining that at least one of the multiple associated TX profiles does not support the SL DRX.

In some embodiments, when the UE is a Receiver (RX) UE in the SL communication, the step of determining whether SL DRX is to be applied for the SL communication or not at least based on multiple associated TX profiles comprises: determining whether multiple TX profiles that are associated with all service types and/or L2 identifiers (IDs) of interest support the SL DRX or not; and determining that the SL DRX is to be applied for the SL communication in response to determining that all of the multiple associated TX profiles support the SL DRX. In some embodiments, when the UE is an RX UE in the SL communication, the step of determining whether SL DRX is to be applied for the SL communication or not at least based on multiple associated TX profiles comprises: determining whether multiple TX profiles that are associated with all service types and/or L2 IDs of interest support the SL DRX or not; and determining that the SL DRX is not to be applied for the SL communication in response to determining that at least one of the multiple associated TX profiles does not support the SL DRX. In some embodiments, the SL communication is SL groupcast communication or SL broadcast communication.

In some embodiments, each of the multiple associated TX profiles indicates at least one of: a unique index and/or ID associated with the communication profile; one or more service types and/or traffic types; one or more L2 destination IDs; one or more L2 source IDs; one or more indices or indicators of one or more Third Generation Partnership Project (3GPP) releases; one or more SL feature groups and/or functionalities; one or more transmission parameters; one or more hybrid automatic repeat request (HARQ) retransmission modes; one or more resource pool identifiers; one or more cast types; one or more indices and/or IDs of one or more logical channels; one or more indices and/or IDs of one or more logical channel groups; one or more indices and/or IDs of one or more radio bearers; one or more service priority levels and/or traffic priority levels; one or more Quality of Service (QoS) indicators and/or requirements; and a priority level associated with the communication profile.

In some embodiments, a service type of the SL communication is mapped to at least one of the multiple TX profiles. In some embodiments, the service type is at least one of: Vehicle-to-Everything (V2X); and Proximity Service (ProSe). In some embodiments, the multiple associated TX profiles comprises at least one of: one or more TX profiles indicated by an upper layer to an access stratum (AS) layer at the UE; one or more TX profiles that are received by the UE from another UE for the D2D communication; and one or more TX profiles that are received by the UE from a network node for the D2D communication.

According to an aspect of the present disclosure, a UE is provided. The UE comprises: a processor; a memory storing instructions which, when executed by the processor, cause the processor to perform any of the methods of the above aspect.

According to an aspect of the present disclosure, a computer program comprising instructions is provided. The instructions, when executed by at least one processor, cause the at least one processor to carry out the method of the above aspect.

According to an aspect of the present disclosure, a carrier containing the computer program of the above aspect is provided. In some embodiments, the carrier is one of an electronic signal, an optical signal, a radio signal, or computer readable storage medium.

According to an aspect of the present disclosure, a method at a user equipment (UE) for device-to-device (D2D) communication is provided. The method comprises: determining at least one configuration or parameter for the D2D communication at least partially based on multiple communication profiles that the UE is intended to use for the D2D communication; and performing the D2D communication at least partially based on the at least one determined configuration or parameter.

In some embodiments, each of the multiple communication profiles corresponds to one of multiple service types. In some embodiments, each of the communication profiles comprises at least one of: —a unique index and/or identifier (ID) associated with the communication profile; —one or more service types and/or traffic types; —one or more L2 destination IDs; —one or more L2 source IDs; —one or more indices or indicators of one or more Third Generation Partnership Project (3GPP) releases; —one or more indices or indicators of one or more 3GPP features and/or functionalities; —one or more transmission parameters; —one or more hybrid automatic repeat request (HARQ) retransmission modes; —one or more resource pool identifiers; —one or more cast types; one or more indices and/or IDs of one or more logical channels; —one or more indices and/or IDs of one or more logical channel groups; —one or more indices and/or IDs of one or more radio bearers; —one or more service priority levels and/or traffic priority levels; —one or more Quality of Service (QoS) indicators and/or requirements; and —a priority level associated with the communication profile.

In some embodiments, the step of determining at least one configuration or parameter for the D2D communication comprises: for each of the at least one configuration or parameter, determining whether the configuration or parameter is compatible with each of the multiple communication profiles or not; and setting the configuration or parameter to indicate that a corresponding feature of the UE is disabled in response to determining that the configuration or parameter is not compatible with at least one of the multiple communication profiles. In some embodiments, the step of determining at least one configuration or parameter for the D2D communication comprises: for each of the at least one configuration or parameter, determining whether the configuration or parameter is compatible with each of the multiple communication profiles or not; and setting the configuration or parameter to indicate that the corresponding feature of the UE is enabled in response to determining that the configuration or parameter is compatible with all of the multiple communication profiles.

In some embodiments, the multiple communication profiles comprise at least one of: —all or a subset of the communication profiles that are intended to be used by the UE for the D2D communication; —all or a subset of the communication profiles that are configured at the UE for the D2D communication; and—all or a subset of the communication profiles that are received by the UE from another UE for the D2D communication. In some embodiments, the multiple communication profiles comprise at least one of: one or more first communication profiles related to both D2D transmission and D2D reception, one or more second communication profiles related to D2D reception only, and one or more third communication profiles related to D2D transmission only. In some embodiments, the at least one configuration or parameter comprises at least one of: —a first configuration of whether a sidelink (SL) communication feature can be enabled for the UE as both a receiver and a transmitter; —a second configuration of whether the SL communication feature can be enabled for the UE as a receiver only; and—a third configuration of whether the SL communication feature can be enabled for the UE as a transmitter only.

In some embodiments, the step of determining at least one configuration or parameter for the D2D communication comprises at least one of: determining the first configuration at least partially based on determining whether the SL communication feature is compatible with each of the multiple communication profiles; determining the second configuration at least partially based on determining whether the SL communication feature is compatible with each of the first and second communication profiles; determining the third configuration at least partially based on determining whether the SL communication feature is compatible with each of the first and third communication profiles. In some embodiments, when the at least one configuration or parameter comprises the first configuration, before the step of performing the D2D communication at least partially based on the at least one determined configuration or parameter, the method further comprises: receiving an indicator indicating a configuration of the SL communication feature of another UE for its D2D communication with the UE or not, wherein the step of performing the D2D communication at least partially based on the at least one determined configuration or parameter comprises one of: at least partially in response to determining that the received indicator indicates that the SL communication feature is enabled at the other UE and that the first configuration indicates that the SL communication feature can be enabled, performing the D2D communication between the UE and the other UE with the SL communication feature enabled; and in response to determining that the received indicator indicates that the SL communication feature is not enabled at the other UE and/or that the first configuration indicates that the SL communication feature cannot be enabled, performing the D2D communication between the UE and the other UE with the SL communication feature disabled.

In some embodiments, when the at least one configuration or parameter comprises the second configuration, before the step of performing the D2D communication at least partially based on the at least one determined configuration or parameter, the method further comprises: receiving an indicator indicating a configuration of the SL communication feature of another UE for the D2D communication to be transmitted to the UE or not, wherein the step of performing the D2D communication at least partially based on the at least one determined configuration or parameter comprises one of: at least partially in response to determining that the received indicator indicates that the SL communication feature is enabled at the other UE and that the second configuration indicates that the SL communication feature can be enabled, performing the D2D communication from the other UE to the UE with the SL communication feature enabled; and in response to determining that the received indicator indicates that the SL communication feature is not enabled at the other UE and/or that the second configuration indicates that the SL communication feature cannot be enabled, performing the D2D communication from the other UE to the UE with the SL communication feature disabled.

In some embodiments, when the at least one configuration or parameter comprises the third configuration, before the step of performing the D2D communication at least partially based on the at least one determined configuration or parameter, the method further comprises: receiving an indicator indicating a configuration of the SL communication feature of another UE for the D2D communication to be transmitted from the UE or not, wherein the step of performing the D2D communication at least partially based on the at least one determined configuration or parameter comprises one of: at least partially in response to determining that the received indicator indicates that the SL communication feature is enabled at the other UE and that the third configuration indicates that the SL communication feature can be enabled, performing the D2D communication from the UE to the other UE with the SL communication feature enabled; and in response to determining that the received indicator indicates that the SL communication feature is not enabled at the other UE and/or that the third configuration indicates that the SL communication feature cannot be enabled, performing the D2D communication from the UE to the other UE with the SL communication feature disabled.

In some embodiments, the received indicator indicates whether the other UE is intended to use the SL communication feature or not. In some embodiments, the received indicator indicates whether the other UE is allowed to use the SL communication feature or not. In some embodiments, the SL communication feature comprises at least one of: —SL discontinuous reception (DRX); and—partial sensing.

In some embodiments, the at least one configuration or parameter corresponds to all or a subset of features to be used by the UE for D2D communication. In some embodiments, the multiple communication profiles comprise none of the first and the third communication profiles. In some embodiments, the step of determining at least one configuration or parameter for the D2D communication comprises: receiving, from a network node, the at least one configuration or parameter. In some embodiments, before the step of receiving, from a network node, the at least one configuration or parameter, the method further comprises transmitting, to the network node, at least one of: —a list of service types that are intended to be used by the UE for the D2D communication; —a list of corresponding communication profiles; and—a list of corresponding destinations.

According to an aspect of the present disclosure, a method at a user equipment (UE) for device-to-device (D2D) communication is provided. The method comprises: determining whether first data associated with a first communication profile can be multiplexed with second data associated with a second communication profile, which is different from the first communication profile, in a same packet at least partially based on the first and second communication profiles; and transmitting the first data and the second data that are multiplexed in the same packet in response to determining that the first data can be multiplexed with the second data in the same packet.

In some embodiments, each of the first and second communication profiles comprises at least one of: —a unique index and/or identifier (ID) associated with the communication profile; —one or more service types and/or traffic types; —one or more L2 destination IDs; —one or more L2 source IDs; —one or more indices or indicators of one or more Third Generation Partnership Project (3GPP) releases; —one or more indices or indicators of one or more 3GPP features and/or functionalities; —one or more transmission parameters; —one or more hybrid automatic repeat request (HARQ) retransmission modes; —one or more resource pool identifiers; —one or more cast types; —one or more indices and/or IDs of one or more logical channels; —one or more indices and/or IDs of one or more logical channel groups; —one or more indices and/or IDs of one or more radio bearers; —one or more service priority levels and/or traffic priority levels; —one or more Quality of Service (QoS) indicators and/or requirements; and—a priority level associated with the communication profile.

In some embodiments, the step of determining whether the first data can be multiplexed with the second data in the same packet or not comprises: determining whether the first data can be multiplexed with the second data in the same packet or not based on all the communication profiles that are associated with data to be multiplexed with the first and second data in the same packet. In some embodiments, the step of determining whether the first data can be multiplexed with the second data in the same packet or not comprises: determining a set of common features enabled by all the communication profiles; and determining whether there is a third communication profile that is compatible with the determined set of common features and not compatible with rest of all the features if any; and determining that the first data can be multiplexed with the second data in the same packet in response to determining that there is the third communication profile.

In some embodiments, the step of determining a set of common features enabled by all the communication profiles comprises: for each of the features enabled by at least one of all the communication profiles, determining whether the feature is enabled or not by all the communication profiles explicitly or implicitly; and determining the feature is a common feature in response to determining that the feature is enabled by all the communication profiles explicitly or implicitly. In some embodiments, the method further comprises: in response to determining that there are multiple third communication profiles, selecting one of the multiple third communication profiles at least partially based on their priority levels. In some embodiments, the step of selecting one of the third communication profiles at least partially based on their priority levels comprises: selecting one of the multiple third communication profiles that has the highest priority level and that is associated with at least one of: —a specific service type; —a specific traffic type; —a specific logical channel (LCH); and—a specific logical channel group (LCG).

In some embodiments, the method further comprises: transmitting the first data and the second data separately in response to determining that there is no third communication profile. In some embodiments, the step of determining whether the first data can be multiplexed with the second data in the same packet or not comprises: determining whether each of the first and second communication profiles is compatible with a fourth communication profile associated with the same packet or not; and determining that the first data can be multiplexed with the second data in the same packet in response to determining that both the first and second communication profiles are compatible with the fourth communication profile; and determining that the first data cannot be multiplexed with the second data in the same packet in response to determining that at least one of the first and second communication profiles is not compatible with the fourth communication profile. In some embodiments, the fourth communication profile is determined by a network node, the UE, or another UE.

In some embodiments, after the step of determining a set of common features enabled by all the communication profiles and before the step of determining whether there is a third communication profile, the method further comprises: for each of the set of common features, determining whether the feature is comprised by a predefined or preconfigured set of features; and removing the feature from the set of common features in response to determining that the feature is not comprised by the predefined or preconfigured set of features. In some embodiments, the predefined or preconfigured set of features is at least one of: —a set of features from a specific 3GPP release; and—a set of features specified as part of a configuration or pre-configuration for a carrier, a cell, and/or a pool.

In some embodiments, before the step of determining whether the first data can be multiplexed with the second data in the same packet or not, the method further comprises: receiving a configuration or a pre-configuration indicating how to select a communication profile for the packet; and selecting a communication profile for the packet, wherein the step of determining whether the first data can be multiplexed with the second data in the packet or not is performed further based on the selected communication profile. In some embodiments, the configuration or a pre-configuration is received from one of a base station, a core network entity, and another controlling UE.

According to an aspect of the present disclosure, a method at a user equipment (UE) for device-to-device (D2D) communication is provided. The method comprises: configuring, at the UE, multiple communication profiles that the UE is intended to use for the D2D communication; and performing the D2D communication at least partially based on one of the multiple communication profiles.

In some embodiments, each of the multiple communication profiles comprises at least one of following parameters or information elements (IEs): —a unique index and/or identifier (ID) associated with the communication profile; —one or more service types and/or traffic types; —one or more L2 destination IDs; —one or more L2 source IDs; —one or more indices or indicators of one or more Third Generation Partnership Project (3GPP) releases; —one or more indices or indicators of one or more 3GPP features and/or functionalities; —one or more transmission parameters; —one or more hybrid automatic repeat request (HARQ) retransmission modes; —one or more resource pool identifiers; —one or more cast types; —one or more indices and/or IDs of one or more logical channels; —one or more indices and/or IDs of one or more logical channel groups; —one or more indices and/or IDs of one or more radio bearers; —one or more service priority levels and/or traffic priority levels; —one or more Quality of Service (QoS) indicators and/or requirements; and—a priority level associated with the communication profile. In some embodiments, a communication profile is identified by at least one of its parameters, at least one of its information elements (IEs), or any combination thereof.

In some embodiments, a communication profile is mapped to at least one of its parameters, at least one of its information elements (IEs), or any combination thereof.

In some embodiments, before the step of configuring, at the UE, multiple communication profiles that the UE is intended to use for the D2D communication, the method comprises: receiving at least one of the multiple communication profiles from at least one of a base station, a core network (CN) entity, and a controlling UE. In some embodiments, the reception of the at least one communication profile is performed via at least one of: —system information; —dedicated radio resource control (RRC) signaling; —a medium access control (MAC) control element (CE); —L1 signaling; and—a control protocol data unit (PDU) of a protocol layer.

In some embodiments, the step of configuring, at the UE, multiple communication profiles is performed in a provisioning procedure or in the UE's manufacture stage. In some embodiments, before the step of performing the D2D communication at least partially based on one of the multiple communication profiles, the method further comprises: determining the one communication profile for the D2D communication when a packet or PDU is initiated for the D2D communication. In some embodiments, the step of determining the one communication profile comprises at least one of: —determining the communication profile based on a static configuration or a pre-configuration at the UE; —receiving, from a base station, an indicator indicating the communication profile to be used for the D2D communication; —receiving, from a controlling UE, an indicator indicating the communication profile to be used for the D2D communication; —receiving, from a CN entity, an indicator indicating the communication profile to be used for the D2D communication; and—determining the communication profile by the UE itself.

In some embodiments, the step of determining the one communication profile comprises determining the one communication profile based on at least one of: —one or more service types and/or traffic types associated with the packet or PDU; —one or more L2 IDs associated with the packet or PDU; —one or more 3GPP releases associated with the packet or PDU; —one or more 3GPP features associated with the packet or PDU; —one or more cast types associated with the packet or PDU; and—one or more LCHs, LCGs, and/or resource blocks (RBs) associated with the packet or PDU.

In some embodiments, after the step of determining the one communication profile for the D2D communication and before the step of performing the D2D communication at least partially based on one of the multiple communication profiles, the method further comprises: signaling another UE of the determined communication profile via at least one of: —RRC signaling; —a MAC CE; —L1 signaling; and—a control protocol data unit (PDU) of a protocol layer. In some embodiments, the step of performing the D2D communication at least partially based on one of the multiple communication profiles comprises: transmitting the packet or the PDU together with an indicator indicating the communication profile determined for the transmission of the packet or the PDU.

In some embodiments, before the step of performing the D2D communication at least partially based on one of the multiple communication profiles, the method further comprises: receiving, from another UE, a packet or PDU together with an indicator indicating one of the multiple communication profiles that is determined by the other UE for the transmission of the packet or the PDU; and transmitting, to the other UE, a response message corresponding to the received packet or PDU at least partially based on the indicated communication profile.

According to an aspect of the present disclosure, a user equipment (UE) is provided. The UE comprises: a processor; a memory storing instructions which, when executed by the processor, cause the processor to perform any of the methods of one or more of the above aspects.

According to an aspect, a computer program comprising instructions is provided. The instructions, when executed by at least one processor, cause the at least one processor to carry out any of the methods of one or more of the above aspects.

According to an aspect, a carrier containing the computer program of the above aspect, wherein the carrier is one of an electronic signal, optical signal, radio signal, or computer readable storage medium.

It is an object of the present disclosure to provide a terminal device, a network node, and methods therein, capable of allowing for coexistence of terminal devices having different 3GPP releases or features, particularly for sidelink communications.

According to an aspect of the present disclosure, a method in a first terminal device is provided. The method includes: transmitting, to a second terminal device, a first message for establishing a sidelink connection with the second terminal device. The first message contains first information indicating a capability of the first terminal device for sidelink communication.

In an embodiment, the first information may indicate one or more of: a transmission format or 3GPP release the first terminal device supports, a list of sidelink features the first terminal device supports, a list of sidelink features the first terminal device wishes to use, or a list of sidelink features the first terminal device is currently using.

In an embodiment, the method may further include: receiving, from the second terminal device, a second message as a response to the first message. The second message may contain second information indicating a capability of the second terminal device for sidelink communication.

In an embodiment, the second information may indicate one or more of: a transmission format or 3GPP release the second terminal device supports, a list of sidelink features the second terminal device supports, a list of sidelink features the second terminal device wishes to use, a list of sidelink features the second terminal device is currently using, or a list of sidelink features the first terminal device and the second terminal device both support, wish to use, and/or are currently using.

In an embodiment, the method may further include: determining a sidelink configuration based on the capability of the first terminal device for sidelink communication and the capability of the second terminal device for sidelink communication; and transmitting the sidelink configuration to the second terminal device.

In an embodiment, the method may further include: transmitting a request for a sidelink configuration to a network node, the request containing the first information and the second information; receiving the sidelink configuration from the network node; and transmitting the sidelink configuration to the second terminal device.

In an embodiment, the request may be transmitted, and/or the sidelink configuration may be received, via: Radio Resource Control (RRC) signaling, Medium Access Control (MAC) Control Element (CE), or Layer 1 (L1) signaling.

In an embodiment, the method may further include: receiving a sidelink configuration from the second terminal device.

In an embodiment, the sidelink features may include sidelink Discontinuous Reception (DRX).

In an embodiment, the method may further include: receiving, from a network node, an instruction to include the first information in the first message.

In an embodiment, the first message may be transmitted to the second terminal device via: PC5-RRC signaling, PC5-Signaling (PC5-S), discovery signaling, MAC CE, or L1 signaling.

According to an aspect of the present disclosure, a method in a second terminal device is provided. The method includes: receiving, from a first terminal device, a first message for establishing a sidelink connection with the second terminal device. The first message contains first information indicating a capability of the first terminal device for sidelink communication.

In an embodiment, the first information may indicate one or more of: a transmission format or 3GPP release the first terminal device supports, a list of sidelink features the first terminal device supports, a list of sidelink features the first terminal device wishes to use, or a list of sidelink features the first terminal device is currently using.

In an embodiment, the method may further include: transmitting, to the first terminal device, a second message in response to the first message. The second message contains second information indicating a capability of the second terminal device for sidelink communication.

In an embodiment, the second information may indicate one or more of: a transmission format or 3GPP release the second terminal device supports, a list of sidelink features the second terminal device supports, a list of sidelink features the second terminal device wishes to use, a list of sidelink features the second terminal device is currently using, or a list of sidelink features the first terminal device and the second terminal device both support, wish to use, and/or are currently using.

In an embodiment, the method may further include: discarding the first message when the second terminal device does not support the transmission format or 3GPP release the first terminal device supports, or when there is no sidelink capability or feature the first terminal device and the second terminal device both support, wish to use, and/or are currently using.

In an embodiment, the method may further include: determining a sidelink configuration based on the capability of the first terminal device for sidelink communication and the capability of the second terminal device for sidelink communication; and transmitting the sidelink configuration to the first terminal device.

In an embodiment, the method may further include: transmitting a request for a sidelink configuration to a network node, the request containing the first information and the second information; receiving the sidelink configuration from the network node; and transmitting the sidelink configuration to the first terminal device.

In an embodiment, the request may be transmitted, and/or the sidelink configuration may be received, via: RRC signaling, MAC CE, or L1 signaling.

In an embodiment, the method may further include: receiving a sidelink configuration from the first terminal device.

In an embodiment, the method may further include: receiving, from a network node, an instruction to include the second information in the second message.

In an embodiment, the method may further include: identifying the capability of the first terminal device for sidelink communication by using an Abstract Syntax Notation One (ASN.1) decoder to decode all information on 3GPP releases and/or sidelink features supported by the first terminal device in the first message.

In an embodiment, the sidelink features may include sidelink DRX.

In an embodiment, the first message may be received from the first terminal device via: PC5-RRC signaling, PC5-S, discovery signaling, MAC CE, or L1 signaling.

According to an aspect of the present disclosure, a method in a network node is provide. The method includes: receiving, from a first terminal device or a second terminal device, a request for a sidelink configuration, the request containing first information indicating a capability of the first terminal device for sidelink communication and second information indicating a capability of the second terminal device for sidelink communication; determining the sidelink configuration based on the capability of the first terminal device for sidelink communication and the capability of the second terminal device for sidelink communication; and transmitting the sidelink configuration to the first terminal device or the second terminal device.

In an embodiment, the first information may indicate one or more of: a transmission format or 3GPP release the first terminal device supports, a list of sidelink features the first terminal device supports, a list of sidelink features the first terminal device wishes to use, or a list of sidelink features the first terminal device is currently using. The second information may indicate one or more of: a transmission format or 3GPP release the second terminal device supports, a list of sidelink features the second terminal device supports, a list of sidelink features the second terminal device wishes to use, or a list of sidelink features the second terminal device is currently using.

In an embodiment, the sidelink features may include sidelink DRX.

In an embodiment, the request may be received, and/or the sidelink configuration may be transmitted, via: RRC signaling, MAC CE, or L1 signaling.

According to an aspect of the present disclosure, a method in a first terminal device is provided. The method includes: transmitting, to a network node, a request for a sidelink configuration; and receiving, from the network node, the sidelink configuration based on a capability of the first terminal device for sidelink communication.

In an embodiment, the capability of the first terminal device for sidelink communication may include one or more of: a transmission format or 3GPP release the first terminal device supports, a list of sidelink features the first terminal device supports, a list of sidelink features the first terminal device wishes to use, or a list of sidelink features the first terminal device is currently using.

In an embodiment, the sidelink configuration may configure only the sidelink features the first terminal device supports, wishes to use, and/or is currently using.

In an embodiment, the sidelink configuration may configure a resource pool used by one or more second terminal devices supporting the same transmission format or 3GPP release as the first terminal device and/or supporting, wishing to use, and/or being currently using the same sidelink features as the first terminal device.

In an embodiment, the sidelink configuration may configure the first terminal device to perform sidelink communication with only one or more second terminal devices in a proximity of the first terminal device that support the same transmission format or 3GPP release as the first terminal device and/or support, wish to use, and/or are currently using the same sidelink features as the first terminal device.

In an embodiment, the method may further include: receiving, from the network node, an indication of a transmission format or 3GPP release or one or more features for use by the first terminal device to establish a sidelink connection with one or more second terminal devices.

In an embodiment, the request may be transmitted, and/or the sidelink configuration may be received, via: RRC signaling, MAC CE, or L1 signaling.

According to an aspect of the present disclosure, a method in a network node is provided. The method includes: receiving, from a first terminal device, a request for a sidelink configuration; and transmitting, to the first terminal device, the sidelink configuration based on a capability of the first terminal device for sidelink communication.

In an embodiment, the capability of the first terminal device for sidelink communication may include one or more of: a transmission format or 3GPP release the first terminal device supports, a list of sidelink features the first terminal device supports, a list of sidelink features the first terminal device wishes to use, or a list of sidelink features the first terminal device is currently using.

In an embodiment, the sidelink configuration may configure only the sidelink features the first terminal device supports, wishes to use, and/or is currently using.

In an embodiment, the sidelink configuration may configure a resource pool used by one or more second terminal devices supporting the same transmission format or 3GPP release as the first terminal device and/or supporting, wishing to use, and/or being currently using the same sidelink features as the first terminal device.

In an embodiment, the sidelink configuration may configure the first terminal device to perform sidelink communication with only one or more second terminal devices in a proximity of the first terminal device that support the same transmission format or 3GPP release as the first terminal device and/or support, wish to use, and/or are currently using the same sidelink features as the first terminal device.

In an embodiment, the method may further include: transmitting, to the first terminal device, an indication of a transmission format or 3GPP release or one or more features for use by the first terminal device to establish a sidelink connection with one or more second terminal devices.

In an embodiment, the request may be received, and/or the sidelink configuration may be transmitted, via: RRC signaling, MAC CE, or L1 signaling.

According to an aspect of the present disclosure, a method in a first terminal device is provided. The method includes: transmitting, to a second terminal device, a first message for establishing a sidelink connection with the second terminal device, using a transmission format or 3GPP release and/or one or more sidelink features.

In an embodiment, the method may further include: receiving, from a network node, an indication of the transmission format or 3GPP release and/or the one or more sidelink features for use by the first terminal device to transmit the first message.

In an embodiment, the indication may be received via: dedicated RRC signaling, system information, MAC CE, control Protocol Data Unit (PDU) of a protocol layer, paging signaling, or L1 signaling.

In an embodiment, the transmission format or 3GPP release may be a preconfigured default transmission format or 3GPP release, and/or the one or more sidelink features may be one or more preconfigured default sidelink features.

In an embodiment, the first message may be transmitted to the second terminal device via: PC5-RRC signaling, PC5-S, discovery signaling, MAC CE, or L1 signaling.

According to an aspect of the present disclosure, a method in a second terminal device is provided. The method includes: receiving, from a first terminal device, a first message for establishing a sidelink connection with the second terminal device; and transmitting, to the first terminal device, a second message in response to the first message, using a transmission format or 3GPP release and/or one or more sidelink features.

In an embodiment, the method may further include: receiving, from a network node, an indication of the transmission format or 3GPP release and/or the one or more sidelink features for use by the second terminal device to transmit the second message.

In an embodiment, the indication may be received via: dedicated RRC signaling, system information, MAC CE, control PDU of a protocol layer, paging signaling, or L1 signaling.

In an embodiment, the transmission format or 3GPP release may be a preconfigured default transmission format or 3GPP release, and/or the one or more sidelink features may be one or more preconfigured default sidelink features.

In an embodiment, the first message may be received from the first terminal device, and/or the second message may be transmitted to first terminal device, via: PC5-RRC signaling, PC5-S, discovery signaling, MAC CE, or L1 signaling.

According to an aspect of the present disclosure, a method in a network node is provided. The method includes: transmitting, to a first terminal device, an indication of a transmission format or 3GPP release and/or one or more sidelink features for use by the first terminal device to transmit a message for establishing a sidelink connection.

In an embodiment, the transmission format or 3GPP release and/or the one or more sidelink features may be determined and/or updated based on one or more of: a presence of the first terminal device in a coverage of the network node, a service or traffic to be transmitted by the first terminal device over the sidelink connection, a Quality of Service (QoS) associated with the service or traffic, or a transmission format or 3GPP release and/or one or more sidelink features supported by the network node.

In an embodiment, the indication may be transmitted via: dedicated RRC signaling, system information, MAC CE, control PDU of a protocol layer, paging signaling, or L1 signaling.

According to an aspect of the present disclosure, a method in a network node is provided. The method includes: transmitting to a second terminal device, an indication of a transmission format or 3GPP release and/or one or more sidelink features for use by the second terminal device to respond to a message for establishing a sidelink connection.

In an embodiment, the transmission format or 3GPP release and/or the one or more sidelink features may be determined and/or updated based on one or more of: a presence of the second terminal device in a coverage of the network node, a service or traffic to be received by the second terminal device over the sidelink connection, a QoS associated with the service or traffic, or a transmission format or 3GPP release and/or one or more sidelink features supported by the network node.

In an embodiment, the indication may be transmitted via: dedicated RRC signaling, system information, MAC CE, control PDU of a protocol layer, paging signaling, or L1 signaling.

According to an aspect of the present disclosure, a first terminal device is provided. The first terminal device includes a transceiver, a processor, and a memory.

The memory contains instructions executable by the processor whereby the first terminal device is operative to perform one or more of the above aspects.

According to an aspect of the present disclosure, a computer readable storage medium is provided. The computer readable storage medium has computer program instructions stored thereon. The computer program instructions, when executed by a processor in a first terminal device, cause the first terminal device to perform one or more of the above aspects.

According to an aspect of the present disclosure, a second terminal device is provided. The second terminal device includes a transceiver, a processor, and a memory.

The memory contains instructions executable by the processor whereby the second terminal device is operative to perform one or more of the above aspects.

According to an aspect of the present disclosure, a computer readable storage medium is provided. The computer readable storage medium has computer program instructions stored thereon. The computer program instructions, when executed by a processor in a second terminal device, cause the second terminal device to perform one or more of the above aspects.

According to an aspect of the present disclosure, a network node is provided.

The network node includes a transceiver, a processor, and a memory. The memory contains instructions executable by the processor whereby the network node is operative to perform one or more of the above aspects.

According to an aspect of the present disclosure, a computer readable storage medium is provided. The computer readable storage medium has computer program instructions stored thereon. The computer program instructions, when executed by a processor in a network node, cause the network node to perform one or more of the above aspects.

With some embodiments of the present disclosure, a terminal device may include information indicating a capability of the terminal device for sidelink communication in a message for establishing a sidelink connection with another terminal device. Alternatively, a terminal device may request from a network node a sidelink configuration based on a capability of the terminal device for sidelink communication. Alternatively, a terminal device may transmit a message for establishing a sidelink connection with another terminal device, using a transmission format or 3GPP release and/or one or more sidelink features. In any case, it is possible to generate a sidelink configuration for sidelink communication between terminal devices having different sidelink capabilities (e.g., different 3GPP releases or sidelink features) properly, thereby allowing for coexistence of the terminal devices.

It is an object of the present disclosure to provide a terminal device, a network node, and methods therein, capable of improving sidelink communication performance based on sidelink features supported and/or applied by terminal devices.

According to an aspect of the present disclosure, a method in a terminal device is provided. The method includes: determining whether to apply a sidelink feature for a service or signaling message based on at least one of: a transmit profile corresponding to a service type of the service, and whether the terminal device has been configured or preconfigured with at least one configuration of the sidelink feature for the service or signaling message.

In an embodiment, the operation of determining may include: determining to apply the sidelink feature when the transmit profile indicates that the sidelink feature is to be applied to the service or signaling message, and the terminal device has been configured or preconfigured with the at least one configuration of the sidelink feature for the service or signaling message, or determining not to apply the sidelink feature when the transmit profile indicates that the sidelink feature is not to be applied to the service or signaling message, and the terminal device has not been configured or preconfigured with the at least one configuration of the sidelink feature for the service or signaling message.

In an embodiment, the operation of determining may include: determining to apply the sidelink feature when the terminal device has been configured or preconfigured with the at least one configuration of the sidelink feature for the service or signaling message, regardless of whether the transmit profile indicates that the sidelink feature is to be applied to the service or signaling message.

In an embodiment, the method may further include: receiving, from a network node, an indication to apply the sidelink feature when the terminal device has been configured or preconfigured with the at least one configuration of the sidelink feature for the service or signaling message, regardless of whether the transmit profile indicates that the sidelink feature is to be applied to the service or signaling message.

In an embodiment, the method may further include, subsequent to determining to apply the sidelink feature for the service or signaling message: prioritizing a first sidelink transmission of the service or signaling message over a second sidelink transmission of another service or signaling message to which the sidelink feature is not applied.

In an embodiment, the operation of prioritizing may include: allocating a resource to a first destination of the first sidelink transmission with a higher priority than a second destination of the second sidelink transmission.

In an embodiment, the operation of prioritizing may include: allocating a resource to a first Sidelink Logic Channel (SLCH) for the first sidelink transmission with a higher priority than a second SLCH for the second sidelink transmission.

In an embodiment, the operation of prioritizing may include: applying a negative offset to a first SLCH priority of a first SLCH for the first sidelink transmission, and/or applying a positive offset to a second SLCH priority of a second SLCH for the second sidelink transmission.

In an embodiment, the negative offset and/or the positive offset may be preconfigured or configured by a network node.

In an embodiment, the sidelink feature may include sidelink DRX, and/or the at least one configuration of the sidelink feature may include at least one sidelink DRX configuration.

In an embodiment, the service may include a groupcast or broadcast service, or the signaling message may include a discovery message, a request for establishing a sidelink unicast connection, or a response to the request.

According to an aspect of the present disclosure, a terminal device is provided. The terminal device includes a transceiver, a processor, and a memory. The memory contains instructions executable by the processor whereby the terminal device is operative to perform the method according to the above aspect.

According to an aspect of the present disclosure, a computer readable storage medium is provided. The computer readable storage medium has computer program instructions stored thereon. The computer program instructions, when executed by a processor in a terminal device, cause the terminal device to perform the method according to the above aspect.

According to an aspect of the present disclosure, a method in a first terminal device is provided. The method includes: transmitting, to a second terminal device, an indication of whether a sidelink feature is supported or applied by the first terminal device for a service or signaling message.

In an embodiment, the indication may be carried in: Sidelink Control Information (SCI), a Sidelink Shared Channel (SL-SCH) Medium Access Control (MAC) header, a MAC Control Element (CE), PC5-RRC signaling, PC5-Signaling (PC5-S), or a control Protocol Data Unit (PDU) of a protocol layer.

In an embodiment, the MAC CE may be transmitted when the first terminal device joins a connection-oriented group, in response to a request from the second terminal device, or periodically, the PC5-RRC signaling may be transmitted by means of unicast, groupcast, or broadcast, or the protocol layer may include Service Data Application Protocol (SDAP), Packet Data Convergence Protocol (PDCP), Radio Link Control (RLC), or an adaptation layer when the indication is transmitted via a sidelink relay.

In an embodiment, the indication may be per service type, per application type, per traffic type, or per signaling message type.

In an embodiment, the indication may be contained in a bitmap having a plurality of bits each associated with a service type, an application type, a traffic type, or a signaling message type.

In an embodiment, the sidelink feature may include sidelink DRX, and the indication may include a DRX Command MAC CE implicitly indicating that the sidelink DRX is applied by the first terminal device.

In an embodiment, the sidelink feature may include sidelink DRX.

In an embodiment, the service may include a groupcast or broadcast service, or the signaling message may include a discovery message, a request for establishing a sidelink unicast connection, or a response to the request.

In an embodiment, the indication may be transmitted via another terminal device serving as a group header in groupcast communication.

According to an aspect of the present disclosure, a first terminal device is provided. The first terminal device includes a transceiver, a processor, and a memory. The memory contains instructions executable by the processor whereby the first terminal device is operative to perform the method according to the above aspect.

According to an aspect of the present disclosure, a computer readable storage medium is provided. The computer readable storage medium has computer program instructions stored thereon. The computer program instructions, when executed by a processor in a first terminal device, cause the first terminal device to perform the method according to the above aspect.

According to an aspect of the present disclosure, a method in a second terminal device is provided. The method includes: receiving, from a first terminal device, an indication of whether a sidelink feature is supported or applied by the first terminal device for a service or signaling message.

In an embodiment, the indication may be carried in: SCI, an SL-SCH MAC header, a MAC CE, PC5-RRC signaling, PC5-S, or a control PDU of a protocol layer.

In an embodiment, the MAC CE may be transmitted when the first terminal device joins a connection-oriented group, in response to a request from the second terminal device, or periodically, the PC5-RRC signaling may be transmitted by means of unicast, groupcast, or broadcast, or the protocol layer may include SDAP, PDCP, RLC, or an adaptation layer when the indication is transmitted via a sidelink relay.

In an embodiment, the indication may be per service type, per application type, per traffic type, or per signaling message type.

In an embodiment, the indication may be contained in a bitmap having a plurality of bits each associated with a service type, an application type, a traffic type, or a signaling message type.

In an embodiment, the sidelink feature may include sidelink DRX, and the indication may include a DRX Command MAC CE implicitly indicating that the sidelink DRX is applied by the first terminal device.

In an embodiment, the sidelink feature may include sidelink DRX.

In an embodiment, the service may include a groupcast or broadcast service, or the signaling message may include a discovery message, a request for establishing a sidelink unicast connection, or a response to the request.

In an embodiment, the indication may be received via another terminal device serving as a group header in groupcast communication.

In an embodiment, the method may further include: determining whether to apply the sidelink feature in receiving the service or signaling message from the first terminal device based on the received indication.

In an embodiment, the method may further include: storing information indicating the first terminal device as supporting or applying, or not supporting or applying, the sidelink feature based on the indication.

In an embodiment, the method may further include: determining whether to apply the sidelink feature in receiving the service or signaling message from the first terminal device based on the stored information.

In an embodiment, the method may further include: determining not to apply the sidelink feature in receiving a transmission from the first terminal device in absence of knowledge that the sidelink feature is supported or applied by the first terminal device.

According to an aspect of the present disclosure, a second terminal device is provided. The second terminal device includes a transceiver, a processor, and a memory.

The memory contains instructions executable by the processor whereby the second terminal device is operative to perform the method according to the above aspect.

According to an aspect of the present disclosure, a computer readable storage medium is provided. The computer readable storage medium has computer program instructions stored thereon. The computer program instructions, when executed by a processor in a second terminal device, cause the second terminal device to perform the method according to the above aspect.

According to an aspect of the present disclosure, a method in a network node is provided. The method includes: transmitting, to a terminal device, an indication to apply a sidelink feature for a service or signaling message when the terminal device has been configured or preconfigured with at least one configuration of the sidelink feature for the service or signaling message, regardless of whether a transmit profile corresponding to a service type of the service indicates that the sidelink feature is to be applied to the service or signaling message.

In an embodiment, the sidelink feature may include sidelink DRX, and/or the at least one configuration of the sidelink feature may include at least one sidelink DRX configuration.

In an embodiment, the service may include a groupcast or broadcast service, or the signaling message may include a discovery message, a request for establishing a sidelink unicast connection, or a response to the request.

According to an aspect of the present disclosure, a method in a network node is provided. The method includes: transmitting, to a terminal device, an indication of a negative offset to be applied to a first SLCH priority of a first SLCH, the first SLCH being used for a first sidelink transmission of a first service or signaling message to which a sidelink feature is applied; and/or transmitting, to the terminal device, an indication of a positive offset to be applied to a second SLCH priority of a second SLCH, the second SLCH being used for a second sidelink transmission of a second service or signaling message to which the sidelink feature is not applied.

In an embodiment, the sidelink feature may include sidelink DRX.

In an embodiment, the first service and/or the second service may include a groupcast or broadcast service, or the first signaling message and/or the second signaling message may include a discovery message, a request for establishing a sidelink unicast connection, or a response to the request.

According to an aspect of the present disclosure, a network node is provided. The network node includes a transceiver, a processor, and a memory. The memory contains instructions executable by the processor whereby the network node is operative to perform the method according to one or more of the above aspects.

According to an aspect of the present disclosure, a computer readable storage medium is provided. The computer readable storage medium has computer program instructions stored thereon. The computer program instructions, when executed by a processor in a network node, cause the network node to perform the method according to one or more of the above aspects.

With the embodiments of the present disclosure, a terminal device may determine whether to apply a sidelink feature based on at least one of a transmit profile and whether it has been configured or preconfigured with at least one configuration of the sidelink feature. Alternatively or additionally, a terminal device can transmit, to another terminal device, an indication of whether a sidelink feature is supported or applied by the terminal device. In this way, the sidelink communication performance can be improved based on the sidelink feature supported and/or applied by the terminal device.

According to an aspect of the present disclosure, there is provided a method performed by a UE. The method comprises: detecting one or more events. In accordance with an exemplary embodiment, the method further comprises: determining whether to apply one or more features for a service in a D2D communication, according to a result of the detection. The one or more features may be related to one or more capabilities of the UE.

In accordance with an exemplary embodiment, the UE may determine not to apply the one or more features for the service in the D2D communication, when the one or more events detected by the UE belong to a predefined set of events. In an embodiment, the predefined set of events may comprise one or more of the following events:
the service being not mapped to the one or more features;
presence of one or more other UEs which are not capable of supporting the one or more features;
completion of data transmission or reception by the UE for the service associated with the one or more features;
when a timer is running during which the one or more features are unavailable; and
an indication that the one or more features are not allowed to be used.

In accordance with an exemplary embodiment, the UE may determine to apply the one or more features for the service in the D2D communication, when none of the predefined set of events are detected by the UE and the following conditions are met:
the one or more features are mapped to all services which the UE is interested to or involved with;
all UEs communicating with the UE are capable of supporting the one or more features;
the UE has data transmission or reception for at least one service which is associated with the one or more features;
there is not any running timer during which the one or more features are not allowed to be used; and
the UE does not get any indication indicating that the one or more features are not allowed to be used.

In accordance with an exemplary embodiment, the method according to the above aspect of the present disclosure may further comprise changing configuration of the one or more features by performing one or more of the following actions:
reconfiguring the one or more features by enabling the one or more features;
reconfiguring the one or more features by disabling the one or more features;
configuring the one or more features which are not configured to the UE previously;
de-configuring the one or more features which are configured to the UE previously; and
reconfiguring the one or more features by changing parameter settings of the one or more features previously configured to the UE.

In accordance with an exemplary embodiment, the configuration of the one or more features may be changed by the UE proactively or in response to an instruction from a communication device.

In accordance with an exemplary embodiment, the communication device may be a base station or another UE (e.g., a UE capable of controlling at least part of D2D/SL communications).

In accordance with an exemplary embodiment, the method according to the above aspect of the present disclosure may further comprise: transmitting a first message to a communication device. In an embodiment, the first message may indicate one or more of:
a request for changing configuration of the one or more features;
a change of the configuration of the one or more features;
at least one of the one or more events detected by the UE; and
one or more actions performed by the UE for changing the configuration of the one or more features.

In accordance with an exemplary embodiment, the first message may be transmitted by the UE via one or more of:
radio resource control (RRC) signaling;
a medium access control (MAC) control element (CE);
a control protocol data unit (PDU); and
physical layer (L1) signaling.

In accordance with an exemplary embodiment, the first message may indicate one or more of:
a cause which triggers the change of the configuration of the one or more features;
an index of the service;
one or more quality of service (QoS) parameters associated with the service;
one or more release numbers supported by one or more other UEs;
one or more capabilities of the one or more other UEs;
a data volume and/or data rate achieved by the UE;
a time period that the UE performs data transmission and/or data reception;
a duration of a timer for prohibiting application of one or more corresponding features;
whether the timer is applied to a specific feature or a group of features; and
a number of times the timer has been started or stopped.

In accordance with an exemplary embodiment, the first message may include a bitmap field. In an embodiment, each bit of the bitmap field may correspond to a specific feature or feature group, and may be used to indicate activation or deactivation of the specific feature or feature group.

In accordance with an exemplary embodiment, the method according to the above aspect of the present disclosure may further comprise: receiving a second message from the communication device. In an embodiment, the second message may include one or more of:
an instruction of changing the configuration of the one or more features;
an indication of completion or failure of changing the configuration of the one or more features; and
configuration information for detecting the one or more events.

In accordance with an exemplary embodiment, the instruction of changing the configuration of the one or more features may indicate one or more actions to be performed by the UE for changing the configuration of the one or more features.

In accordance with an exemplary embodiment, the one or more features may be detected by the UE according to at least one of the following criteria:
periodically;
after data reception;
before data transmission; and
after getting a detection indication from a communication device.

According to an aspect of the present disclosure, there is provided an apparatus which may be implemented as a UE. The apparatus may comprise one or more processors and one or more memories storing computer program codes. The one or more memories and the computer program codes may be configured to, with the one or more processors, cause the apparatus at least to perform any step of the method according to the above aspect of the present disclosure.

According to an aspect of the present disclosure, there is provided a computer-readable medium having computer program codes embodied thereon which, when executed on a computer, cause the computer to perform any step of the method according to the above aspect of the present disclosure.

According to an aspect of the present disclosure, there is provided an apparatus which may be implemented as a UE. The apparatus may comprise a detecting unit and a determining unit. In accordance with some exemplary embodiments, the detecting unit may be operable to carry out at least the detecting step of the method according to the above aspect of the present disclosure. The determining unit may be operable to carry out at least the determining step of the method according to the above aspect of the present disclosure.

According to an aspect of the present disclosure, there is provided a method performed by a communication device (e.g., a base station, a UE, etc.). The method comprises: receiving a first message from a UE. In an embodiment, the first message may indicate one or more of:
a request for changing configuration of one or more features for a service in a D2D communication, where the one or more features may be related to one or more capabilities of the UE;
a change of the configuration of the one or more features;
at least one of one or more events detected by the UE; and
one or more actions performed by the UE for changing the configuration of the one or more features.

In accordance with an exemplary embodiment, the first message received by the communication device as described according to the above aspect of the present disclosure may correspond to the first message transmitted by the UE as described according to the above aspect of the present disclosure.

In accordance with an exemplary embodiment, the one or more features may not to be applied for the service in the D2D communication, when the one or more events detected by the UE belong to a predefined set of events.

In accordance with an exemplary embodiment, the method according to the above aspect of the present disclosure may further comprise: transmitting a second message to the UE. In an embodiment, the second message may include one or more of:
an instruction of changing the configuration of the one or more features;
an indication of completion or failure of changing the configuration of the one or more features; and
configuration information for detecting the one or more events.

In accordance with an exemplary embodiment, the second message transmitted by the communication device as described according to the above aspect of the present disclosure may correspond to the second message received by the UE as described according to the above aspect of the present disclosure.

According to an aspect of the present disclosure, there is provided an apparatus which may be implemented as a communication device. The apparatus may comprise one or more processors and one or more memories storing computer program codes.

The one or more memories and the computer program codes may be configured to, with the one or more processors, cause the apparatus at least to perform any step of the method according to the above aspect of the present disclosure.

According to an aspect of the present disclosure, there is provided a computer-readable medium having computer program codes embodied thereon which, when executed on a computer, cause the computer to perform any step of the method according to the above aspect of the present disclosure.

According to an aspect of the present disclosure, there is provided an apparatus which may be implemented as a communication device. The apparatus may comprise a receiving unit and optionally a transmitting unit. In accordance with some exemplary embodiments, the receiving unit may be operable to carry out at least the receiving step of the method according to the above aspect of the present disclosure. The transmitting unit may be operable to carry out at least the transmitting step of the method according to the above aspect of the present disclosure.

According to an aspect of the present disclosure, there is provided a method performed by a UE. The method comprises: obtaining configuration information of a feature. The feature may be related to one or more capabilities of the UE, and the configuration information may indicate whether the feature is mandatory to be applied for a service. In accordance with an exemplary embodiment, the method further comprises: determining whether to start the service in a D2D communication, based at least in part on the configuration information of the feature.

In accordance with an exemplary embodiment, when the configuration information indicates that the feature is mandatory to be applied for the service, and when existing services of the UE allow the feature to be applied, the UE may determine to start the service using the feature.

In accordance with an exemplary embodiment, when the configuration information indicates that the feature is mandatory to be applied for the service, and when a priority of the service is higher than a highest priority of existing services of the UE for which the feature is not allowed to be applied, the UE may determine to start the service using the feature. In an embodiment, the method according to the above aspect of the present disclosure may further comprise: stopping the existing services for which the feature is not allowed to be applied.

In accordance with an exemplary embodiment, when the configuration information indicates that the feature is mandatory to be applied for the service, and when a priority of the service is lower than a highest priority of existing services of the UE for which the feature is not allowed to be applied, the UE may determine not to start the service.

In accordance with an exemplary embodiment, when the configuration information indicates that the feature is not mandatory but optional to be applied for the service, the UE may determine to start the service.

In accordance with an exemplary embodiment, when the configuration information indicates that the feature is not mandatory and not allowed to be applied for the service, the UE may determine to start the service without using the feature.

According to an aspect of the present disclosure, there is provided an apparatus which may be implemented as a UE. The apparatus may comprise one or more processors and one or more memories storing computer program codes. The one or more memories and the computer program codes may be configured to, with the one or more processors, cause the apparatus at least to perform any step of the method according to the above aspect of the present disclosure.

According to an aspect of the present disclosure, there is provided a computer-readable medium having computer program codes embodied thereon which, when executed on a computer, cause the computer to perform any step of the method according to the above aspect of the present disclosure.

According to an aspect of the present disclosure, there is provided an apparatus which may be implemented as a UE. The apparatus may comprise an obtaining unit and a determining unit. In accordance with some exemplary embodiments, the obtaining unit may be operable to carry out at least the obtaining step of the method according to the above aspect of the present disclosure. The determining unit may be operable to carry out at least the determining step of the method according to the above aspect of the present disclosure.

It can be appreciated that the apparatus according to the above aspect of the present disclosure may also be configured to perform the method according to the above aspect of the present disclosure and/or the method according to the above aspect of the present disclosure. Similarly, it can be appreciated that the apparatus according to the above aspect of the present disclosure may also be configured to perform the method according to the above aspect of the present disclosure and/or the method according to the above aspect of the present disclosure. It also can be appreciated that the apparatus according to the above aspect of the present disclosure may also be configured to perform the method according to the above aspect of the present disclosure and/or the method according to the above aspect of the present disclosure.

According to an aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the above aspect of the present disclosure.

According to an aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the above aspect of the present disclosure.

According to an aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to one or more of the above aspects of the present disclosure.

According to an aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to one or more of the above aspects of the present disclosure.

According to an aspect of the present disclosure, there is provided a method implemented in a communication system which may include a host computer, a base station and a UE. The method may comprise, at the host computer, receiving user data transmitted to the base station from the UE which may perform any step of the method according to one or more of the above aspects of the present disclosure.

According to an aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to one or more of the above aspects of the present disclosure.

According to an aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the above aspect of the present disclosure.

According to an aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the above aspect of the present disclosure.

Various exemplary embodiments according to the present disclosure can enable UEs supporting different service features or protocol releases (e.g., 3GPP releases, etc.) to communicate with each other, e.g., over a D2D link or SL, without service interruption due to release/feature differences. As an example, without the proposed solutions, when a new service arrives/becomes interested for a UE, the UE may apply a feature which is not supported by another UE, which may lead to packet loss or packet delay for the service; while with the proposed solutions, the UE may always choose a suitable feature which fits to the neighbor UEs' capabilities, so that the negative impact to services can be minimized.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary telecommunications network in which communication profile based D2D communication according to an embodiment of the present disclosure may be applicable.

FIG. 2 is a flow chart of an exemplary method at a UE for D2D communication according to an embodiment of the present disclosure.

FIG. 3 is a flow chart of another exemplary method at a UE for D2D communication according to another embodiment of the present disclosure.

FIG. 4 is a flow chart of yet another exemplary method at a UE for D2D communication according to yet another embodiment of the present disclosure.

FIG. 5 schematically shows an embodiment of an arrangement which may be used in a UE according to an embodiment of the present disclosure.

FIG. 6 schematically illustrates a telecommunication network connected via an intermediate network to a host computer according to an embodiment of the present disclosure.

FIG. 7 is a generalized block diagram of a host computer communicating via a base station with a user equipment over a partially wireless connection according to an embodiment of the present disclosure.

FIG. 8 to FIG. 11 are flowcharts illustrating methods implemented in a communication system including a host computer, a base station, and a user equipment according to an embodiment of the present disclosure.

FIG. 12 is a flowchart illustrating a method in a first terminal device according to an embodiment of the present disclosure.

FIG. 13 is a flowchart illustrating a method in a second terminal device according to an embodiment of the present disclosure.

FIG. 14 is a flowchart illustrating a method in a network node according to an embodiment of the present disclosure.

FIG. 15 is a flowchart illustrating a method in a first terminal device according to another embodiment of the present disclosure.

FIG. 16 is a flowchart illustrating a method in a network node according to another embodiment of the present disclosure.

FIG. 17 is a flowchart illustrating a method in a first terminal device according to yet another embodiment of the present disclosure.

FIG. 18 is a flowchart illustrating a method in a second terminal device according to yet another embodiment of the present disclosure.

FIG. 19 is a flowchart illustrating a method in a network node according to yet another embodiment of the present disclosure.

FIG. 20 is a flowchart illustrating a method in a network node according to yet another embodiment of the present disclosure.

FIG. 21 is a block diagram of a first terminal device according to an embodiment of the present disclosure.

FIG. 22 is a block diagram of a second terminal device according to an embodiment of the present disclosure.

FIG. 23 is a block diagram of a network node according to an embodiment of the present disclosure.

FIG. 24 is a block diagram of a first terminal device according to another embodiment of the present disclosure.

FIG. 25 is a block diagram of a network node according to another embodiment of the present disclosure.

FIG. 26 is a block diagram of a first terminal device according to yet another embodiment of the present disclosure.

FIG. 27 is a block diagram of a second terminal device according to yet another embodiment of the present disclosure.

FIG. 28 is a block diagram of a network node according to yet another embodiment of the present disclosure.

FIG. 29 is a block diagram of a network node according to yet another embodiment of the present disclosure.

FIG. 30 is a block diagram of a first terminal device according to still yet another embodiment of the present disclosure.

FIG. 31 is a block diagram of a second terminal device according to still yet another embodiment of the present disclosure.

FIG. 32 is a block diagram of a network node according to still yet another embodiment of the present disclosure.

FIG. 33 is a flowchart illustrating a method in a terminal device according to an embodiment of the present disclosure.

FIG. 34 is a flowchart illustrating a method in a first terminal device according to an embodiment of the present disclosure.

FIG. 35 is a flowchart illustrating a method in a second terminal device according to an embodiment of the present disclosure.

FIG. 36 is a flowchart illustrating a method in a network node according to an embodiment of the present disclosure.

FIG. 37 is a flowchart illustrating a method in a network node according to another embodiment of the present disclosure.

FIG. 38 is a block diagram of a terminal device according to an embodiment of the present disclosure.

FIG. 39 is a block diagram of a first terminal device according to an embodiment of the present disclosure.

FIG. 40 is a block diagram of a second terminal device according to an embodiment of the present disclosure.

FIG. 41 is a block diagram of a network node according to an embodiment of the present disclosure.

FIG. 42 is a block diagram of a terminal device according to another embodiment of the present disclosure.

FIG. 43 is a block diagram of a first terminal device according to another embodiment of the present disclosure.

FIG. 44 is a block diagram of a second terminal device according to another embodiment of the present disclosure.

FIG. 45 is a block diagram of a network node according to another embodiment of the present disclosure.

FIG. 46 is a flowchart illustrating a method according to an embodiment of the present disclosure.

FIG. 47 is a flowchart illustrating another method according to an embodiment of the present disclosure.

FIG. 48 is a flowchart illustrating a further method according to an embodiment of the present disclosure.

FIG. 49 is a block diagram illustrating an apparatus according to an embodiment of the present disclosure.

FIG. 50A and FIG. 50B are block diagrams illustrating apparatuses according to some embodiments of the present disclosure.

FIG. 51 is a block diagram illustrating another apparatus according to an embodiment of the present disclosure.

FIG. 52 is a flow chart of an exemplary method at a UE for SL communication according to an embodiment of the present disclosure.

FIG. 53 schematically shows an embodiment of an arrangement which may be used in a UE according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5th Generation New Radio (5G NR), the present disclosure is not limited thereto. In fact, as long as D2D communication is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IoT device, a vehicle, or any other equivalents. For another example, the term “gNB” used herein may refer to a base station, a base transceiver station, an access point, a hot spot, a NodeB (NB), an evolved NodeB (eNB), a network element, an access network (AN) node, or any other equivalents. Further, the term “node” used herein may refer to a UE, a functional entity, a network entity, a network element, a network equipment, or any other equivalents.

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device and a network node in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network node” or “network device” refers to a device in a wireless communication network via which a terminal device accesses the network and receives services therefrom. The network node or network device refers to a base station (BS), an access point (AP), or any other suitable device in the wireless communication network. The BS may be, for example, a node B (NodeB or NB), an evolved NodeB (eNodeB or eNB), or a (next) generation (gNB), a Remote Radio Unit (RRU), a radio header (RH), a remote radio head (RRH), a relay, a low power node such as a femto, a pico, and so forth. Yet further examples of the network node may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network node may represent any suitable device (or group of devices) capable, configured, arranged, and/or operable to enable and/or provide a terminal device access to the wireless communication network or to provide some service to a terminal device that has accessed the wireless communication network.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, a mobile phone, a cellular phone, a smart phone, voice over IP (VoIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink transmission refers to a transmission from the network node to a terminal device, and an uplink transmission refers to a transmission in an opposite direction.

Further, following 3GPP documents are incorporated herein by reference in their entireties:
3GPP TS 38.213 V16.5.0 (2021-03), 3rd Generation Partnership Project; Technical Specification Group Radio Access Network; NR; Physical layer procedures for control (Release 16);
3GPP TS 38.214 V16.5.0 (2021-03), 3rd Generation Partnership Project; Technical Specification Group Radio Access Network; NR; Physical layer procedures for data (Release 16);
3GPP TS 38.300 V16.5.0 (2021-03), 3rd Generation Partnership Project; Technical Specification Group Radio Access Network; NR; NR and NG-RAN Overall Description; Stage 2 (Release 16);
3GPP TS 38.321 V16.4.0 (2021-03), 3rd Generation Partnership Project; Technical Specification Group Radio Access Network; NR; Medium Access Control (MAC) protocol specification (Release 16); and
3GPP TS 38.331 V16.4.1 (2021-03), 3rd Generation Partnership Project; Technical Specification Group Radio Access Network; NR; Radio Resource Control (RRC) protocol specification (Release 16).

Before some embodiments of the present disclosure are described, a brief introduction of sidelink will be given below.

Similar to Long Term Evolution (LTE), NR uses the OFDM (Orthogonal Frequency Division Multiplexing) technology in the downlink (i.e., from a network node, gNB, eNB, or base station to a user equipment or UE). The basic NR physical resource over an antenna port can thus be seen as a time-frequency grid, where a resource block (RB) in a 14-symbol slot is used. A resource block corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2\hat{ }μ) kHz where μ∈{0,1,2,3,4}. Δf=15 kHz is the basic (or reference) subcarrier spacing that is also used in LTE.

In the time domain, downlink and uplink transmissions in NR will be organized into equally-sized subframes of 1 ms each, similar to LTE. A subframe is further divided into multiple slots of equal duration. The slot length for subcarrier spacing Δf=(15×2\hat{ }μ) kHz is ½\hat{ }μ ms. There is only one slot per subframe for Δf=15 kHz and a slot consists of 14 OFDM symbols as mentioned above.

Downlink transmissions are dynamically scheduled, i.e., in each slot the gNB may transmit downlink control information (DCI) about which UE data is to be transmitted to and which resource blocks in the current downlink slot the data is transmitted on. This control information is typically transmitted in the first one or two OFDM symbols in each slot in NR. The control information is carried on the Physical Downlink Control Channel (PDCCH) and data is carried on the Physical Downlink Shared Channel (PDSCH). A UE first detects and decodes PDCCH and if a PDCCH is decoded successfully, it then decodes the corresponding PDSCH based on the downlink assignment provided by decoded control information in the PDCCH.

In addition to PDCCH and PDSCH, there are also other channels and reference signals transmitted in the downlink, including Synchronous Signal and PBCH Block (SSB), Channel State Information-Reference Signal (CSI-RS), etc.

Uplink data transmissions, carried on Physical Uplink Shared Channel (PUSCH), can also be dynamically scheduled by the gNB by transmitting a DCI. The DCI (which is transmitted in the DL region) always indicates a scheduling time offset so that the PUSCH is transmitted in a slot in the UL region.

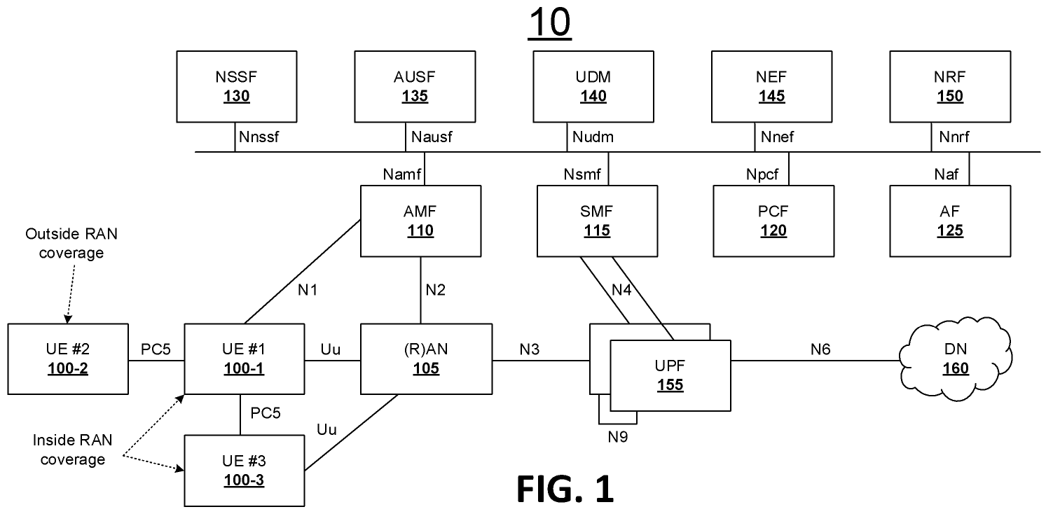

FIG. 1 is a diagram illustrating an exemplary telecommunications network 10 in which communication profile based D2D communication according to an embodiment of the present disclosure may be applicable. Although the telecommunications network 10 is a network defined in the context of 5G NR, the present disclosure is not limited thereto.

As shown in FIG. 1, the network 10 may comprise one or more UEs 100-1, 100-2, and 100-3 (collectively, UE(s) 100) and a (radio) access network ((R)AN) 105, which could be a base station, a Node B, an evolved NodeB (eNB), a gNB, or an AN node which provides the UEs 100 with access to the network. Further, the network 10 may comprise its core network portion comprising (but not limited to) an AMF 110, an SMF 115, a Policy Control Function (PCF) 120, an Application Function (AF) 125, a Network Slice Selection Function (NSSF) 130, an AUthentication Server Function (AUSF) 135, a Unified Data Management (UDM) 140, a Network Exposure Function (NEF) 145, a Network Repository Function (NRF) 150, and one or more UPFs 155. As shown in FIG. 1, these entities may communicate with each other via the service-based interfaces, such as, Namf, Nsmf, Npcf, etc. and/or the reference points, such as, N1, N2, N3, N6, N9, etc. Further, as shown in FIG. 1, the UEs may communicate with each other via sidelinks over the reference point PC5.

However, the present disclosure is not limited thereto. In some other embodiments, the network 10 may comprise additional network functions, less network functions, or some variants of the existing network functions shown in FIG. 1. For example, in a network with the 4G architecture, the entities which perform these functions may be different from those shown in FIG. 1. For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure.

As shown in FIG. 1, the UPFs 155 may be communicatively connected to the Data Network (DN) 160 which may be, or in turn communicatively connected to, the Internet, such that the UEs 100 may finally communicate its user plane data with other devices outside the network 10, for example, via the RAN 105 and the UPFs 155.

3GPP organizes the specifications for a radio access technology (RAT) in terms of releases. In each release, either new technical features are introduced, or existing features are enhanced, improving support for existing use cases, or providing support for new use cases, etc. Although there may be substantial technical differences between UEs from different releases, coexistence in cellular communications is possible. That is, UEs communicating with each other (through the network (NW)) may use functionalities from different releases. This architecture of cellular networks simplifies the coexistence by putting all the burden of it on the network (e.g., RAT, core network (CN), etc.). For example:
A first user equipment (UE) communicates in uplink with a first base station (BS) (e.g., an eNB in the case of LTE, a gNB in the case of NR, etc.) using features from Rel-X.
The communication from the first UE passes through the network until it reaches a second BS (in fact, it could even be the same BS).
The second BS communicates in downlink with a second UE using features from Rel-Y.

In the description above, it is clear that the first UE and the first BS must support the corresponding features from Rel-X. Similarly, the second UE and the second BS must support the corresponding features from Rel-Y. Communication between UEs is enabled by the NW who is a bridge between UEs and is responsible of translating a transmission from a UE to be in a proper format that can be readable by destination UE.

The coexistence between the UE and the NW, including the communication in each of UL and DL is possible thanks to a framework that includes:
A basic set of features that must be implemented by any NW and any UE, regardless of the release they implement, and which allows for initial communication between them.
A set of procedures for the UE to inform the NW about its capabilities, the features it supports (including the release), etc.
The assumption that the NW will not use features that are not supported by the UE.

In Rel-12, 3GPP specified direct (i.e., D2D) communications between neighboring devices, as well as direct discovery between neighboring devices. D2D communications in 3GPP are commonly referred to as sidelink (SL) communications or communications over the PC5 interface (for both LTE and NR). The driving use case for the LTE SL in Rel-12 was public safety communication (e.g., communication among first responders). Minor enhancements of the SL were introduced in Rel-13. However, the target use case did not change. These services are usually referred to Proximity Services or ProSe.

In Rel-14, the sidelink was heavily redesigned in 3GPP. Multiple features to support V2X communications were introduced. Some further enhancements were introduced in Rel-15. This is usually referred to as SL for V2V or V2X communications.

Some embodiments of the present disclosure are concerned with the LTE sidelink introduced in Rel-14 and Rel-15 and some embodiments of the present disclosure are concerned with the NR sidelink introduced in Rel-16 and described below.

3GPP Rel-15 extended the LTE SL support with new features, some of which were not backwards compatible with Rel-14 terminals. Given that sidelink communications take place directly between devices, the networks cannot facilitate coexistence (as described above) unlike regular cellular communications (i.e., consisting of UL and/or DL transmissions). For these reasons, a different framework for coexistence was introduced. This framework is based on the following principles:
1. LTE SL Rel-15 features are a super-set of LTE SL Rel-14 features.
2. Any Rel-14 or Rel-15 SL UE is capable of receiving transmissions over the physical sidelink control channel (PSCCH) that use a Rel-14 UE or a Rel-15 format, regardless of which features are used.
3. Any Rel-14 or Rel-15 SL UE is capable of receiving transmissions over the physical sidelink shared channel (PSSCH) that use a Rel-14 format, regardless of which features are used.
4. For Rel-15 UEs:
   Each service is assigned a type.
   Each service type is mapped to a TX profile. In LTE Rel-15, TX profile is associated with a release, and it can be either ‘Rel-14’ or ‘Rel-15’.
   The service type of a packet (and its TX profile) determines how it is transmitted:
      Transmission of packets from a service mapped to TX profile=‘Rel-14’ must use Rel-14 features, regardless of whether the transmitter UE supports Rel-15 or not.
      Transmission of packets belonging to a service mapped to TX profile=‘Rel-15’ must use Rel-15 features (which are a super-set of Rel-14 features).

Note that in the existing specifications, the TX profile is used by a transmitter is totally transparent for a receiver. In this regard:
Decodability at the intended receiver(s) is guaranteed by choosing appropriately the TX parameters (i.e., using the TX profile); and
There is no action at the receiver UE related to service types/TX profiles.

Note also that Rel-14 UEs do not have the notion of TX profile or about the mapping between service type and TX profile at all.

An example of the coexistence operation using TX profile may be given as follows. In practice, some entity (e.g., an NW operator, a regulatory authority, etc.) determines what transmission profile (=LTE release) is used for each specific service. For a UE, when deciding to participate in a specific service, the mapping between service types and TX profiles must be considered.

Considering the situation with two service types ‘ITS safety’ and ‘Cooperative driving’. These two services could be delivered in the following way:
Mapping between service types and TX profiles are defined or (pre-)configured at the UE:
   Service type ‘ITS safety’ (e.g., CAM) is mapped to the TX profile=‘Rel-14’;
   Service type ‘Cooperative driving’ is mapped to the TX profile=‘Rel-15’.
OEM1 wants a vehicle that can participate in ‘ITS safety’ services only
   OEM1 can use any UE that supports Rel-14 (a UE that additionally supports Rel-15 would work too, but the Rel-15 features will not be used for ‘ITS safety’);
   When transmitting a message for the service type ‘ITS safety’, the UE can use any of the Rel-14 features but no Rel-15-only feature, even if it supports them.
OEM2 wants a vehicle that can participate in ‘Cooperative driving’ services only
   OEM2 must choose a Rel-15 UE (in practice meaning that the UE supports Rel-14+Rel-15 features.).
      When transmitting a message for the service type ‘Cooperative driving’, the UE can use any of the Rel-14+Rel-15 features.

Regarding the TX-RX interaction, the following cases are distinguished:

Case 1: Transmitter UE is Rel-14, packet contains ‘ITS safety’ payload (Note: in Rel-14, packets have no service type)
The UE transmits using Rel-14 features
   The packet can be received by Rel-14 and Rel-15 UEs alike

Case 2: Transmitter UE is Rel-14, packet contains ‘advanced driving’ payload (Note: in Rel-14, packets have no service type)
This case should not happen in this coexistence framework. An OEM interested in ‘advanced driving (Cooperative driving)’ communications over SL must use a Rel-15 UE for that purpose. In the SL coexistence framework, this is not allowed.

Case 3: Transmitter UE is Rel-15, packet is of service type ‘ITS safety’
The UE transmits using Rel-14 features
The packet can be received by Rel-14 and Rel-15 UEs alike

Case 4: Transmitter UE is Rel-15, packet is of service type ‘advanced driving (cooperative driving)’
The UE transmits using Rel-15 features
The packet can be received by Rel-15 UEs
There is no guarantee that the packet can be received by Rel-14 UEs

Some related content of the 3GPP technical specification is provided below.

### 3Gpp Ts 36.300 V16.5.0 States:

| | |
|---|---|
| 23.14.1.1 | Support for V2X sidelink communication |

The user plane protocol stack and functions, as specified in clause 23.10.2.1 for sidelink communication, are also
used for V2X sidelink communication. In addition, for V2X sidelink communication:

| | |
|---|---|
| - | STCH for sidelink communication is also used for V2X sidelink communication. |
| - | Non-V2X (e.g. Public Safety) data is not multiplexed with V2X data transmitted in resources configured for |
| | V2X sidelink communication. |
| - | The Access Stratum (AS) is provided with the PPPP and PPPR of a protocol data unit transmitted over PC5 |
| | interface by upper layers. The packet delay budget (PDB) of the protocol data unit can be determined from |
| | the PPPP. The low PDB is mapped to the high priority PPPP value (TS 23.285 [72]). |
| - | The Access Stratum (AS) is provided with a transmit profile (TS 23.285 [72]) of a protocol data unit |
| | transmitted over PC5 interface by upper layers. |
| - | The logical channel prioritization based on PPPP is used for V2X sidelink communication. |

3GPP TS 23.285 V16.4.0 States that:

| | |
|---|---|
| 3.1 | Definitions |

For the purposes of the present document, the terms and definitions given in TR 21.905 [1] and the following apply.
A term defined in the present document takes precedence over the definition of the same term, if any, in
TR 21.905 [1].
Tx Profile: The transmission format (i.e. which 3GPP Release) to be used by the UE over LTE PC5 RAT, see
TS 36.300 [10].

| | |
|---|---|
| 4.4.1.1.2 | Policy/Parameter provisioning |

The following information for V2X communications over PC5 reference point is provisioned to the UE:

| 1) | Authorization policy: | |
|---|---|---|
| | - | When the UE is “served by E-UTRAN”: |

| | |
|---|---|
| - | PLMNs in which the UE is authorized to perform V2X communications over PC5 reference point. |

| | |
|---|---|
| - | When the UE is “not served by E-UTRAN”: |

| | |
|---|---|
| - | Indicates whether the UE is authorized to perform V2X communications over PC5 reference point |

when “not served by E-UTRAN”.

| 2) | Radio parameters for when the UE is “not served by E-UTRAN”: | |
|---|---|---|
| | - | Includes the radio parameters with Geographical Area(s) and an indication of whether they are “operator |

managed” or “non-operator managed. These radio parameters (e.g. frequency bands) are defined in
TS 36.331 [9]. The UE uses the radio parameters to perform V2X communications over PC5 reference
point when “not served by E-UTRAN” only if the UE can reliably locate itself in the corresponding
Geographical Area. Otherwise, the UE is not authorized to transmit.

| | |
|---|---|
| NOTE 1: | Whether a frequency band is “operator managed” or “non-operator managed” in a given Geographical |
| | Area is defined by local regulations. |

| 3) | Policy/parameters: | |
|---|---|---|
| | - | The mapping of Destination Layer-2 ID(s) and the V2X services, e.g. PSIDs, ITS-AIDs or AIDs of the |
| | | V2X application. |

| | |
|---|---|
| NOTE 2: | PLMN operators coordinate to make sure Destination Layer-2 ID(s) for different V2X services are |
| | configured in a consistent manner. |
| NOTE 3: | To pre-configure a UE with the provisioning parameters, at least the “not served by E-UTRAN” |
| | parameters of 1) and 2), and the parameters of 3) need to be included. |

| - | The mapping of ProSe Per-Packet Priority and packet delay budget for V2X communication (autonomous |
|---|---|
| | resources selection mode). |
| - | The list of V2X services, e.g. PSIDs, ITS-AIDs or AIDs of the V2X applications, with Geographical |
| | Area(s) that require privacy support. |
| - | The mapping of service types (e.g. PSIDs, ITS-AIDs or AIDs) to V2X frequencies (see TS 36.300 [10] |
| | for further information) with Geographical Area(s). |
| - | The mapping of service types (e.g. PSIDs, ITS-AIDs or AIDs) to Tx Profiles (see TS 36.300 [10] for |
| | further information). |
| - | The list of V2X services, e.g. PSIDs, ITS-AIDs or AIDs of the V2X applications, allowed to use a |

specific PPPR value.

| | |
|---|---|
| 4.4.2 | V2X message transmission/reception over PC5 reference point |

PC5 reference point as defined in TS 23.303 [5] is used for the transmission and reception of V2X messages. The
V2X communication over PC5 reference point supports roaming and inter-PLMN operations. V2X communication
over PC5 reference point is supported when the UE is “served by E-UTRAN” and when the UE is “not served by
E-UTRAN”.
A UE is authorized to transmit and receive V2X messages by the V2X Control Function in its home PLMN as
described in clause 5.2.
The V2X communication over PC5 reference point is a type of ProSe Direct Communication with the following
characteristics:

| | |
|---|---|
| - | The V2X communication over PC5 reference point is connectionless, and there is no signalling over PC5 |
| | control plane for connection establishment. |
| - | V2X messages are exchanged between UEs over PC5 user plane. |
| - | Both IP based and non-IP based V2X messages are supported. |
| - | For IP based V2X messages, only IPv6 is used. IPv4 is not supported in this release. |

The identifiers used in the V2X communication over PC5 reference point are described in clause 4.5.1. UE decides
on the Tx Profile to use for the transmission of a particular packets based on the configuration described in
clause 4.4.1.1.2.
When the network scheduled operation mode is used, following additional principle applies:

| | |
|---|---|
| - | When the eNB receives a request for PC5 resource from a UE, the eNB may deduce the Tx Profile from the |
| | Destination L2 ID. |

| | |
|---|---|
| NOTE 1: | The mapping from Destination L2 ID to Tx Profile is configured in the eNB. The eNB can determine |
| | the Tx Profiles that the UE needs to use for transmitting the packets thus utilising the resources |
| | available appropriately -i.e. handling of sidelink grant), see TS 36.321 [26] for details. |
| 5.3 | Procedure for V2X communication over PC5 reference |
| | point |

To perform V2X communication over PC5 reference point, the UE is configured with the related information as
described in clause 4.4.1.1.
The procedure for one-to-many ProSe Direct Communication transmission described in clause 5.4.2 of
TS 23.303 [5] is applied to V2X communication over PC5 reference point with following differences:

| | |
|---|---|
| - | The source Layer-2 ID is set to the Layer-2 ID described in clause 4.5.1. |
| - | A UE shall be configured with a set of Layer-2 ID corresponding to different type of services. |
| - | A UE shall be configured with the mapping of services types to Tx Profiles as described in clause 4.4.1.1.2, |
| | and selects a Tx Profile to use based on the upper layer provided service type (e.g. PSID/ITS-AID/AID). |

The procedure for one-to-many ProSe Direct Communication reception described in clause 5.4.3 of TS 23.303 [5] is
applied to V2X communication over PC5 reference point.

The specifications define the functionality for creating the backwards compatibility frameworks but do not explain exactly how to do it. Nonetheless, the following statement from Clause 23.14.1.1 in 3GPP TS 36.300 V16.5.0 illustrate the principle.

Sidelink packet duplication is supported for V2X sidelink communication and is performed at PDCP layer of the
UE. For sidelink packet duplication for transmission, a PDCP PDU is duplicated at the PDCP entity. The duplicated
PDCP PDUs of the same PDCP entity are submitted to two different RLC entities and associated to two different
sidelink logical channels respectively. The duplicated PDCP PDUs of the same PDCP entity are only allowed to be
transmitted on different sidelink carriers. A UE can activate or deactivate sidelink packet duplication based on
(pre)configuration. Sidelink packet duplication does not apply to transmission with Rel-14 transmit profile (TS
23.285 [72]). The PPPR value(s) for which sidelink packet duplication is supported can be (pre)configured via a
PPPR threshold. For UE autonomous resource selection and scheduled resource allocation, the UE shall perform
sidelink packet duplication for the data with the configured PPPR value(s) until packet duplication is deconfigured
for these PPPR value(s). For scheduled resource allocation, the UE reports the amount of data associated with one or
more PPPR values, and the destination(s) to which the data belongs via sidelink BSR(s). A mapping of PPPR values
to logical channel groups can be configured by the eNB, and the PPPR value(s) are reflected by the associated
logical channel group ID included in the sidelink BSR(s). A list of PPPR value(s) may be reported in Sidelink UE
information by an RRC_CONNECTED UE.

The following part of 3GPP TS 36.321 V16.4.0 states that for a MAC PDU, the Tx Profile to be used corresponds to that of the logical channel with highest priority.

| | |
|---|---|
| 5.14.1.1 | SL Grant reception and SCI transmission |

[...]
The MAC entity shall for each subframe:

| - | for each configured sidelink grant occurring in this subframe: | |
|---|---|---|
| | - | if SL_RESOURCE_RESELECTION_COUNTER = 1 for the Sidelink process associated with the |

| configured sidelink grant and the MAC entity randomly selected, with equal probability, a value in the | |
|---|---|
| interval [0, 1] which is above the probability configured by upper layers in probResourceKeep: | |
| - | set the resource reservation interval for the configured sidelink grant equal to 0; |

| | |
|---|---|
| - | if the configured sidelink grant corresponds to transmission of SCI: |

| | |
|---|---|
| - | for V2X sidelink communication in UE autonomous resource selection: |

| - | consider the selected transmission format to be SL-V2X-TxProfile for the highest priority of the |
|---|---|
| | sidelink logical channel(s) in the MAC PDU (TS 36.331 [8]); |
| - | select a MCS which is, if configured, within the range that is configured by upper layers between |

| | minMCS-PSSCH and maxMCS-PSSCH included in pssch-TxConfigList associated with the |
|---|---|
| | selected transmission format and, if configured by upper layers, overlapped between minMCS- |
| | PSSCH and maxMCS-PSSCH indicated in cbr-pssch-TxConfigList associated with the selected |
| | transmission format for the highest priority of the sidelink logical channel(s) in the MAC PDU and |
| | the CBR measured by lower layers according to TS 36.214 [6] if CBR measurement results are |
| | available or the corresponding defaultTxConfigIndex configured by upper layers if CBR |
| | measurement results are not available; |
| NOTE 9: | MCS selection is up to UE implementation if the MCS or the corresponding range is not |
| | configured by upper layers. |
| NOTE 10: | For V2X sidelink communication, when there is no overlapping between the chosen |

configuration(s) included in pssch-TxConfigList and chosen configuration(s) indicated in cbr-
pssch-TxConfigList, it is up to UE implementation whether the UE transmits and which
transmitting parameters the UE uses between allowed configuration(s) indicated in pssch-
TxConfigList and allowed configuration(s) indicated in cbr-pssch-TxConfigList.

| | |
|---|---|
| - | for V2X sidelink communication in scheduled resource allocation: |

| - | consider the selected transmission format to be SL-V2X-TxProfile for the highest priority of the |
|---|---|
| | sidelink logical channel(s) in the MAC PDU (TS 36.331 [8]); |
| - | select a MCS which is associated with the selected transmission format unless it is configured by |

upper layer;

| | |
|---|---|
| - | instruct the physical layer to transmit SCI corresponding to the configured sidelink grant; |
| - | for V2X sidelink communication, deliver the configured sidelink grant, the associated HARQ |

information and the value of the highest priority of the sidelink logical channel(s) in the MAC PDU to
the Sidelink HARQ Entity for this subframe;

| | |
|---|---|
| - | else if the configured sidelink grant corresponds to transmission of first transport block for sidelink |

| communication: | |
|---|---|
| - | deliver the configured sidelink grant and the associated HARQ information to the Sidelink HARQ |

| | |
|---|---|
| | Entity for this subframe. |
| NOTE 11: | If the MAC entity has multiple configured sidelink grants occurring in one subframe and if not all of |
| | them can be processed due to the single-cluster SC-FDM restriction, it is left for UE implementation |
| | which one of these to process according to the procedure above. |

Finally, Clause 9.3.2 in 3GPP TS 36.331 V16.4.0 defines the SL-V2X-TxProfile IE

| | |
|---|---|
| SL-V2X-TxProfile-r15 ::= | ENUMERATED { |
| | rel14, rel15, spare6, spare5, spare4, |
| | spare3, spare2, spare1, ...} |

NR sidelink communication was specified by 3GPP in Rel-16. The NR SL is an evolution of the LTE sidelink, in particular of the features introduced in Rel-14 and Rel-15 for V2X communication. As mentioned above, some of the most relevant features of the NR sidelink are the following:
Support for unicast and groupcast transmissions, in addition to broadcast transmissions, which were already supported in LTE.
Support for HARQ feedback over the SL for unicast and groupcast. This feedback is conveyed by the receiver UE to the transmitter UE using the physical sidelink feedback channel (PSFCH). This functionality is new in NR compared to LTE.
To alleviate resource collisions among different sidelink transmissions launched by different UEs, it enhances channel sensing and resource selection procedures, which also lead to a new design of physical channels carrying the sidelink control information (SCI). The new design of the SCI simplifies coexistence between releases by grouping together all the information related to resource allocation (which is critical for coexistence) in a single channel with a robust, predefined format. Other control information is carried by other means, in a more flexible manner.
Grant-free transmissions, which are supported in NR uplink transmissions, are also provided in NR sidelink transmissions, to improve the latency performance.
To achieve a high connection density, congestion control and thus Quality of Service (QoS) management is supported in NR sidelink transmissions.

To enable the above enhancements, new physical channels and reference signals are introduced in NR (available in LTE before):
PSCCH (Physical Sidelink Common Control Channel): This channel carries sidelink control information (SCI) including part of the scheduling assignment (SA) that allows a receiver to further process and decode the corresponding PSSCH (e.g., demodulation reference signal (DMRS) pattern and antenna port, MCS, etc.). In addition, the PSCCH indicates future reserved resources. This allows a receiver UE to sense and predict the utilization of the channel in the future. This sensing information is used for the purpose of UE-autonomous resource allocation (Mode 2), which is described below.
PSSCH (Physical Sidelink Shared Channel): The PSSCH is transmitted by a sidelink transmitter UE, which conveys sidelink transmission data (i.e., the SL shared channel SL-SCH), and a part of the sidelink control information (SCI). In addition, higher layer control information may be carried using the PSSCH (e.g., MAC CEs, RRC signaling, etc.). For example, channel state information (CSI) is carried in the medium access control (MAC) control element (CE) over the PSSCH instead of the PSFCH.
PSFCH (Physical Sidelink feedback channel): The PSFCH is transmitted by a sidelink receiver UE for unicast and groupcast. It conveys the SL HARQ acknowledgement, which may consist of ACK/NACK (used for unicast and groupcast option 2) or NACK-only (used for groupcast option 1).
Physical Sidelink Broadcast Channel (PSBCH): The PSBCH conveys information related to synchronization, such as the direct frame number (DFN), indication of the slot and symbol level time resources for sidelink transmissions, in-coverage indicator, etc. The SSB is transmitted periodically at every 160 ms. The PSBCH is transmitted along with the S-PSS/S-SSS as a sidelink synchronization signal block (S-SSB).
   Sidelink Primary/Secondary Synchronization Signal (S-PSS/S-SSS) are used by UEs to establish a common timing references among UEs in the absence of another reference such as GNSS time of NW time.

Along with the different physical channels, reference signals (RS) are transmitted for different purposes, including demodulation (DM-RS), phase tracking RS (PT-RS), or RS for channel state information acquisition (CSI-RS).

Another new feature is the two-stage sidelink control information (SCI). A first part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining part (second stage) of the SCI carries the remaining scheduling and control information such as a 8-bits source identity (ID) and a 16-bits destination ID, NDI, RV and HARQ process ID is sent on the PSSCH to be decoded by the receiver UE.

NR sidelink supports the following two modes of resource allocation:
Mode 1: Sidelink resources are scheduled by a gNB.
Mode 2: The UE autonomously selects sidelink resources from a (pre-)configured sidelink resource pool. To avoid collisions between UEs a procedure based on the channel sensing and resource reservation is used.

An in-coverage UE (e.g., the UE #1 100-1 or the UE #3 100-3) can be configured by a gNB to use Mode 1 or Mode 2. For the out-of-coverage UE (e.g., the UE #2 100-2), only Mode 2 can be used.

Like in LTE, scheduling over the sidelink in NR is done in different ways for Mode 1 and Mode 2.

In Mode 1, the grant is provided by the gNB. The following two kinds of grants are supported:
Dynamic grants are provided for one or multiple transmissions of a single packet (i.e., transport block). When the traffic to be sent over sidelink arrives at a transmitter UE (i.e., at the corresponding TX buffer), the UE initiates the four-message exchange procedure to request sidelink resources from a gNB (SR on UL, grant, BSR on UL, grant for data on SL sent to UE). A gNB indicates the resource allocation for the PSCCH and the PSSCH in the downlink control information (DCI) conveyed by PDCCH with CRC scrambled with the SL-RNTI of the corresponding UE. A UE receiving such a DCI, assumes that it has been provided a SL dynamic grant only if the detects that the CRC of DCI has been scrambled with its SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB. As a result, this kind of grant is suitable for traffic with a loose latency requirement.
Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. This kind of grant is also known as grant-free transmissions.

Note that only the transmitter UE is scheduled by the gNB. The receiver UE does not receive any information directly from the gNB. Instead, it is scheduled by the transmitter UE by means of the SCI. Therefore, a receiver UE should perform blind decoding to identify the presence of PSCCH and find the resources for the PSSCH through the SCI.

In Mode 2 resource allocation, the grant is generated by the UE itself. When traffic arrives at a transmitter UE (i.e., at the corresponding TX buffer), this transmitter autonomously selects resources for the PSCCH and the PSSCH. To further enhance the probability of successful TB decoding at one shot and thus suppress the probability to perform retransmissions, a transmitter UE may repeat the TB transmission along with the initial TB transmission. These retransmissions may be triggered by the corresponding SL HARQ feedback or may be sent blindly by the transmitter UE. In either case, to minimize the probability of collision for potential retransmissions, the transmitter UE may also reserve the corresponding resources for PSCCH/PSSCH for retransmissions. That is, the transmitter UE selects resources for:
1) The PSCCH/PSSCH corresponding to the first transmission.
2) The PSCCH/PSCCH corresponding to the retransmissions. Resources for up to 2 retransmissions may be reserved. These reserved resources are always used in case of blind retransmissions. If SL HARQ feedback is used, the used of the reserved resources is conditional on a negative SL HARQ acknowledgement.

Since each transmitter UE in sidelink transmissions should autonomously select resources for its own transmissions, preventing the different transmitter UEs from selecting the same resources turns out to be a critical issue in Mode 2. A particular resource selection procedure is therefore imposed to Mode 2 based on channel sensing. The channel sensing algorithm involves detecting the reservations transmitted by other UEs and performing power measurements (i.e., reference signal received power or RSRP) on the incoming transmissions.

There are device-to-device (D2D) discovery procedures for detection of services and applications offered by other UEs in close proximity. This discovery procedure is a part of LTE Rel 12 and Rel 13. The discovery procedure has two modes, mode A based on open announcements (broadcasts) and mode B, which is based on request/response mechanism. The discovery mechanism is controlled by the application layer (ProSe). The discovery message is sent on the Physical Sidelink Discovery Channel (PSDCH) which is not available in NR. Also, there is a specific resource pool for announcement and monitoring of discovery messages. The discovery procedure can be used to detect UEs supporting certain services or applications before initiating direct communication.

In Release 17, 3GPP is working on the following enhancements for the sidelink (see RP-202846), the objective of this work item (WI) is to specify radio solutions that can enhance NR sidelink for the V2X, public safety and commercial use cases. The enhancements for the sidelink may include the following:

The objective of this work item is to specify radio solutions that can enhance NR sidelink for the V2X, public safety
and commercial use cases.
1. Sidelink evaluation methodology update: Define evaluation assumption and performance metric for power saving
by reusing TR 36.843 and/or TR 38.840 (to be completed by RAN#89) [RAN1]

| | |
|---|---|
| ● | Note: TR 37.885 is reused for the other evaluation assumption and performance metric. Vehicle dropping |
| | model B and antenna option 2 shall be a more realistic baseline for highway and urban grid scenarios. |

2. Resource allocation enhancement:

| ● | Specify resource allocation to reduce power consumption of the UEs [RANI, RAN2] | |
|---|---|---|
| | ▪ | Baseline is to introduce the principle of Rel-14 LTE sidelink random resource selection and partial |
| | | sensing to Rel-16 NR sidelink resource allocation mode 2. |
| | ▪ | Note: Taking Rel-14 as the baseline does not preclude introducing a new solution to reduce power |
| | | consumption for the cases where the baseline cannot work properly. |
| | ▪ | This work should consider the impact of sidelink DRX, if any. |
| ● | Study the feasibility and benefit of solution(s) on the enhancement(s) in mode 2 for enhanced reliability | |
| | and reduced latency in consideration of both PRR and PIR defined in TR37.885 (by RAN#91), and specify | |
| | the identified solution(s) if deemed feasible and beneficial [RAN1, RAN2] | |
| | ▪ | Inter-UE coordination with the following. |

| | |
|---|---|
| ♦ | A set of resources is determined at UE-A. This set is sent to UE-B in mode 2, and UE-B takes |

this into account in the resource selection for its own transmission.

| ▪ | Note: The solution should be able to operate in-coverage, partial coverage, and out-of-coverage and to |
|---|---|
| | address consecutive packet loss in all coverage scenarios. |
| ▪ | Note: RAN2 work will start after RAN#89. |

3. Sidelink DRX for broadcast, groupcast, and unicast [RAN2]

| | |
|---|---|
| ● | Define on- and off-durations in sidelink and specify the corresponding UE procedure |
| ● | Specify mechanism aiming to align sidelink DRX wake-up time among the UEs communicating with each |
| | other |
| ● | Specify mechanism aiming to align sidelink DRX wake-up time with Uu DRX wake-up time in an in- |
| | coverage UE |

4. Support of new sidelink frequency bands for single-carrier operations [RAN4]

| | |
|---|---|
| ● | Support of new sidelink frequency bands should ensure coexistence between sidelink and Uu interface in |
| | the same and adjacent channels in licensed spectrum. |
| ● | The exact frequency bands are to be determined based on company input during the WI, considering both |
| | licensed and ITS-dedicated spectrum in both FRI and FR2. |

5. Define mechanism to ensure sidelink operation can be confined to a predetermined geographic area(s) for a given
frequency range within non-ITS bands [RAN2].

| | |
|---|---|
| ● | This applies areas where there is no network coverage. |

6. UE Tx and Rx RF requirement for the new features introduced in this WI [RAN4]
7. UE RRM core requirement for the new features introduced in this WI [RAN4]
Enhancements introduced in Rel-17 should be based on the functionalities specified in Rel-16, and Rel-17 sidelink
should be able to coexist with Rel-16 sidelink in the same resource pool. This does not preclude the possibility of
operating Rel-17 sidelink in a dedicated resource pool.
The solutions should cover both the operating scenario where the carrier(s) is/are dedicated to ITS and the operating
scenario where the carrier(s) is/are licensed spectrum and also used for NR Uu/LTE Uu operation.
The solutions should support the network control of NR sidelink as in Rel-16, i.e., NR Uu controls NR sidelink using
Layer 1 and Layer 2 signalling and LTE Uu controls NR sidelink using Layer 2 signalling.
In ITS carriers, it is assumed that any co-channel coexistence requirements and mechanisms of NR sidelink with
non-3GPP technologies will not be defined by 3GPP.

UEs supporting the new functionality introduced in Rel-17 must coexist with Rel-16 UEs. In some cases, coexistence may be trivially realized, but it other cases it may require new mechanisms. For example, Rel-16 UEs do not support SL DRX. Similarly, partial sensing may be used by a UE that is selectively turning off its receiver. This functionality is neither supported nor understood by Rel-16 UEs. These and similar aspects must be considered to guarantee coexistence.

The 3GPP sidelink is specified in a way that allows for using it when a UE is in coverage or when it is out of coverage. In the former case, the UE can be directly configured by the NW (e.g., the BS) by means of common or dedicated signaling. In the latter case, the UE cannot rely on NW configuration and uses instead pre-configuration, which is stored in the SIM. The term (pre-)configuration is used to denote both ways of proving the necessary parameters, etc. to the UE.

To guarantee communication between UEs that are in coverage and UEs that are out of coverage, configuration and pre-configuration must be aligned.

NR SL has no mechanism to ensure coexistence between UEs of different releases. The LTE SL framework for coexistence between UEs of different releases is not directly reusable for NR SL for several reasons:
In addition to broadcast communications at radio layers, which were the only type supported in LTE SL, the NR SL supports groupcast and unicast communications.
In LTE, a TX profile is assigned to a service type. However, some NR features are not service specific. For example:
   SL DRX, which is being introduced in Rel-17, is a general feature that may not associated with any service type.
   Partial sensing, which is also being introduced in Rel-17, is a general feature that may not associated with any service type.

Therefore, determining the TX behavior by means of LTE TX profiles may create a TX-RX misalignment, since a LTE TX profile may not indicate whether UEs support DRX or not.
Transmitter profiles in LTE SL are equivalent to release numbers. This may not be sufficient for NR SL in Rel-17 and/or future releases, which will likely support several independent features.

An example is given to illustrate the relevance of coexistence between UEs of different releases.

In the WID (RP-202846, “WID revision: NR sidelink enhancement”) for the WI “SL Enhancement” in Rel-17, one study objective regarding coexistence between Rel-16 UE and Rel-17 UE has been defined in the following.

“Enhancements introduced in Rel-17 should be based on the functionalities specified in Rel-16, and Rel-17 sidelink should be able to coexist with Rel-16 sidelink in the same resource pool.”

Therefore, it is necessary to study how to address the coexistence issue and develop corresponding solutions.

Some embodiments of the present disclosure provide the extension of the existing framework for enabling coexistence of sidelink UEs supporting different capabilities (e.g., different features, different releases, etc.). The framework is extended in three complementary ways:
1. Communication profiles are used for determining not only transmission parameters and configurations but also reception parameters and configurations.
2. Rules for multiplexing packets with different communication profiles (e.g., from different service types).
3. Configuration of communication profile and determination of AS layer feature(s) to use based on communication profile

In some embodiments, the rules may be used separately or may be combined.

Therefore, some of the present disclosure are related to:
Rules for configuring transmission/reception at the UE based on the different service types;
Rules for a UE to determine which communication profile shall be applied in case UE has data with different communication profiles (e.g., belonging to different service types, etc.) for transmission. In particular, for multiplexing traffic; and/or
Methods for configuration of communication profile and determination of AS layer feature(s) to use based on communication profile.

With the embodiments, sidelink UEs from different releases are allowed to coexist:
It ensures that a legacy transmission format is used when transmitting to legacy UEs.
It ensures that, that multiplexing of data at a transmitter UE is done in a way that is compatible with the capabilities of the intended destination.
It ensures that new features are only configured when they are compatible with the different services that the UE is participating in.

Please note that the methods and solutions disclosed in the following embodiments are referring to the NR RAT but can be applied also to LTE RAT and any other RAT enabling the direct transmission between two (or more) nearby devices without any loss of meaning. Further, please also note that, all the embodiments can be applied without any loss of meaning to a communication that happens between a UE1 that implements 3GPP release “X” and UE2 that implements 3GPP release “Y”, or vice versa. Similarly, all the embodiments can also be applied without any loss of meaning to a communication that happens between a UE1 that implements a feature “A” and UE2 that implements feature “B”, or vice versa (i.e., regardless of the 3GPP release they are implementing).

Therefore, some embodiments of the present disclosure provide the extension of the existing framework for enabling coexistence of sidelink UEs supporting different capabilities (e.g., different features, different releases, etc.). As described above, the framework may be based on the notion of service types and communication profiles. The framework may be extended in three complementary ways:
1. Communication profiles are used for determining not only transmission parameters and configurations but also reception parameters and configurations.
2. Rules for multiplexing packets with different communication profiles (e.g., from different service types).
3. Configuration of communication profile and determination of AS layer feature(s) to use based on communication profile.

In the following embodiments, the term “communication profile” may be used to represent a communication profile which is available at transmitter UE and/or receiver UE. For example, a communication profile may be or comprise at least one of:
a transmission format (like in LTE);
a reception format (simple extension of LTE);
a receiver configuration (that is a configuration that is to be applied for operating a receiver) or a configuration or parameter used for reception; and
a transmitter configuration (that is a configuration that is to be applied for operating the transmitter) or a configuration or parameter used for transmission.

The embodiments are not restricted by the term. Any similar term such as “transmission and/or reception profile”, “transmitter profile”, “transmit profile”, “receiver profile”, “receive profile”, “TX profile”, “RX profile”, etc. is equally applicable here. Further, the rules may be used separately or may be combined.

### Transmissions Profiles for Determining Reception Parameters and Configurations

A UE may be in general interested in transmitting/receiving packets belonging to different services. Each service may be of a different type and may be mapped to a different communication profile.

In LTE V2X, a transmission (TX) profile determines only transmission parameters and configurations. That is, the transmission profile determines how the UE was expected to operate when transmitting a packet of a certain service type. No behavior at the receiver was implied by the use of a transmission profile.

In NR SL, some of the features being specified have deeper implications in terms of transmitter and receiver behavior. Moreover, the interaction between them may not be straightforward. For example, a UE may be interested in two service types (i.e., transmitting/receiving packets of two different service types). The first service type may be mapped to a communication profile that allows for using SL DRX. The second service type may be mapped to a communication profile that does not allow for using SL DRX. Clearly, configuring SL DRX has implications for the UE when receiving any packets. Clearly, the UE should not configure SL DRX, even if this would be possible for service type 1, because of the negative consequences that it would have for the reception of packets of service type 2.

The core idea of some embodiments of the present disclosure is to define rules for configuring transmission/reception at the UE based on the different service types.

A first rule is to determine whether a specific configuration or parameter (e.g., a specific value) can be used by the UE by looking at the communication profiles corresponding to all the services for which the UE is interested in transmitting and/or receiving packets. A UE may only use the configuration or parameter if it is compatible with all the communication profiles. To list a few examples:
The UE may only configure SL DRX if the communication profiles of all the service types include SL DRX as a supported feature.
   The UE may only configure SL DRX from a receiver point of view if the communication profiles of all the service types include SL DRX as a supported feature. From a transmitter point of view, the UE may still use SL DRX parameters/configuration to ensure alignment with the receivers of transmissions of a service type for which the correspond communication profile supports SL DRX. For example, the UE may take receiver DRX parameters/configuration into account while performing resource allocation to ensure that the transmission is properly received by a receiver UE that may be using SL DRX.
The UE may only configure partial sensing if the communication profiles of all the service types include partial sensing as a supported feature.
   The considerations made above for SL DRX from a receiver/transmitter point of view are also applicable to the case of partial sensing.

In some embodiments, these rules may be used for all features. In some other embodiments, these rules may only be used for some features. For example, the rules may be applicable for SL DRX but not for another feature (e.g., use of higher-order modulation, etc.).

In some embodiments, the rules may only be applied from reception point of view and the rules may not be applied from transmission point of view.

In some embodiments, the rules may be used by the UE for determining the parameters or configurations that can or cannot be used. In another embodiment, the rules may be used by the NW (e.g., a BS) for determining the parameters or configurations that can or cannot be used. Related to the latter case, supporting signaling between the UE and BS may be defined. For example, the UE may provide a list of service types on which it is interested; a list of corresponding communication profiles; and/or a list of corresponding destinations; etc.

In some embodiments, the UE applying the rule may use information about communication profiles for its own transmission (e.g., communication profiles for the service types that it is interested in; all or a subset of the communication profiles that are (pre-)configured at the UE; etc. In this case, there is no need for communicating communication profiles to other UEs.

In some embodiments, the UE applying the rule uses information about communication profiles used by other UEs (e.g., a communication profile used by UEs that are communicating with the UE applying the rule, etc.). In this case, the communication profiles used by other UEs may be communicated between UEs; or may be (pre-)configured or may be signaled by some other node or UE.

Rules for Multiplexin Packets with Different Communication Profiles

One typical operation performed by the transmitter UE is to multiplex data from different higher-layer packets into a single radio-layer packet. For example, data coming from higher layers is organized in terms of logical channels (LCHs), which in turn are organized in terms of logical channel groups (LCGs). The medium access control (MAC) layer is responsible for grouping data from same or different LCHs/LCGs in a single packet. In other words, the MAC layer multiplexes data (e.g., packets such as MAC service data units, or parts thereof) in same or different LCHs/LCGs into a MAC protocol data unit (i.e., a packet delivered by the MAC layer to the lower layers, such as the PHY layer). A MAC protocol data unit is sometimes referred to as a transport block (TB).

At the receiver UE, the MAC layer is responsible of de-multiplexing the data contained in a MAC PDU. That is, given a received transport block (e.g., delivered by the PHY layer to the MAC layer), the MAC layer recovers data (e.g., packets) belonging to same or different LCHs/LCGs.

In some cases, MAC control elements (CEs) are inserted by the MAC layer of the transmitter UE during or after the multiplexing operation. At the receiver end, the MAC CEs are extracted by the MAC layer as part of its operations.

In LTE V2X communication is broadcast at the PHY layer. Each service is associated with one L2 destination ID and potentially one service type, which is in turn mapped to one transmit profile. Two different services always have different L2 destination IDs and may or may not have different service types and corresponding transmit profiles. Since the L2 destination IDs are different, packets from different services are not multiplexed together. Hence there is no problem that a UE may be in a situation to multiplex two packets with different transmission profiles.

In NR SL, packets belonging to different services may still be associated with the same L2 destination ID. Potentially, a UE may have to decide whether/how to multiplex packets with different service types.

The core idea of some embodiments of the present disclosure is to define rules for UE to determine which communication profile shall be applied in case UE has data with different communication profiles (e.g., belonging to different service types, etc.) for transmission. Particularly relevant is the problem of multiplexing data with different communication profiles in a single transport block (TB). The data may correspond to a data from a logical channel (LCH) or from a logical channel group (LCG) and may belong to one service type or traffic type.

In one embodiment, the communication profiles of the different data are compared to determine which features are common to all of them. For example, the UE may select a communication profile which is suitable for/associated with all services/traffic types/LCHs/LCGs to apply. In an example, the two communication profiles are compared to determine which features are common to all services/traffic types/LCHs/LCGs with data available. For example, if the communication profile explicitly lists which features are supported, only the features that are supported by all the communication profiles are used.

In some embodiments, a dependency of features may be defined. For example, support for feature B may imply support for feature A. The feature used for transmission may be thus any of the features that are explicitly or implicitly part of all the corresponding communication profiles.

In some embodiments, UE determines which communication profile to apply according to service/traffic type/LCH/LCG with highest priority. In other words, the communication profile associated with service/traffic type/LCH/LCG with highest priority is selected among all communication profiles.

In some embodiments, for a UE, if there are multiple communication profiles available to select, the UE may select the communication profile with highest priority level to apply.

In some embodiments, packets may be not multiplexed (i.e., they are transmitted separately) if they do not have a same communication profile. For example, if there is no communication profile which is associated with all services/traffic types/LCHs/LCGs with data available, multiplexing of services/traffic types/LCHs/LCGs is disabled (i.e., they are transmitted separately) always or if they do not have a same communication profile.

In some embodiments, for a given SL grant, a communication profile may be determined. For transmission using that grant, the UE may only select data from services/traffic types/LCHs/LCGs which are associated with the communication profile to build a MAC PDU. The selection follows the ordinary logical channel prioritization procedure. The communication profile may be determined by a gNB, by the transmitter UE, or by another UE (e.g., the intended receiver UE or a controlling UE).

In some embodiments, UE uses only features from a predefined or (pre-)configured set of features (e.g., features from Rel-16, features specified as part of a carrier/cell/pool (pre-)configuration, etc.). This rule may be applicable always or only whenever the communication profiles of the packets are different.

For any one of the above embodiments, UE may apply which embodiment/option to select a communication profile according to configuration or pre-configuration. In some embodiments, the configuration may be signaled to UE by a gNB, a core network entity (e.g., SMF or AMF) or another controlling UE.

### Communication Profile Configuration

### Communication Profile Configuration Elements

A communication profile may be defined to comprise at least one of the following parameters or information elements which are associated with the communication profile:
a unique index and/or identifier (ID) associated with the communication profile;
one or more service types and/or traffic types;
one or more L2 destination IDs;
one or more L2 source IDs;
one or more indices or indicators of one or more Third Generation Partnership Project (3GPP) releases;
one or more indices or indicators of one or more 3GPP features and/or functionalities;
one or more transmission parameters (e.g., modulation and coding scheme (MCS), transmit power, modulation, modulation table, multi-antenna configuration);
one or more hybrid automatic repeat request (HARQ) retransmission modes (e.g., blind transmissions (i.e., without HARQ feedback), retransmissions based on HARQ ACK/NACK (e.g., for unicast or groupcast option 2), retransmissions based on HARQ NACK only (e.g., groupcast option 1));
one or more resource pool identifiers (e.g., a resource pool may be a set of time-frequency radio resources that can be used for SL transmission);
one or more cast types (e.g., unicast, groupcast, or broadcast);
one or more indices and/or IDs of one or more logical channels;
one or more indices and/or IDs of one or more logical channel groups;
one or more indices and/or IDs of one or more radio bearers;
one or more service priority levels and/or traffic priority levels;
one or more Quality of Service (QoS) indicators and/or requirements; and
a priority level associated with the communication profile.

A communication profile may be represented/abstracted by the index associated with the communication profile, so that communication entities can unambiguously locate the same profile via the index.

Alternatively, a communication profile may be represented/abstracted by the associated service/traffic types or L2 destination IDs based on which communication can unambiguously locate the same profile.

In another alternative, a communication profile may be represented/abstracted by the associated any other parameters/information elements as described in the above texts.

Similarly, a communication profile may be mapped to at least one of the above parameters/information elements.

### Configuration of Communication Profiles

A list of communication profiles may be configured to a UE by a gNB, a core network entity (e.g., SMF or AMF), a controlling UE via at least one of the following signaling alternatives:
System information
Dedicated RRC signaling
MAC CE
L1 signaling
Control PDUs of a protocol layer (e.g., SDAP, PDCP, RLC or an adaptation layer in case of SL relay)

A list of communication profiles may be preconfigured to a UE.

Alternatively, a list of communication profiles may be captured in specs in a hard-coded fashion.

### Determination of the Communication Profile to Use

For a UE, whenever a packet or PDU is initiated for transmission, the UE may apply a communication profile for the transmission. The communication profile may be determined via one of the following options:
Determined from the type of the service (e.g., through a static of (pre-)configured mapping). This is the legacy behavior.
Determined by a gNB. In this case, the gNB may signal the UE of the communication profile ahead of the transmission, via RRC signaling, MAC CE, L1 signaling such as DCI. In case of Mode 1 scheduling, the communication profile may be signaled to the UE together with a SL grant carried in a DCI signaling.
Determined by a controlling UE (i.e., another UE). In this case, the controlling UE may signal the UE of the communication profile ahead of the transmission, via RRC signaling, MAC CE, L1 signaling such as SCI.
Determined by a core network entity (e.g., SMF or AMF).
Determined by the UE itself. This option is applicable especially in case the UE is out of coverage.

In some embodiments, a selection rule may be (pre-)configured to the UE or hard coded in the specifications. The UE determines which communication profile to apply for a transmission based on the rule.

In some embodiments, the communication profile is determined according to service/traffic types associated with the transmission. In some embodiments, the communication profile is determined according to L2 IDs (destination or source) associated with the transmission. In some embodiments, the communication profile is determined according to 3GPP releases associated with the transmission. In some embodiments, the communication profile is determined according to 3GPP features associated with the transmission. In some embodiments, the communication profile is determined according to cast types associated with the transmission. In some embodiments, the communication profile is determined according to LCHs/LCGs/RBs associated with the transmission. In some embodiments, it is important to ensure all UEs involved in a same communication (i.e., transmission or reception) to locate a same communication profile. When the transmitter UE selects a certain communication profile to perform the transmission of a certain service, the same communication profile needs also to be selected by the receiver UEs in order to send a response message (if needed) to the transmitter UE.

In some embodiments, a transmitter UE may signal its receiver UEs of which communication profile is being applied by the transmitter UE. The signaling may be carried via at least one of the following signaling alternatives:
RRC signaling
MAC CE
L1 signaling (e.g., SCI)
Control PDUs of a protocol layer (e.g., SDAP, PDCP, RLC or an adaptation layer in case of SL relay)

In some other embodiments, the alignment of the communication profile to be selected by the transmitter and Receiver UEs can be done according to the following:
The transmitter UE, when selecting a certain communication profile for transmitting, it includes in the transmission some information about what communication profile has been selected.
This information can be an ID with which the communication profile can be identified, a set of capabilities that the transmitter UE is using for the transmission, and/or a set of configuration that the TX is using for the transmission.

The transmitter UE forwards traffic information to the receiver UE so the receiver UE can select the same communication profile as the transmitter UE when sending the response message.

With the embodiments, sidelink UEs from different releases are allowed to coexist:
It ensures that a legacy transmission format is used when transmitting to legacy UEs.
It ensures that, that multiplexing of data at a transmitter UE is done in a way that is compatible with the capabilities of the intended destination.
It ensures that new features are only configured when they are compatible with the different services that the UE is participating in.

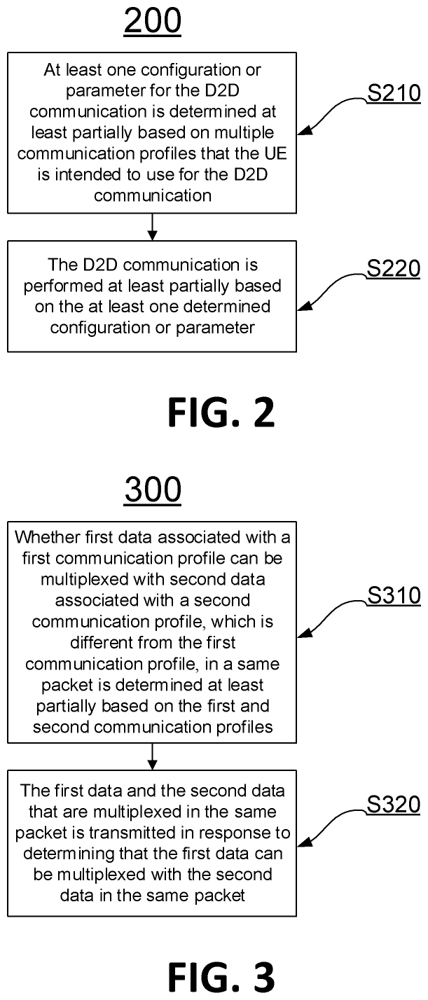

FIG. 2 is a flow chart of an exemplary method 200 at a UE for D2D communication according to an embodiment of the present disclosure. The method 200 may be performed at a UE (e.g., the UEs 100) for communication profile based D2D communication. The method 200 may comprise steps S210 and S220. However, the present disclosure is not limited thereto. In some other embodiments, the method 200 may comprise more steps, less steps, different steps, or any combination thereof. Further the steps of the method 200 may be performed in a different order than that described herein. Further, in some embodiments, a step in the method 200 may be split into multiple sub-steps and performed by different entities, and/or multiple steps in the method 200 may be combined into a single step.

The method 200 may begin at step S210 where at least one configuration or parameter for the D2D communication may be determined at least partially based on multiple communication profiles that the UE is intended to use for the D2D communication.

At step S220, the D2D communication may be performed at least partially based on the at least one determined configuration or parameter.

In some embodiments, each of the multiple communication profiles may correspond to one of multiple service types. In some embodiments, each of the communication profiles may comprise at least one of: —a unique index and/or identifier (ID) associated with the communication profile; —one or more service types and/or traffic types; —one or more L2 destination IDs; —one or more L2 source IDs; —one or more indices or indicators of one or more Third Generation Partnership Project (3GPP) releases; —one or more indices or indicators of one or more 3GPP features and/or functionalities; —one or more transmission parameters; —one or more hybrid automatic repeat request (HARQ) retransmission modes; —one or more resource pool identifiers; —one or more cast types; —one or more indices and/or IDs of one or more logical channels; —one or more indices and/or IDs of one or more logical channel groups; —one or more indices and/or IDs of one or more radio bearers; —one or more service priority levels and/or traffic priority levels; —one or more Quality of Service (QoS) indicators and/or requirements; and—a priority level associated with the communication profile.

In some embodiments, the step S210 may comprise: for each of the at least one configuration or parameter, determining whether the configuration or parameter is compatible with each of the multiple communication profiles or not; and setting the configuration or parameter to indicate that a corresponding feature of the UE is disabled in response to determining that the configuration or parameter is not compatible with at least one of the multiple communication profiles. In some embodiments, the step S210 may comprise: for each of the at least one configuration or parameter, determining whether the configuration or parameter is compatible with each of the multiple communication profiles or not; and setting the configuration or parameter to indicate that the corresponding feature of the UE is enabled in response to determining that the configuration or parameter is compatible with all of the multiple communication profiles.

In some embodiments, the multiple communication profiles may comprise at least one of: —all or a subset of the communication profiles that are intended to be used by the UE for the D2D communication; —all or a subset of the communication profiles that are configured at the UE for the D2D communication; and—all or a subset of the communication profiles that are received by the UE from another UE for the D2D communication. In some embodiments, the multiple communication profiles may comprise at least one of: one or more first communication profiles related to both D2D transmission and D2D reception, one or more second communication profiles related to D2D reception only, and one or more third communication profiles related to D2D transmission only. In some embodiments, the at least one configuration or parameter may comprise at least one of: —a first configuration of whether a sidelink (SL) communication feature can be enabled for the UE as both a receiver and a transmitter; —a second configuration of whether the SL communication feature can be enabled for the UE as a receiver only; and—a third configuration of whether the SL communication feature can be enabled for the UE as a transmitter only.

In some embodiments, the step S210 may comprise at least one of: determining the first configuration at least partially based on determining whether the SL communication feature is compatible with each of the multiple communication profiles; determining the second configuration at least partially based on determining whether the SL communication feature is compatible with each of the first and second communication profiles; determining the third configuration at least partially based on determining whether the SL communication feature is compatible with each of the first and third communication profiles. In some embodiments, when the at least one configuration or parameter comprises the first configuration, before the step S220, the method 200 may further comprise: receiving an indicator indicating a configuration of the SL communication feature of another UE for its D2D communication with the UE or not, wherein the step S220 may comprise one of: at least partially in response to determining that the received indicator indicates that the SL communication feature is enabled at the other UE and that the first configuration indicates that the SL communication feature can be enabled, performing the D2D communication between the UE and the other UE with the SL communication feature enabled; and in response to determining that the received indicator indicates that the SL communication feature is not enabled at the other UE and/or that the first configuration indicates that the SL communication feature cannot be enabled, performing the D2D communication between the UE and the other UE with the SL communication feature disabled.

In some embodiments, when the at least one configuration or parameter comprises the second configuration, before the step S220, the method 200 may further comprise: receiving an indicator indicating a configuration of the SL communication feature of another UE for the D2D communication to be transmitted to the UE or not, wherein the step S220 may comprise one of: at least partially in response to determining that the received indicator indicates that the SL communication feature is enabled at the other UE and that the second configuration indicates that the SL communication feature can be enabled, performing the D2D communication from the other UE to the UE with the SL communication feature enabled; and in response to determining that the received indicator indicates that the SL communication feature is not enabled at the other UE and/or that the second configuration indicates that the SL communication feature cannot be enabled, performing the D2D communication from the other UE to the UE with the SL communication feature disabled.

In some embodiments, when the at least one configuration or parameter comprises the third configuration, before the step S220, the method 200 may further comprise: receiving an indicator indicating a configuration of the SL communication feature of another UE for the D2D communication to be transmitted from the UE or not, wherein the step S220 may comprise one of: at least partially in response to determining that the received indicator indicates that the SL communication feature is enabled at the other UE and that the third configuration indicates that the SL communication feature can be enabled, performing the D2D communication from the UE to the other UE with the SL communication feature enabled; and in response to determining that the received indicator indicates that the SL communication feature is not enabled at the other UE and/or that the third configuration indicates that the SL communication feature cannot be enabled, performing the D2D communication from the UE to the other UE with the SL communication feature disabled.

In some embodiments, the received indicator may indicate whether the other UE is intended to use the SL communication feature or not. In some embodiments, the received indicator may indicate whether the other UE is allowed to use the SL communication feature or not. In some embodiments, the SL communication feature may comprise at least one of: —SL discontinuous reception (DRX); and—partial sensing.

In some embodiments, the at least one configuration or parameter may correspond to all or a subset of features to be used by the UE for D2D communication. In some embodiments, the multiple communication profiles may comprise none of the first and the third communication profiles. In some embodiments, the step S210 may comprise: receiving, from a network node, the at least one configuration or parameter. In some embodiments, before the step of receiving, from a network node, the at least one configuration or parameter, the method 200 may further comprise transmitting, to the network node, at least one of: —a list of service types that are intended to be used by the UE for the D2D communication; —a list of corresponding communication profiles; and—a list of corresponding destinations.

FIG. 3 is a flow chart of an exemplary method 300 at a UE for D2D communication is provided according to an embodiment of the present disclosure. The method 300 may be performed at a UE (e.g., the UEs 100) for communication profile based D2D communication. The method 300 may comprise steps S310 and S320. However, the present disclosure is not limited thereto. In some other embodiments, the method 300 may comprise more steps, less steps, different steps, or any combination thereof. Further the steps of the method 300 may be performed in a different order than that described herein. Further, in some embodiments, a step in the method 300 may be split into multiple sub-steps and performed by different entities, and/or multiple steps in the method 300 may be combined into a single step.

The method 300 may begin at step S310 where whether first data associated with a first communication profile can be multiplexed with second data associated with a second communication profile, which is different from the first communication profile, in a same packet may be determined at least partially based on the first and second communication profiles.

At step S320, the first data and the second data that are multiplexed in the same packet may be transmitted in response to determining that the first data can be multiplexed with the second data in the same packet.

In some embodiments, each of the first and second communication profiles may comprise at least one of: —a unique index and/or identifier (ID) associated with the communication profile; —one or more service types and/or traffic types; —one or more L2 destination IDs; —one or more L2 source IDs; —one or more indices or indicators of one or more Third Generation Partnership Project (3GPP) releases; —one or more indices or indicators of one or more 3GPP features and/or functionalities; —one or more transmission parameters; —one or more hybrid automatic repeat request (HARQ) retransmission modes; —one or more resource pool identifiers; —one or more cast types; —one or more indices and/or IDs of one or more logical channels; —one or more indices and/or IDs of one or more logical channel groups; —one or more indices and/or IDs of one or more radio bearers; —one or more service priority levels and/or traffic priority levels; —one or more Quality of Service (QoS) indicators and/or requirements; and—a priority level associated with the communication profile.

In some embodiments, the step S310 may comprise: determining whether the first data can be multiplexed with the second data in the same packet or not based on all the communication profiles that are associated with data to be multiplexed with the first and second data in the same packet. In some embodiments, the step S310 may comprise: determining a set of common features enabled by all the communication profiles; and determining whether there is a third communication profile that is compatible with the determined set of common features and not compatible with rest of all the features if any; and determining that the first data can be multiplexed with the second data in the same packet in response to determining that there is the third communication profile.

In some embodiments, the step of determining a set of common features enabled by all the communication profiles may comprise: for each of the features enabled by at least one of all the communication profiles, determining whether the feature is enabled or not by all the communication profiles explicitly or implicitly; and determining the feature is a common feature in response to determining that the feature is enabled by all the communication profiles explicitly or implicitly. In some embodiments, the method 300 may further comprise: in response to determining that there are multiple third communication profiles, selecting one of the multiple third communication profiles at least partially based on their priority levels. In some embodiments, the step of selecting one of the third communication profiles at least partially based on their priority levels may comprise: selecting one of the multiple third communication profiles that has the highest priority level and that is associated with at least one of: —a specific service type; —a specific traffic type; —a specific logical channel (LCH); and—a specific logical channel group (LCG).

In some embodiments, the method 300 may further comprise: transmitting the first data and the second data separately in response to determining that there is no third communication profile. In some embodiments, the step S310 may comprise: determining whether each of the first and second communication profiles is compatible with a fourth communication profile associated with the same packet or not; and determining that the first data can be multiplexed with the second data in the same packet in response to determining that both the first and second communication profiles are compatible with the fourth communication profile; and determining that the first data cannot be multiplexed with the second data in the same packet in response to determining that at least one of the first and second communication profiles is not compatible with the fourth communication profile. In some embodiments, the fourth communication profile may be determined by a network node, the UE, or another UE.

In some embodiments, after the step of determining a set of common features enabled by all the communication profiles and before the step of determining whether there is a third communication profile, the method 300 may further comprise: for each of the set of common features, determining whether the feature is comprised by a predefined or preconfigured set of features; and removing the feature from the set of common features in response to determining that the feature is not comprised by the predefined or preconfigured set of features. In some embodiments, the predefined or preconfigured set of features may be at least one of: —a set of features from a specific 3GPP release; and—a set of features specified as part of a configuration or pre-configuration for a carrier, a cell, and/or a pool.

In some embodiments, before the step S310, the method 300 may further comprise: receiving a configuration or a pre-configuration indicating how to select a communication profile for the packet; and selecting a communication profile for the packet, wherein the step of determining whether the first data can be multiplexed with the second data in the packet or not is performed further based on the selected communication profile. In some embodiments, the configuration or a pre-configuration may be received from one of a base station, a core network entity, and another controlling UE.

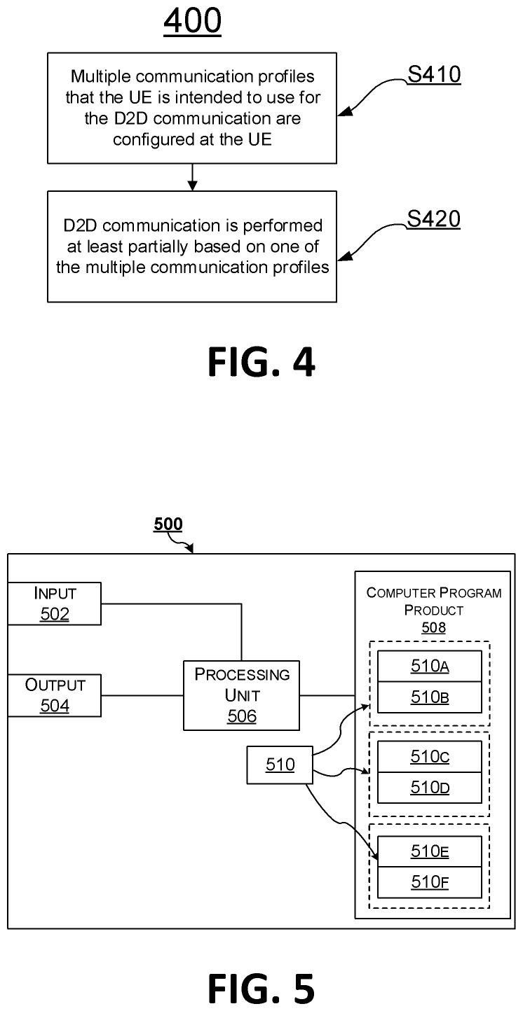

FIG. 4 is a flow chart of an exemplary method 400 at a UE for D2D communication according to an embodiment of the present disclosure. The method 400 may be performed at a UE (e.g., the UEs 100) for communication profile based D2D communication. The method 400 may comprise steps S410 and S420. However, the present disclosure is not limited thereto. In some other embodiments, the method 400 may comprise more steps, less steps, different steps, or any combination thereof. Further the steps of the method 400 may be performed in a different order than that described herein. Further, in some embodiments, a step in the method 400 may be split into multiple sub-steps and performed by different entities, and/or multiple steps in the method 400 may be combined into a single step.

The method 400 may begin at step S410 where multiple communication profiles that the UE is intended to use for the D2D communication may be configured at the UE.

At step S420, the D2D communication may be performed at least partially based on one of the multiple communication profiles.

In some embodiments, each of the multiple communication profiles may comprise at least one of following parameters or information elements (IEs): —a unique index and/or identifier (ID) associated with the communication profile; —one or more service types and/or traffic types; —one or more L2 destination IDs; —one or more L2 source IDs; —one or more indices or indicators of one or more Third Generation Partnership Project (3GPP) releases; —one or more indices or indicators of one or more 3GPP features and/or functionalities; —one or more transmission parameters; —one or more hybrid automatic repeat request (HARQ) retransmission modes; —one or more resource pool identifiers; —one or more cast types; —one or more indices and/or IDs of one or more logical channels; —one or more indices and/or IDs of one or more logical channel groups; —one or more indices and/or IDs of one or more radio bearers; —one or more service priority levels and/or traffic priority levels; —one or more Quality of Service (QoS) indicators and/or requirements; and—a priority level associated with the communication profile. In some embodiments, a communication profile is identified by at least one of its parameters, at least one of its information elements (IEs), or any combination thereof.

In some embodiments, a communication profile may be mapped to at least one of its parameters, at least one of its information elements (IEs), or any combination thereof. In some embodiments, before the step S410, the method 400 may comprise: receiving at least one of the multiple communication profiles from at least one of a base station, a core network (CN) entity, and a controlling UE. In some embodiments, the reception of the at least one communication profile may be performed via at least one of: —system information; —dedicated radio resource control (RRC) signaling; —a medium access control (MAC) control element (CE); —L1 signaling; and—a control protocol data unit (PDU) of a protocol layer.

In some embodiments, the step S410 may be performed in a provisioning procedure or in the UE's manufacture stage. In some embodiments, the provisioning procedure may comprise a procedure for configuration and/or pre-configuration at the UE. In some embodiments, before the step S420, the method 400 may further comprise: determining the one communication profile for the D2D communication when a packet or PDU is initiated for the D2D communication. In some embodiments, the step of determining the one communication profile may comprise at least one of: —determining the communication profile based on a static configuration or a pre-configuration at the UE; —receiving, from a base station, an indicator indicating the communication profile to be used for the D2D communication; —receiving, from a controlling UE, an indicator indicating the communication profile to be used for the D2D communication; —receiving, from a CN entity, an indicator indicating the communication profile to be used for the D2D communication; and—determining the communication profile by the UE itself.

In some embodiments, the step of determining the one communication profile may comprise determining the one communication profile based on at least one of: —one or more service types and/or traffic types associated with the packet or PDU; —one or more L2 IDs associated with the packet or PDU; —one or more 3GPP releases associated with the packet or PDU; —one or more 3GPP features associated with the packet or PDU; —one or more cast types associated with the packet or PDU; and—one or more LCHs, LCGs, and/or resource blocks (RBs) associated with the packet or PDU.

In some embodiments, after the step of determining the one communication profile for the D2D communication and before the step S420, the method 400 may further comprise: signaling another UE of the determined communication profile via at least one of: —RRC signaling; —a MAC CE; —L1 signaling; and—a control protocol data unit (PDU) of a protocol layer. In some embodiments, the step S420 may comprise: transmitting the packet or the PDU together with an indicator indicating the communication profile determined for the transmission of the packet or the PDU.

In some embodiments, before the step S420, the method 400 may further comprise: receiving, from another UE, a packet or PDU together with an indicator indicating one of the multiple communication profiles that is determined by the other UE for the transmission of the packet or the PDU; and transmitting, to the other UE, a response message corresponding to the received packet or PDU at least partially based on the indicated communication profile.

FIG. 5 schematically shows an embodiment of an arrangement which may be used in a UE according to an embodiment of the present disclosure. Comprised in the arrangement 500 are a processing unit 506, e.g., with a Digital Signal Processor (DSP) or a Central Processing Unit (CPU). The processing unit 506 may be a single unit or a plurality of units to perform different actions of procedures described herein. The arrangement 500 may also comprise an input unit 502 for receiving signals from other entities, and an output unit 504 for providing signal(s) to other entities. The input unit 502 and the output unit 504 may be arranged as an integrated entity or as separate entities.

Furthermore, the arrangement 500 may comprise at least one computer program product 508 in the form of a non-volatile or volatile memory, e.g., an Electrically Erasable Programmable Read-Only Memory (EEPROM), a flash memory and/or a hard drive. The computer program product 508 comprises a computer program 510, which comprises code/computer readable instructions, which when executed by the processing unit 506 in the arrangement 500 causes the arrangement 500 and/or the UE in which it is comprised to perform the actions, e.g., of the procedure described earlier in conjunction with FIG. 2 through FIG. 4 or any other variant.

The computer program 510 may be configured as a computer program code structured in computer program modules 510A to 510B. Hence, in an exemplifying embodiment when the arrangement 500 is used in the UE, the code in the computer program of the arrangement 500 includes: a module 510A for determining at least one configuration or parameter for the D2D communication at least partially based on multiple communication profiles that the UE is intended to use for the D2D communication; and a module 510B for performing the D2D communication at least partially based on the at least one determined configuration or parameter.

Additionally or alternatively, the computer program 510 may be configured as a computer program code structured in computer program modules 510C to 510D. Hence, in an exemplifying embodiment when the arrangement 500 is used in the UE, the code in the computer program of the arrangement 500 includes: a module 510C for determining whether first data associated with a first communication profile can be multiplexed with second data associated with a second communication profile, which is different from the first communication profile, in a same packet at least partially based on the first and second communication profiles; and a module 510D for transmitting the first data and the second data that are multiplexed in the same packet in response to determining that the first data can be multiplexed with the second data in the same packet.

Additionally or alternatively, the computer program 510 may be configured as a computer program code structured in computer program modules 510E to 510F. Hence, in an exemplifying embodiment when the arrangement 500 is used in the UE, the code in the computer program of the arrangement 500 includes: a module 510E for configuring, at the UE, multiple communication profiles that the UE is intended to use for the D2D communication; and a module 510F for performing the D2D communication at least partially based on one of the multiple communication profiles.

The computer program modules could essentially perform the actions of the flow illustrated in FIG. 2 through FIG. 4, to emulate the UE. In other words, when the different computer program modules are executed in the processing unit 506, they may correspond to different modules in the UE.

Although the code means in the embodiments disclosed above in conjunction with FIG. 5 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE.

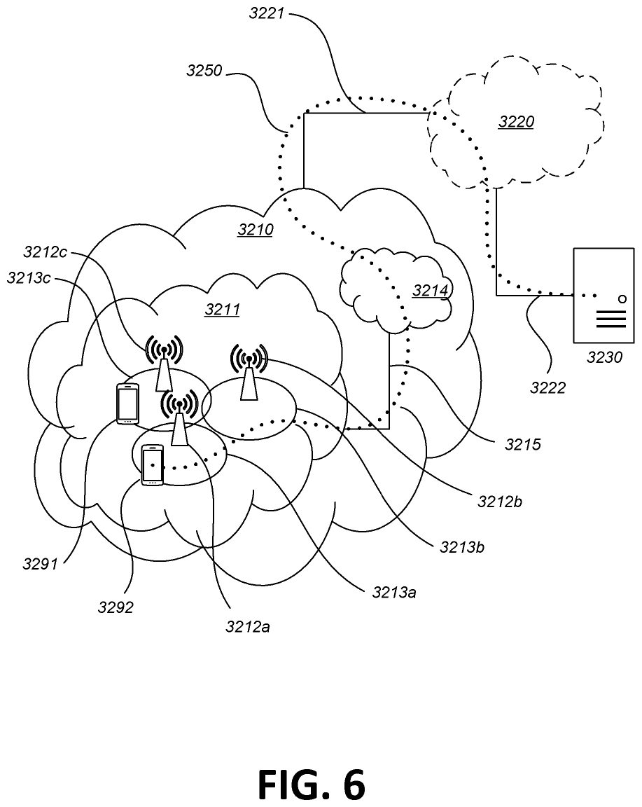

With reference to FIG. 6, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 6 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

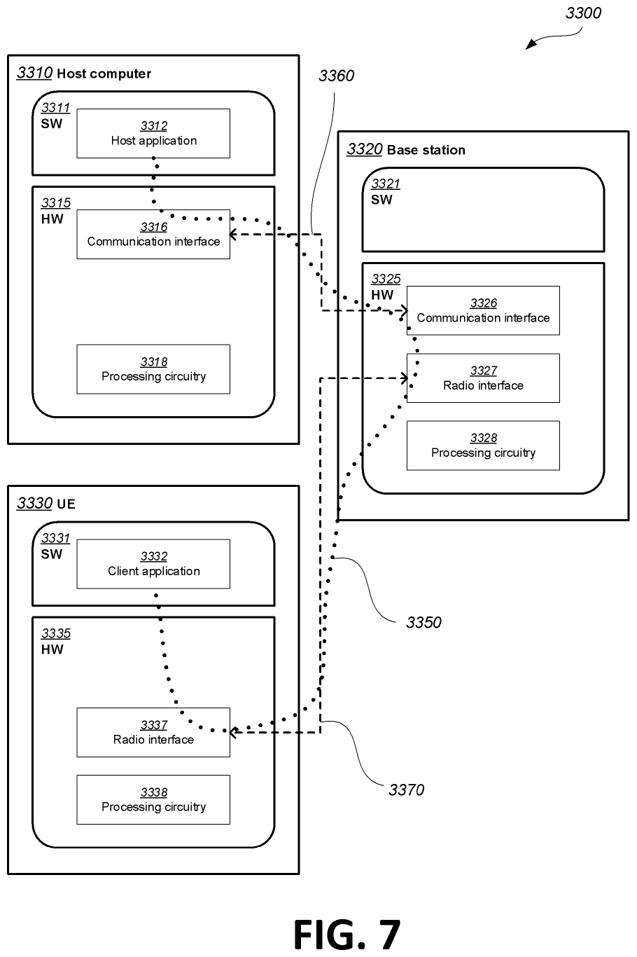

Example implementations, in accordance with an embodiment, of the UE, base station and host computer discussed in the preceding paragraphs will now be described with reference to FIG. 7. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 7) served by the base station 3320. The communication interface 3326 may be configured to facilitate a connection 3360 to the host computer 3310. The connection 3360 may be direct or it may pass through a core network (not shown in FIG. 7) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 7 may be identical to the host computer 3230, one of the base stations 3212a, 3212b, 3212c and one of the UEs 3291, 3292 of FIG. 6, respectively. This is to say, the inner workings of these entities may be as shown in FIG. 7 and independently, the surrounding network topology may be that of FIG. 6.

In FIG. 7, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure One or more of the various embodiments improve the performance of OTT services provided to the UE 3330 using the OTT connection 3350, in which the wireless connection 3370 forms the last segment. More precisely, the teachings of these embodiments may improve the latency and power consumption and thereby provide benefits such as reduced user waiting time, better responsiveness, extended battery lifetime.

A measurement procedure may be provided for the purpose of monitoring data rate, latency, and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency, and the like. The measurements may be implemented in that the software 3311, 3331 causes messages to be transmitted, in particular empty or ‘dummy’ messages, using the OTT connection 3350 while it monitors propagation times, errors etc.

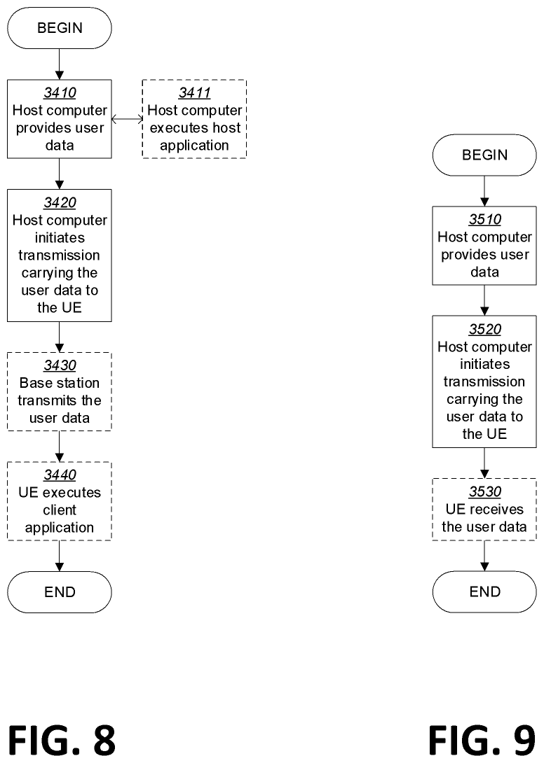

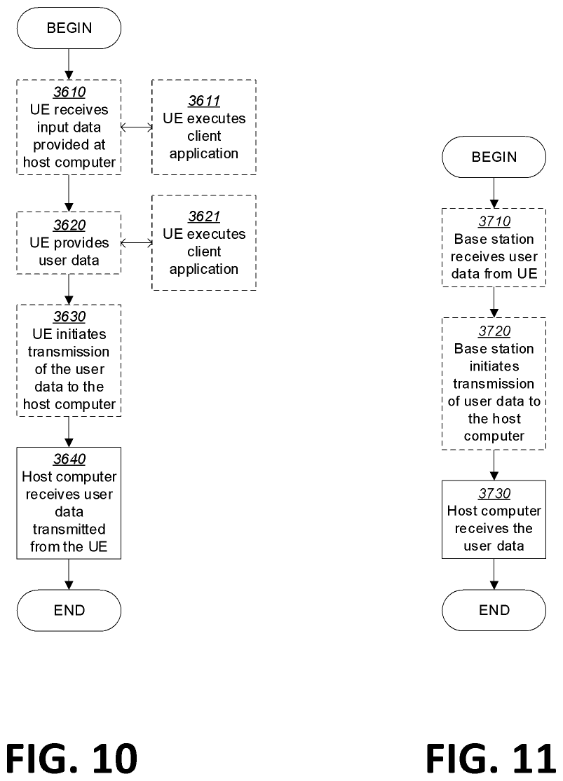

FIG. 8 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 8 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 9 is a flowchart illustrating a method implemented in a communication system, in accordance with one embodiment. The communication system includes a host computer, a base station and a UE which may be those described with reference to FIG. 6 and FIG. 7. For simplicity of the present disclosure, only drawing references to FIG. 9 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

FIG. 10 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 10 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 11 is a flowchart illustrating a method implemented in a communication system, in accordance with one embodiment. The communication system includes a host computer, a base station and a UE which may be those described with reference to FIG. 6 and FIG. 7. For simplicity of the present disclosure, only drawing references to FIG. 11 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

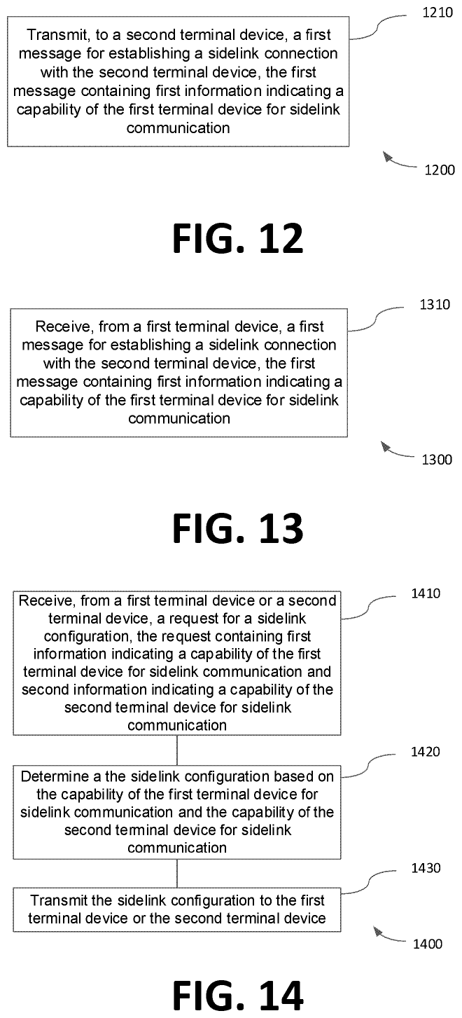

FIG. 12 is a flowchart illustrating a method 1200 according to an embodiment of the present disclosure. The method 1200 can be performed by a first terminal device, e.g., a UE initiating sidelink communication.

At block 1210, a first message for establishing a sidelink connection with a second terminal device is transmitted to the second terminal device. The first message contains first information indicating a capability of the first terminal device for sidelink communication. For example, the first message can be transmitted when the first terminal device has some traffic data to transmit and wishes to establish a sidelink connection with other terminal devices in its proximity. The first message may be a request for sidelink connection establishment, which may be a broadcast message. In an example, the first terminal device may receive, from a network node (e.g., a serving gNB of the first terminal device), an instruction or configuration to include the first information in the first message.

The first information may indicate one or more of: a transmission format or 3GPP release the first terminal device supports, a list of sidelink features the first terminal device supports, a list of sidelink features the first terminal device wishes to use, or a list of sidelink features the first terminal device is currently using.

In an example, the first terminal device may receive, from the second terminal device, a second message as a response to the first message. The second message may contain second information indicating a capability of the second terminal device for sidelink communication. Here, the second information may indicate one or more of: a transmission format or 3GPP release the second terminal device supports, a list of sidelink features the second terminal device supports, a list of sidelink features the second terminal device wishes to use, a list of sidelink features the second terminal device is currently using, or a list of sidelink features the first terminal device and the second terminal device both support, wish to use, and/or are currently using.

As an example, the sidelink features may include sidelink DRX.

In an example, after receiving the second message, the first terminal device may determine a sidelink configuration based on the capability of the first terminal device for sidelink communication and the capability of the second terminal device for sidelink communication, and transmit the sidelink configuration to the second terminal device. Here, the sidelink configuration may configure only those features both terminal devices support, wish to use, and/or are currently using.

Alternatively, the first terminal device may transmit a request for a sidelink configuration to a network node (e.g., a serving gNB of the first terminal device). The request may contain the first information and the second information. Then, the first terminal device may receive the sidelink configuration (e.g., determined by the network node based on the capability of the first terminal device for sidelink communication and the capability of the second terminal device for sidelink communication) from the network node, and transmit the sidelink configuration to the second terminal device.

Alternatively, the first terminal device may receive a sidelink configuration (e.g., determined by the second terminal device based on the capability of the first terminal device for sidelink communication and the capability of the second terminal device for sidelink communication) from the second terminal device.

Here, the communication (including e.g., the first message, the second message, and/or the sidelink configuration) between the first terminal device and the second terminal device can be performed via PC5-RRC signaling, PC5-S, discovery signaling, MAC CE, or L1 signaling (e.g., PSSCH, PSCCH, or PSFCH). The communication (including e.g., the request for the sidelink configuration and/or the sidelink configuration) between the first terminal device and the network node can be performed via RRC signaling, MAC CE, or L1 signaling (Physical Random Access Channel (PRACH), Physical Uplink Control Channel (PUCCH), or Physical Downlink Control Channel (PDCCH)).

FIG. 13 is a flowchart illustrating a method 1300 according to an embodiment of the present disclosure. The method 1300 can be performed by a second terminal device.

At block 1310, a first message for establishing a sidelink connection with the second terminal device is received from a first terminal device. The first message contains first information indicating a capability of the first terminal device for sidelink communication. The first message may be a request for sidelink connection establishment, which may be a broadcast message.

The first information may indicate one or more of: a transmission format or 3GPP release the first terminal device supports, a list of sidelink features the first terminal device supports, a list of sidelink features the first terminal device wishes to use, or a list of sidelink features the first terminal device is currently using.

In an example, the second terminal device may identify the capability of the first terminal device for sidelink communication by using an Abstract Syntax Notation One (ASN.1) decoder to decode all information on 3GPP releases and/or sidelink features supported by the first terminal device in the first message. For example, the ASN.1 decoder in the second terminal device may be configured to look for all extension markers in the ASN.1 code (for example, a suffix “-rXX” where XX denotes a 3GPP release, e.g., “-r16” denotes Rel-16, or a suffix “-vXy” where Xy denotes a version number) in the first message to identify which 3GPP release or sidelink feature(s) the first terminal device supports, wishes to use, and/or is currently using.

In an example, the second terminal device may transmit, to the first terminal device, a second message in response to the first message. The second message may contain second information indicating a capability of the second terminal device for sidelink communication. Here, the second information may indicate one or more of: a transmission format or 3GPP release the second terminal device supports, a list of sidelink features the second terminal device supports, a list of sidelink features the second terminal device wishes to use, a list of sidelink features the second terminal device is currently using, or a list of sidelink features the first terminal device and the second terminal device both support, wish to use, and/or are currently using. For example, the second terminal device may receive, from a network node (e.g., a serving gNB of the second terminal device), an instruction or configuration to include the second information in the second message.

As an example, the sidelink features may include sidelink DRX.

In an example, after receiving the first message, the second terminal device may discard the first message when the second terminal device does not support the transmission format or 3GPP release the first terminal device supports, or when there is no sidelink capability or feature the first terminal device and the second terminal device both support, wish to use, and/or are currently using. Here, the second terminal device not supporting the 3GPP release the first terminal device supports may mean that the second terminal device uses or implements a 3GPP release that is older than the 3GPP release the first terminal device supports.

In an example, after receiving the first message, the second terminal device may determine a sidelink configuration based on the capability of the first terminal device for sidelink communication and the capability of the second terminal device for sidelink communication; and transmit the sidelink configuration to the first terminal device.

Alternatively, the second terminal device may transmit a request for a sidelink configuration to a network node (e.g., a serving gNB of the second terminal device). The request may contain the first information and the second information. Then, the second terminal device may receive the sidelink configuration (e.g., determined by the network node based on the capability of the first terminal device for sidelink communication and the capability of the second terminal device for sidelink communication) from the network node, and transmit the sidelink configuration to the first terminal device.

Alternatively, the second terminal device may receive a sidelink configuration (e.g., determined by the first terminal device based on the capability of the first terminal device for sidelink communication and the capability of the second terminal device for sidelink communication) from the first terminal device.

Here, the communication (including e.g., the first message, the second message, and/or the sidelink configuration) between the first terminal device and the second terminal device can be performed via PC5-RRC signaling, PC5-S, discovery signaling, MAC CE, or L1 signaling (e.g., PSSCH, PSCCH, or PSFCH). The communication (including e.g., the request for the sidelink configuration and/or the sidelink configuration) between the second terminal device and the network node can be performed via RRC signaling, MAC CE, or L1 signaling (e.g., PRACH, PUCCH, or PDCCH).

FIG. 14 is a flowchart illustrating a method 1400 according to an embodiment of the present disclosure. The method 1400 can be performed by a network node, e.g., a serving gNB of a first terminal device or a second terminal device.

At block 1410, a request for a sidelink configuration is received from the first terminal device or the second terminal device. The request contains first information indicating a capability of the first terminal device for sidelink communication and second information indicating a capability of the second terminal device for sidelink communication.

Here, the first information may indicate one or more of: a transmission format or 3GPP release the first terminal device supports, a list of sidelink features the first terminal device supports, a list of sidelink features the first terminal device wishes to use, or a list of sidelink features the first terminal device is currently using. The second information may indicate one or more of: a transmission format or 3GPP release the second terminal device supports, a list of sidelink features the second terminal device supports, a list of sidelink features the second terminal device wishes to use, or a list of sidelink features the second terminal device is currently using.

As an example, the sidelink features may include sidelink DRX.

At block 1420, the sidelink configuration is determined based on the capability of the first terminal device for sidelink communication and the capability of the second terminal device for sidelink communication. Here, the sidelink configuration may configure only those features both terminal devices support, wish to use, and/or are currently using.

At block 1430, the sidelink configuration is transmitted to the first terminal device or the second terminal device.

Here, the communication (including e.g., the request for the sidelink configuration and/or the sidelink configuration) between the first or second terminal device and the network node can be performed via RRC signaling, MAC CE, or L1 signaling (e.g., PRACH, PUCCH, or PDCCH).

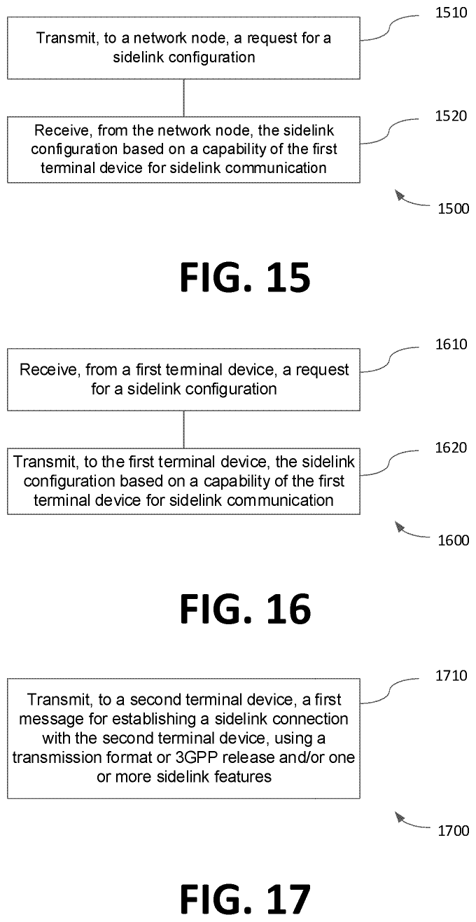

FIG. 15 is a flowchart illustrating a method 1500 according to an embodiment of the present disclosure. The method 1500 can be performed by a first terminal device, e.g., a UE initiating sidelink communication.

At block 1510, a request for a sidelink configuration is transmitted to a network node (e.g., a serving gNB of the first terminal device).

At block 1520, the sidelink configuration based on a capability of the first terminal device for sidelink communication is received from the network node.

Here, the capability of the first terminal device for sidelink communication may include one or more of: a transmission format or 3GPP release the first terminal device supports, a list of sidelink features the first terminal device supports, a list of sidelink features the first terminal device wishes to use, or a list of sidelink features the first terminal device is currently using. For example, the capability of the first terminal device for sidelink communication may be transmitted to the network node in the request or reported to the network node in advance.

In an example, the sidelink configuration may configure only the sidelink features the first terminal device supports, wishes to use, and/or is currently using.

Alternatively, the sidelink configuration may configure a resource pool used by one or more second terminal devices supporting the same transmission format or 3GPP release as the first terminal device and/or supporting, wishing to use, and/or being currently using the same sidelink features as the first terminal device.

Alternatively, the sidelink configuration may configure the first terminal device to perform sidelink communication with only one or more second terminal devices in a proximity of the first terminal device that support the same transmission format or 3GPP release as the first terminal device and/or support, wish to use, and/or are currently using the same sidelink features as the first terminal device.

Additionally or alternatively, the first terminal device may receive, from the network node, an indication of a transmission format or 3GPP release or one or more features for use by the first terminal device to establish a sidelink connection with one or more second terminal devices (i.e., to transmit a message for establishing a sidelink connection).

The communication (including e.g., the request for the sidelink configuration and/or the sidelink configuration) between the first terminal device and the network node can be performed via RRC signaling, MAC CE, or L1 signaling (e.g., PRACH, PUCCH, or PDCCH).

FIG. 16 is a flowchart illustrating a method 1600 according to an embodiment of the present disclosure. The method 1600 can be performed by a network node, e.g., a serving gNB of a first terminal device.

At block 1610, a request for a sidelink configuration is received from a first terminal device.

At block 1620, the sidelink configuration based on a capability of the first terminal device for sidelink communication is transmitted to the first terminal device.

Here, the capability of the first terminal device for sidelink communication may include one or more of: a transmission format or 3GPP release the first terminal device supports, a list of sidelink features the first terminal device supports, a list of sidelink features the first terminal device wishes to use, or a list of sidelink features the first terminal device is currently using. For example, the capability of the first terminal device for sidelink communication may be received from the first terminal device in the request or reported from the first terminal device in advance.

In an example, the sidelink configuration may configure only the sidelink features the first terminal device supports, wishes to use, and/or is currently using. For example, the network node may check capabilities (e.g., 3GPP releases or sidelink features) of all terminal devices within its coverage and generate the sidelink configuration that configures only those sidelink features the first terminal device supports, wishes to use, and/or is currently using.

Alternatively, the sidelink configuration may configure a resource pool used by one or more second terminal devices supporting the same transmission format or 3GPP release as the first terminal device and/or supporting, wishing to use, and/or being currently using the same sidelink features as the first terminal device.

Alternatively, the sidelink configuration may configure the first terminal device to perform sidelink communication with only one or more second terminal devices in a proximity of the first terminal device that support the same transmission format or 3GPP release as the first terminal device and/or support, wish to use, and/or are currently using the same sidelink features as the first terminal device.

Additionally or alternatively, the network node may transmit, to the first terminal device, an indication of a transmission format or 3GPP release or one or more features for use by the first terminal device to establish a sidelink connection with one or more second terminal devices (i.e., to transmit a message for establishing a sidelink connection). For example, the network node may determine the transmission format or 3GPP release or the one or more features based on capabilities (e.g., 3GPP releases or sidelink features) of potential terminal devices for sidelink communication in a proximity of the first terminal device.

The communication (including e.g., the request for the sidelink configuration and/or the sidelink configuration) between the first terminal device and the network node can be performed via RRC signaling, MAC CE, or L1 signaling (e.g., PRACH, PUCCH, or PDCCH).

FIG. 17 is a flowchart illustrating a method 1700 according to an embodiment of the present disclosure. The method 1700 can be performed by a first terminal device, e.g., a UE initiating sidelink communication.

At block 1710, a first message for establishing a sidelink connection with a second terminal device is transmitted to the second terminal device, using a transmission format or 3GPP release and/or one or more sidelink features. The first message may be a request for sidelink connection establishment, which may be a broadcast message.

In an example, the first terminal device may receive, from a network node (e.g., a serving gNB of the first terminal device), an indication of the transmission format or 3GPP release and/or the one or more sidelink features for use by the first terminal device to transmit the first message.

In an example, the communication (including e.g., the indication) between the first terminal device and the network node may be performed via dedicated RRC signaling, system information, MAC CE, control PDU of a protocol layer (e.g., Service Data Application Protocol (SDAP), Packet Data Convergence Protocol (PDCP), or Radio Link Control (RLC)), paging signaling, or L1 signaling (e.g., PDCCH).

Alternatively, the transmission format or 3GPP release may be a preconfigured default transmission format or 3GPP release, and/or the one or more sidelink features may be one or more preconfigured default sidelink features. The default transmission format or 3GPP release and/or the default sidelink feature(s) may be hardcoded in a specification.

Here, the communication (including e.g., the first message) between the first terminal device and the second terminal device can be performed via PC5-RRC signaling, PC5-S, discovery signaling, MAC CE, or L1 signaling (e.g., PSSCH, PSCCH, or PSFCH).

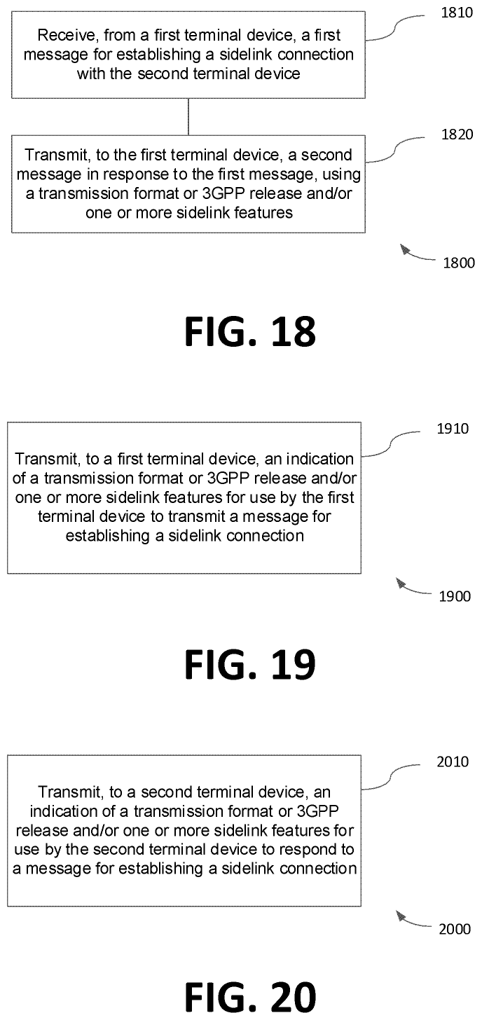

FIG. 18 is a flowchart illustrating a method 1800 according to an embodiment of the present disclosure. The method 1800 can be performed by a second terminal device.

At block 1810, a first message for establishing a sidelink connection with the second terminal device is received from a first terminal device.

At block 1820, a second message in response to the first message is transmitted to the first terminal device, using a transmission format or 3GPP release and/or one or more sidelink features.

In an example, the second terminal device can receive, from a network node (e.g., a serving gNB of the second terminal device), an indication of the transmission format or 3GPP release and/or the one or more sidelink features for use by the second terminal device to transmit the second message.

In an example, the communication (including e.g., the indication) between the second terminal device and the network node may be performed via dedicated RRC signaling, system information, MAC CE, control PDU of a protocol layer (e.g., SDAP, PDCP, or RLC), paging signaling, or L1 signaling (e.g., PDCCH).

Alternatively, the transmission format or 3GPP release may be a preconfigured default transmission format or 3GPP release, and/or the one or more sidelink features may be one or more preconfigured default sidelink features. The default transmission format or 3GPP release and/or the default sidelink feature(s) may be hardcoded in a specification.

Here, the communication (including e.g., the first message and/or the second message) between the first terminal device and the second terminal device can be performed via PC5-RRC signaling, PC5-S, discovery signaling, MAC CE, or L1 signaling (e.g., PSSCH, PSCCH, or PSFCH).

FIG. 19 is a flowchart illustrating a method 1900 according to an embodiment of the present disclosure. The method 1900 can be performed by a network node, e.g., a serving gNB of a first terminal device.

At block 1910, an indication is transmitted to the first terminal device, indicating a transmission format or 3GPP release and/or one or more sidelink features for use by the first terminal device to transmit a message for establishing a sidelink connection.

In an example, the transmission format or 3GPP release and/or the one or more sidelink features may be determined and/or updated based on one or more of: a presence of the first terminal device in a coverage of the network node, a service or traffic to be transmitted by the first terminal device over the sidelink connection, a Quality of Service (QoS) associated with the service or traffic, or a transmission format or 3GPP release and/or one or more sidelink features supported by the network node.

In an example, the communication (including e.g., the indication) between the first terminal device and the network node may be performed via dedicated RRC signaling, system information, MAC CE, control PDU of a protocol layer (e.g., SDAP, PDCP, or RLC), paging signaling, or L1 signaling (e.g., PDCCH).

FIG. 20 is a flowchart illustrating a method 2000 according to an embodiment of the present disclosure. The method 2000 can be performed by a network node, e.g., a serving gNB of a second terminal device.

At block 2010, an indication is transmitted to the second terminal device, indicating a transmission format or 3GPP release and/or one or more sidelink features for use by the second terminal device to respond to a message for establishing a sidelink connection.

In an example, the transmission format or 3GPP release and/or the one or more sidelink features may be determined and/or updated based on one or more of: a presence of the second terminal device in a coverage of the network node, a service or traffic to be received by the second terminal device over the sidelink connection, a Quality of Service (QoS) associated with the service or traffic, or a transmission format or 3GPP release and/or one or more sidelink features supported by the network node.

In an example, the communication (including e.g., the indication) between the second terminal device and the network node may be performed via dedicated RRC signaling, system information, MAC CE, control PDU of a protocol layer (e.g., SDAP, PDCP, or RLC), paging signaling, or L1 signaling (e.g., PDCCH).

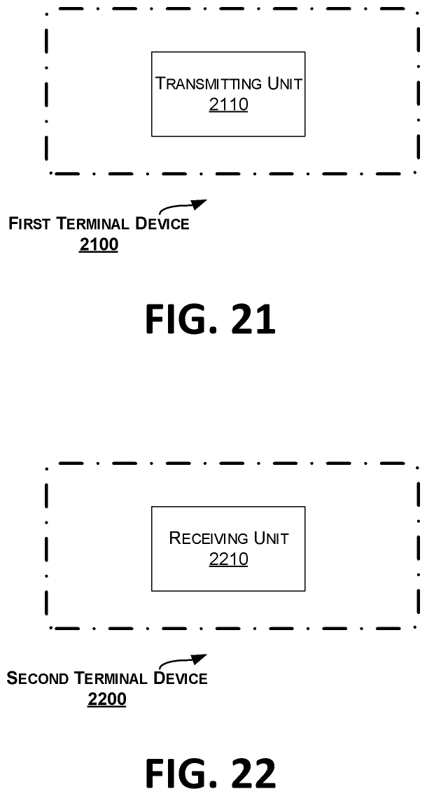

Correspondingly to the method 1200 as described above, a first terminal device is provided. FIG. 21 is a block diagram of a first terminal device 2100 according to an embodiment of the present disclosure.

The first terminal device 2100 is operative to perform the method 1200 as described above in connection with FIG. 12. The first terminal device 2100 includes a transmitting unit 2110 configured to transmit, to a second terminal device, a first message for establishing a sidelink connection with the second terminal device. The first message contains first information indicating a capability of the first terminal device for sidelink communication.

In an embodiment, the first information may indicate one or more of: a transmission format or 3GPP release the first terminal device supports, a list of sidelink features the first terminal device supports, a list of sidelink features the first terminal device wishes to use, or a list of sidelink features the first terminal device is currently using.

In an embodiment, the first terminal device 2100 may further include a receiving unit configured to receive, from the second terminal device, a second message as a response to the first message. The second message may contain second information indicating a capability of the second terminal device for sidelink communication.

In an embodiment, the second information may indicate one or more of: a transmission format or 3GPP release the second terminal device supports, a list of sidelink features the second terminal device supports, a list of sidelink features the second terminal device wishes to use, a list of sidelink features the second terminal device is currently using, or a list of sidelink features the first terminal device and the second terminal device both support, wish to use, and/or are currently using.

In an embodiment, the first terminal device 2100 may further include a determining unit configured to determine a sidelink configuration based on the capability of the first terminal device for sidelink communication and the capability of the second terminal device for sidelink communication. The transmitting unit 2110 may be further configured to transmit the sidelink configuration to the second terminal device.

In an embodiment, the transmitting unit 2110 may be further configured to transmit a request for a sidelink configuration to a network node. The request may contain the first information and the second information. The receiving unit may be further configured to receive the sidelink configuration from the network node, and the transmitting unit 2110 may be further configured to transmit the sidelink configuration to the second terminal device.

In an embodiment, the request may be transmitted, and/or the sidelink configuration may be received, via: RRC signaling, MAC CE, or L1 signaling.

In an embodiment, the first terminal device 2100 may further include a receiving unit configured to receive a sidelink configuration from the second terminal device.

In an embodiment, the sidelink features may include sidelink DRX.

In an embodiment, the first terminal device 2100 may further include a receiving unit configured to receive, from a network node, an instruction to include the first information in the first message.

In an embodiment, the first message may be transmitted to the second terminal device via: PC5-RRC signaling, PC5-S, discovery signaling, MAC CE, or L1 signaling.

The unit 2110 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 12.

Correspondingly to the method 1300 as described above, a first terminal device is provided. FIG. 22 is a block diagram of a second terminal device 2200 according to an embodiment of the present disclosure.

The second terminal device 2200 is operative to perform the method 1300 as described above in connection with FIG. 13. The second terminal device 2200 includes a receiving unit 2210 configured to receive, from a first terminal device, a first message for establishing a sidelink connection with the second terminal device. The first message contains first information indicating a capability of the first terminal device for sidelink communication.

In an embodiment, the first information may indicate one or more of: a transmission format or 3GPP release the first terminal device supports, a list of sidelink features the first terminal device supports, a list of sidelink features the first terminal device wishes to use, or a list of sidelink features the first terminal device is currently using.

In an embodiment, the second terminal device 2200 may further include a transmitting unit configured to transmit, to the first terminal device, a second message in response to the first message. The second message contains second information indicating a capability of the second terminal device for sidelink communication.

In an embodiment, the second information may indicate one or more of: a transmission format or 3GPP release the second terminal device supports, a list of sidelink features the second terminal device supports, a list of sidelink features the second terminal device wishes to use, a list of sidelink features the second terminal device is currently using, or a list of sidelink features the first terminal device and the second terminal device both support, wish to use, and/or are currently using.

In an embodiment, the second terminal device 2200 may further a discarding unit configured to discard the first message when the second terminal device does not support the transmission format or 3GPP release the first terminal device supports, or when there is no sidelink capability or feature the first terminal device and the second terminal device both support, wish to use, and/or are currently using.

In an embodiment, the second terminal device 2200 may further include a determining unit configured to determine a sidelink configuration based on the capability of the first terminal device for sidelink communication and the capability of the second terminal device for sidelink communication. The second terminal device 2200 may further include a transmitting unit configured to transmit the sidelink configuration to the first terminal device.

In an embodiment, the second terminal device 2200 may further include a transmitting unit configured to transmit a request for a sidelink configuration to a network node. The request may contain the first information and the second information. The receiving unit 2210 may be further configured to receive the sidelink configuration from the network node. The transmitting unit may be further configured to transmit the sidelink configuration to the first terminal device.

In an embodiment, the request may be transmitted, and/or the sidelink configuration may be received, via: RRC signaling, MAC CE, or L1 signaling.

In an embodiment, the receiving unit 2210 may be further configured to receive a sidelink configuration from the first terminal device.

In an embodiment, the receiving unit 2210 may be further configured to receive, from a network node, an instruction to include the second information in the second message.

In an embodiment, the second terminal device 2200 may further include an identifying unit configured to identify the capability of the first terminal device for sidelink communication by using an Abstract Syntax Notation One (ASN.1) decoder to decode all information on 3GPP releases and/or sidelink features supported by the first terminal device in the first message.

In an embodiment, the sidelink features may include sidelink DRX.

In an embodiment, the first message may be received from the first terminal device via: PC5-RRC signaling, PC5-S, discovery signaling, MAC CE, or L1 signaling.

The unit 2210 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 13.

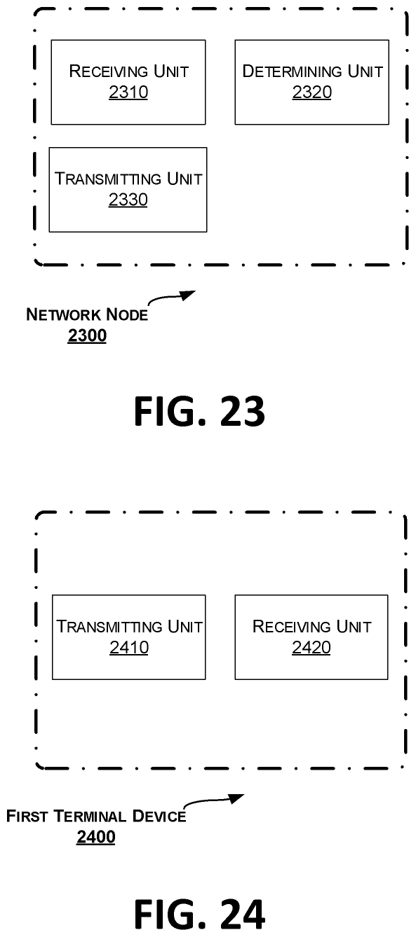

Correspondingly to the method 1400 as described above, a network node is provided. FIG. 23 is a block diagram of a network node 2300 according to an embodiment of the present disclosure.

The network node 2300 is operative to perform the method 1400 as described above in connection with FIG. 14. The network node 2300 includes a receiving unit 2310 configured to receive, from a first terminal device or a second terminal device, a request for a sidelink configuration. The request contains first information indicating a capability of the first terminal device for sidelink communication and second information indicating a capability of the second terminal device for sidelink communication. The network node 2300 further includes a determining unit 2320 configured to determine the sidelink configuration based on the capability of the first terminal device for sidelink communication and the capability of the second terminal device for sidelink communication. The network node 2300 further includes a transmitting unit 2330 configured to transmit the sidelink configuration to the first terminal device or the second terminal device.

In an embodiment, the first information may indicate one or more of: a transmission format or 3GPP release the first terminal device supports, a list of sidelink features the first terminal device supports, a list of sidelink features the first terminal device wishes to use, or a list of sidelink features the first terminal device is currently using. The second information may indicate one or more of: a transmission format or 3GPP release the second terminal device supports, a list of sidelink features the second terminal device supports, a list of sidelink features the second terminal device wishes to use, or a list of sidelink features the second terminal device is currently using.

In an embodiment, the sidelink features may include sidelink DRX.

In an embodiment, the request may be received, and/or the sidelink configuration may be transmitted, via: RRC signaling, MAC CE, or L1 signaling.

The units 2310-2330 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 14.

Correspondingly to the method 1500 as described above, a first terminal device is provided. FIG. 24 is a block diagram of a first terminal device 2400 according to an embodiment of the present disclosure.

The first terminal device 2400 is operative to perform the method 1500 as described above in connection with FIG. 15. The first terminal device 2400 includes a transmitting unit 2410 configured to transmit, to a network node, a request for a sidelink configuration. The first terminal device 2400 further includes a receiving unit 2420 configured to receive, from the network node, the sidelink configuration based on a capability of the first terminal device for sidelink communication.

In an embodiment, the capability of the first terminal device for sidelink communication may include one or more of: a transmission format or 3GPP release the first terminal device supports, a list of sidelink features the first terminal device supports, a list of sidelink features the first terminal device wishes to use, or a list of sidelink features the first terminal device is currently using.

In an embodiment, the sidelink configuration may configure only the sidelink features the first terminal device supports, wishes to use, and/or is currently using.

In an embodiment, the sidelink configuration may configure a resource pool used by one or more second terminal devices supporting the same transmission format or 3GPP release as the first terminal device and/or supporting, wishing to use, and/or being currently using the same sidelink features as the first terminal device.

In an embodiment, the sidelink configuration may configure the first terminal device to perform sidelink communication with only one or more second terminal devices in a proximity of the first terminal device that support the same transmission format or 3GPP release as the first terminal device and/or support, wish to use, and/or are currently using the same sidelink features as the first terminal device.

In an embodiment, the receiving unit 2420 may be further configured to receive, from the network node, an indication of a transmission format or 3GPP release or one or more features for use by the first terminal device to establish a sidelink connection with one or more second terminal devices.

In an embodiment, the request may be transmitted, and/or the sidelink configuration may be received, via: RRC signaling, MAC CE, or L1 signaling.

The units 2410-2420 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 15.

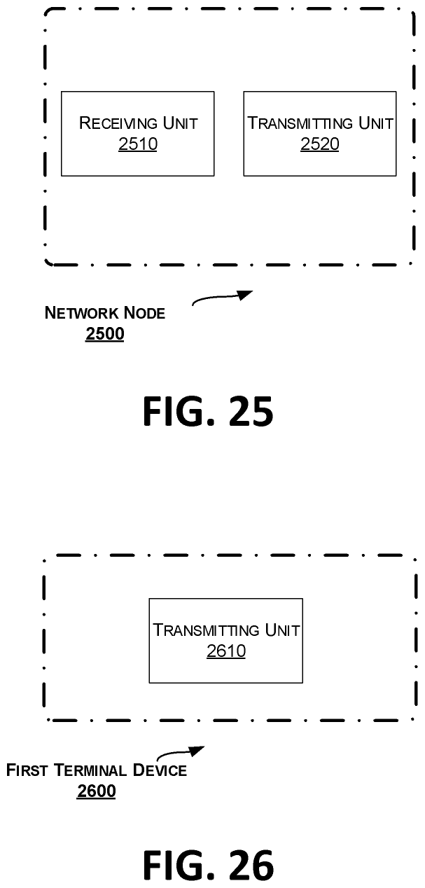

Correspondingly to the method 1600 as described above, a network node is provided. FIG. 25 is a block diagram of a network node 2500 according to an embodiment of the present disclosure.

The network node 2500 is operative to perform the method 1600 as described above in connection with FIG. 16. The network node 2500 includes a receiving unit 2510 configured to receive, from a first terminal device, a request for a sidelink configuration. The network node 2500 further includes a transmitting unit 2520 configured to transmit, to the first terminal device, the sidelink configuration based on a capability of the first terminal device for sidelink communication.

In an embodiment, the capability of the first terminal device for sidelink communication may include one or more of: a transmission format or 3GPP release the first terminal device supports, a list of sidelink features the first terminal device supports, a list of sidelink features the first terminal device wishes to use, or a list of sidelink features the first terminal device is currently using.

In an embodiment, the sidelink configuration may configure only the sidelink features the first terminal device supports, wishes to use, and/or is currently using.

In an embodiment, the sidelink configuration may configure a resource pool used by one or more second terminal devices supporting the same transmission format or 3GPP release as the first terminal device and/or supporting, wishing to use, and/or being currently using the same sidelink features as the first terminal device.

In an embodiment, the sidelink configuration may configure the first terminal device to perform sidelink communication with only one or more second terminal devices in a proximity of the first terminal device that support the same transmission format or 3GPP release as the first terminal device and/or support, wish to use, and/or are currently using the same sidelink features as the first terminal device.

In an embodiment, the transmitting unit 2520 may be further configured to transmit, to the first terminal device, an indication of a transmission format or 3GPP release or one or more features for use by the first terminal device to establish a sidelink connection with one or more second terminal devices.

In an embodiment, the request may be received, and/or the sidelink configuration may be transmitted, via: RRC signaling, MAC CE, or L1 signaling.

The units 2510-2520 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 16.

Correspondingly to the method 1700 as described above, a first terminal device is provided. FIG. 26 is a block diagram of a first terminal device 2600 according to an embodiment of the present disclosure.

The first terminal device 2600 is operative to perform the method 1700 as described above in connection with FIG. 17. The first terminal device 2600 includes a transmitting unit 2610 configured to transmit, to a second terminal device, a first message for establishing a sidelink connection with the second terminal device, using a transmission format or 3GPP release and/or one or more sidelink features.

In an embodiment, the first terminal device 2600 may further include a receiving unit configured to receive, from a network node, an indication of the transmission format or 3GPP release and/or the one or more sidelink features for use by the first terminal device to transmit the first message.

In an embodiment, the indication may be received via: dedicated RRC signaling, system information, MAC CE, control PDU of a protocol layer, paging signaling, or L1 signaling.

In an embodiment, the transmission format or 3GPP release may be a preconfigured default transmission format or 3GPP release, and/or the one or more sidelink features may be one or more preconfigured default sidelink features.

In an embodiment, the first message may be transmitted to the second terminal device via: PC5-RRC signaling, PC5-S, discovery signaling, MAC CE, or L1 signaling.

The unit 2610 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 17.

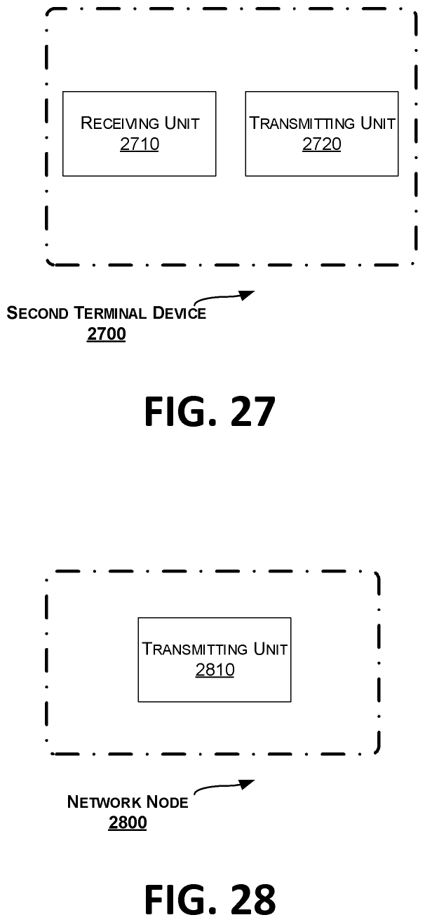

Correspondingly to the method 1800 as described above, a second terminal device is provided. FIG. 27 is a block diagram of a second terminal device 2700 according to an embodiment of the present disclosure.

The second terminal device 2700 is operative to perform the method 1800 as described above in connection with FIG. 18. The second terminal device 2700 includes a receiving unit 2710 configured to receive, from a first terminal device, a first message for establishing a sidelink connection with the second terminal device. The second terminal device 2700 further includes a transmitting unit 2720 configured to transmit, to the first terminal device, a second message in response to the first message, using a transmission format or 3GPP release and/or one or more sidelink features.

In an embodiment, the receiving unit 2710 may be further configured to receive, from a network node, an indication of the transmission format or 3GPP release and/or the one or more sidelink features for use by the second terminal device to transmit the second message.

In an embodiment, the indication may be received via: dedicated RRC signaling, system information, MAC CE, control PDU of a protocol layer, paging signaling, or L1 signaling.

In an embodiment, the transmission format or 3GPP release may be a preconfigured default transmission format or 3GPP release, and/or the one or more sidelink features may be one or more preconfigured default sidelink features.

In an embodiment, the first message may be received from the first terminal device, and/or the second message may be transmitted to first terminal device, via: PC5-RRC signaling, PC5-S, discovery signaling, MAC CE, or L1 signaling.

The units 2710-2720 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 18.

Correspondingly to the method 1900 as described above, a network node is provided. FIG. 28 is a block diagram of a network node 2800 according to an embodiment of the present disclosure.

The network node 2800 is operative to perform the method 1900 as described above in connection with FIG. 19. The network node 2800 includes a transmitting unit 2810 configured to transmit, to a first terminal device, an indication of a transmission format or 3GPP release and/or one or more sidelink features for use by the first terminal device to transmit a message for establishing a sidelink connection.

In an embodiment, the transmission format or 3GPP release and/or the one or more sidelink features may be determined and/or updated based on one or more of: a presence of the first terminal device in a coverage of the network node, a service or traffic to be transmitted by the first terminal device over the sidelink connection, a Quality of Service (QoS) associated with the service or traffic, or a transmission format or 3GPP release and/or one or more sidelink features supported by the network node.

In an embodiment, the indication may be transmitted via: dedicated RRC signaling, system information, MAC CE, control PDU of a protocol layer, paging signaling, or L1 signaling.

The unit 2810 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 19.

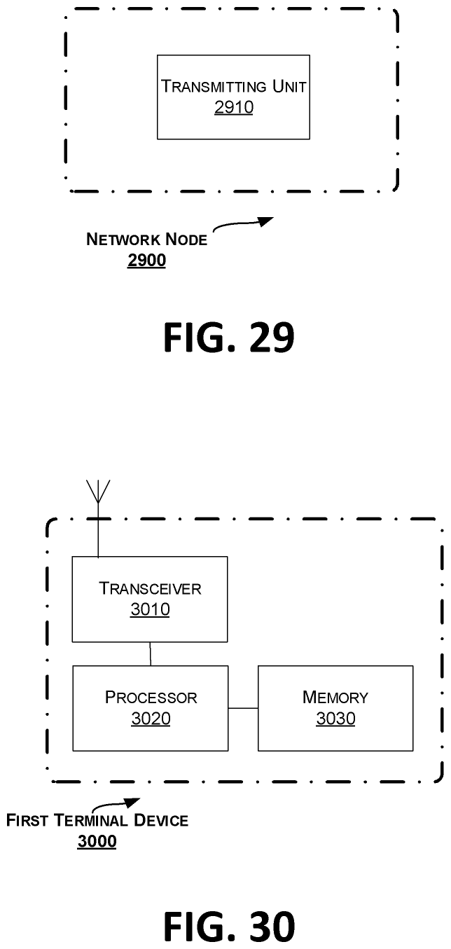

Correspondingly to the method 2000 as described above, a network node is provided. FIG. 29 is a block diagram of a network node 2900 according to an embodiment of the present disclosure.

The network node 2900 is operative to perform the method 2000 as described above in connection with FIG. 20. The network node 2900 includes a transmitting unit 2910 configured to transmit to a second terminal device, an indication of a transmission format or 3GPP release and/or one or more sidelink features for use by the second terminal device to respond to a message for establishing a sidelink connection.

In an embodiment, the transmission format or 3GPP release and/or the one or more sidelink features may be determined and/or updated based on one or more of: a presence of the second terminal device in a coverage of the network node, a service or traffic to be received by the second terminal device over the sidelink connection, a QoS associated with the service or traffic, or a transmission format or 3GPP release and/or one or more sidelink features supported by the network node.

In an embodiment, the indication may be transmitted via: dedicated RRC signaling, system information, MAC CE, control PDU of a protocol layer, paging signaling, or L1 signaling.

The unit 2910 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 20.

FIG. 30 is a block diagram of a first terminal device 3000 according to another embodiment of the present disclosure.

The first terminal device 3000 includes a transceiver 3010, a processor 3020 and a memory 3030. The memory 3030 may contain instructions executable by the processor 3020 whereby the first terminal device 3000 is operative to perform the actions, e.g., of the procedure described earlier in conjunction with FIG. 12. Particularly, the memory 3030 may contain instructions executable by the processor 3020 whereby the first terminal device 3000 is operative to: transmit, to a second terminal device, a first message for establishing a sidelink connection with the second terminal device. The first message contains first information indicating a capability of the first terminal device for sidelink communication.

In an embodiment, the first information may indicate one or more of: a transmission format or 3GPP release the first terminal device supports, a list of sidelink features the first terminal device supports, a list of sidelink features the first terminal device wishes to use, or a list of sidelink features the first terminal device is currently using.

In an embodiment, the memory 3030 may further contain instructions executable by the processor 3020 whereby the first terminal device 3000 is operative to: receive, from the second terminal device, a second message as a response to the first message. The second message may contain second information indicating a capability of the second terminal device for sidelink communication.

In an embodiment, the second information may indicate one or more of: a transmission format or 3GPP release the second terminal device supports, a list of sidelink features the second terminal device supports, a list of sidelink features the second terminal device wishes to use, a list of sidelink features the second terminal device is currently using, or a list of sidelink features the first terminal device and the second terminal device both support, wish to use, and/or are currently using.

In an embodiment, the memory 3030 may further contain instructions executable by the processor 3020 whereby the first terminal device 3000 is operative to: determine a sidelink configuration based on the capability of the first terminal device for sidelink communication and the capability of the second terminal device for sidelink communication; and transmit the sidelink configuration to the second terminal device.

In an embodiment, the memory 3030 may further contain instructions executable by the processor 3020 whereby the first terminal device 3000 is operative to: transmit a request for a sidelink configuration to a network node, the request containing the first information and the second information; receive the sidelink configuration from the network node; and transmit the sidelink configuration to the second terminal device.

In an embodiment, the request may be transmitted, and/or the sidelink configuration may be received, via: RRC signaling, MAC CE, or L1 signaling.

In an embodiment, the memory 3030 may further contain instructions executable by the processor 3020 whereby the first terminal device 3000 is operative to: receive a sidelink configuration from the second terminal device.

In an embodiment, the sidelink features may include sidelink DRX.

In an embodiment, the memory 3030 may further contain instructions executable by the processor 3020 whereby the first terminal device 3000 is operative to: receive, from a network node, an instruction to include the first information in the first message.

In an embodiment, the first message may be transmitted to the second terminal device via: PC5-RRC signaling, PC5-S, discovery signaling, MAC CE, or L1 signaling.

Alternatively, the memory 3030 may contain instructions executable by the processor 3020 whereby the first terminal device 3000 is operative to perform the actions, e.g., of the procedure described earlier in conjunction with FIG. 15. Particularly, the memory 3030 may contain instructions executable by the processor 3020 whereby the first terminal device 3000 is operative to: transmit, to a network node, a request for a sidelink configuration; and receive, from the network node, the sidelink configuration based on a capability of the first terminal device for sidelink communication.

In an embodiment, the capability of the first terminal device for sidelink communication may include one or more of: a transmission format or 3GPP release the first terminal device supports, a list of sidelink features the first terminal device supports, a list of sidelink features the first terminal device wishes to use, or a list of sidelink features the first terminal device is currently using.

In an embodiment, the sidelink configuration may configure only the sidelink features the first terminal device supports, wishes to use, and/or is currently using.

In an embodiment, the sidelink configuration may configure a resource pool used by one or more second terminal devices supporting the same transmission format or 3GPP release as the first terminal device and/or supporting, wishing to use, and/or being currently using the same sidelink features as the first terminal device.

In an embodiment, the sidelink configuration may configure the first terminal device to perform sidelink communication with only one or more second terminal devices in a proximity of the first terminal device that support the same transmission format or 3GPP release as the first terminal device and/or support, wish to use, and/or are currently using the same sidelink features as the first terminal device.

In an embodiment, the memory 3030 may further contain instructions executable by the processor 3020 whereby the first terminal device 3000 is operative to: receive, from the network node, an indication of a transmission format or 3GPP release or one or more features for use by the first terminal device to establish a sidelink connection with one or more second terminal devices.

In an embodiment, the request may be transmitted, and/or the sidelink configuration may be received, via: RRC signaling, MAC CE, or L1 signaling.

Alternatively, the memory 3030 may contain instructions executable by the processor 3020 whereby the first terminal device 3000 is operative to perform the actions, e.g., of the procedure described earlier in conjunction with FIG. 17. Particularly, the memory 3030 may contain instructions executable by the processor 3020 whereby the first terminal device 3000 is operative to: transmit, to a second terminal device, a first message for establishing a sidelink connection with the second terminal device, using a transmission format or 3GPP release and/or one or more sidelink features.

In an embodiment, the memory 3030 may further contain instructions executable by the processor 3020 whereby the first terminal device 3000 is operative to: receive, from a network node, an indication of the transmission format or 3GPP release and/or the one or more sidelink features for use by the first terminal device to transmit the first message.

In an embodiment, the indication may be received via: dedicated RRC signaling, system information, MAC CE, control Protocol Data Unit (PDU) of a protocol layer, paging signaling, or L1 signaling.

In an embodiment, the transmission format or 3GPP release may be a preconfigured default transmission format or 3GPP release, and/or the one or more sidelink features may be one or more preconfigured default sidelink features.

In an embodiment, the first message may be transmitted to the second terminal device via: PC5-RRC signaling, PC5-S, discovery signaling, MAC CE, or L1 signaling.

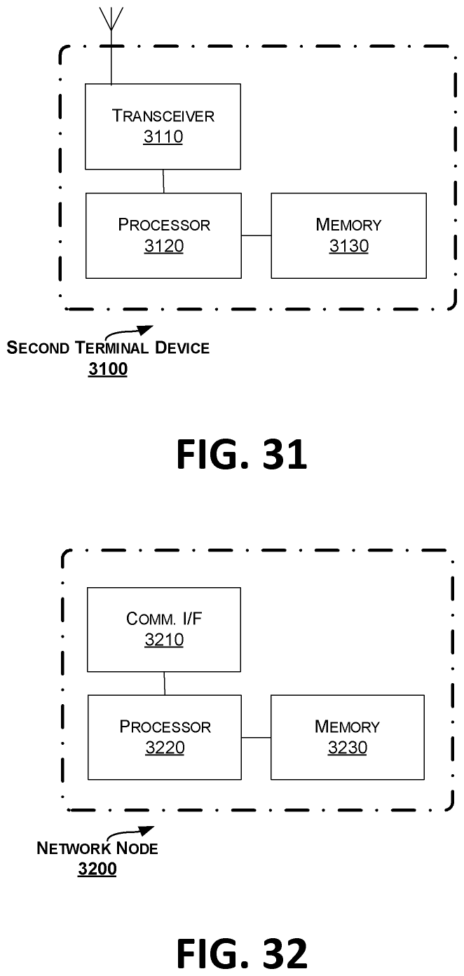

FIG. 31 is a block diagram of a second terminal device 3100 according to another embodiment of the present disclosure.

The second terminal device 3100 includes a transceiver 3110, a processor 3120 and a memory 3130. The memory 3130 may contain instructions executable by the processor 3120 whereby the second terminal device 3100 is operative to perform the actions, e.g., of the procedure described earlier in conjunction with FIG. 13. Particularly, the memory 3130 may contain instructions executable by the processor 3120 whereby the second terminal device 3100 is operative to: receive, from a first terminal device, a first message for establishing a sidelink connection with the second terminal device. The first message contains first information indicating a capability of the first terminal device for sidelink communication.

In an embodiment, the first information may indicate one or more of: a transmission format or 3GPP release the first terminal device supports, a list of sidelink features the first terminal device supports, a list of sidelink features the first terminal device wishes to use, or a list of sidelink features the first terminal device is currently using.

In an embodiment, the memory 3130 may further contain instructions executable by the processor 3120 whereby the second terminal device 3100 is operative to: transmit, to the first terminal device, a second message in response to the first message. The second message contains second information indicating a capability of the second terminal device for sidelink communication.

In an embodiment, the second information may indicate one or more of: a transmission format or 3GPP release the second terminal device supports, a list of sidelink features the second terminal device supports, a list of sidelink features the second terminal device wishes to use, a list of sidelink features the second terminal device is currently using, or a list of sidelink features the first terminal device and the second terminal device both support, wish to use, and/or are currently using.

In an embodiment, the memory 3130 may further contain instructions executable by the processor 3120 whereby the second terminal device 3100 is operative to: discard the first message when the second terminal device does not support the transmission format or 3GPP release the first terminal device supports, or when there is no sidelink capability or feature the first terminal device and the second terminal device both support, wish to use, and/or are currently using.

In an embodiment, the memory 3130 may further contain instructions executable by the processor 3120 whereby the second terminal device 3100 is operative to: determine a sidelink configuration based on the capability of the first terminal device for sidelink communication and the capability of the second terminal device for sidelink communication; and transmit the sidelink configuration to the first terminal device.

In an embodiment, the memory 3130 may further contain instructions executable by the processor 3120 whereby the second terminal device 3100 is operative to: transmit a request for a sidelink configuration to a network node, the request containing the first information and the second information; receive the sidelink configuration from the network node; and transmit the sidelink configuration to the first terminal device.

In an embodiment, the request may be transmitted, and/or the sidelink configuration may be received, via: RRC signaling, MAC CE, or L1 signaling.

In an embodiment, the memory 3130 may further contain instructions executable by the processor 3120 whereby the second terminal device 3100 is operative to: receive a sidelink configuration from the first terminal device.

In an embodiment, the memory 3130 may further contain instructions executable by the processor 3120 whereby the second terminal device 3100 is operative to: receive, from a network node, an instruction to include the second information in the second message.

In an embodiment, the memory 3130 may further contain instructions executable by the processor 3120 whereby the second terminal device 3100 is operative to: identify the capability of the first terminal device for sidelink communication by using an Abstract Syntax Notation One (ASN.1) decoder to decode all information on 3GPP releases and/or sidelink features supported by the first terminal device in the first message.

In an embodiment, the sidelink features may include sidelink DRX.

In an embodiment, the first message may be received from the first terminal device via PC5-RRC signaling, PC5-S, discovery signaling, MAC CE, or L1 signaling.

Alternatively, the memory 3130 may contain instructions executable by the processor 3120 whereby the second terminal device 3100 is operative to perform the actions, e.g., of the procedure described earlier in conjunction with FIG. 18. Particularly, the memory 3130 may contain instructions executable by the processor 3120 whereby the second terminal device 3100 is operative to: receive, from a first terminal device, a first message for establishing a sidelink connection with the second terminal device; and transmit, to the first terminal device, a second message in response to the first message, using a transmission format or 3GPP release and/or one or more sidelink features.

In an embodiment, the memory 3130 may further contain instructions executable by the processor 3120 whereby the second terminal device 3100 is operative to: receive, from a network node, an indication of the transmission format or 3GPP release and/or the one or more sidelink features for use by the second terminal device to transmit the second message.

In an embodiment, the indication may be received via: dedicated RRC signaling, system information, MAC CE, control PDU of a protocol layer, paging signaling, or L1 signaling.

In an embodiment, the transmission format or 3GPP release may be a preconfigured default transmission format or 3GPP release, and/or the one or more sidelink features may be one or more preconfigured default sidelink features.

In an embodiment, the first message may be received from the first terminal device, and/or the second message may be transmitted to first terminal device, via: PC5-RRC signaling, PC5-S, discovery signaling, MAC CE, or L1 signaling.

FIG. 32 is a block diagram of a network node 3200 according to another embodiment of the present disclosure.

The network node 3200 includes a communication interface 3210, a processor 3220 and a memory 3230. The memory 3230 may contain instructions executable by the processor 3220 whereby the network node 3200 is operative to perform the actions, e.g., of the process described earlier in conjunction with FIG. 14. Particularly, the memory 3230 may contain instructions executable by the processor 3220 whereby the network node 3200 is operative to: receive, from a first terminal device or a second terminal device, a request for a sidelink configuration, the request containing first information indicating a capability of the first terminal device for sidelink communication and second information indicating a capability of the second terminal device for sidelink communication; determine the sidelink configuration based on the capability of the first terminal device for sidelink communication and the capability of the second terminal device for sidelink communication; and transmit the sidelink configuration to the first terminal device or the second terminal device.

In an embodiment, the first information may indicate one or more of: a transmission format or 3GPP release the first terminal device supports, a list of sidelink features the first terminal device supports, a list of sidelink features the first terminal device wishes to use, or a list of sidelink features the first terminal device is currently using. The second information may indicate one or more of: a transmission format or 3GPP release the second terminal device supports, a list of sidelink features the second terminal device supports, a list of sidelink features the second terminal device wishes to use, or a list of sidelink features the second terminal device is currently using.

In an embodiment, the sidelink features may include sidelink DRX.

In an embodiment, the request may be received, and/or the sidelink configuration may be transmitted, via: RRC signaling, MAC CE, or L1 signaling.

Alternatively, the memory 3230 may contain instructions executable by the processor 3220 whereby the network node 3200 is operative to perform the actions, e.g., of the process described earlier in conjunction with FIG. 16. Particularly, the memory 3230 may contain instructions executable by the processor 3220 whereby the network node 3200 is operative to: receive, from a first terminal device, a request for a sidelink configuration; and transmit, to the first terminal device, the sidelink configuration based on a capability of the first terminal device for sidelink communication.

In an embodiment, the capability of the first terminal device for sidelink communication may include one or more of: a transmission format or 3GPP release the first terminal device supports, a list of sidelink features the first terminal device supports, a list of sidelink features the first terminal device wishes to use, or a list of sidelink features the first terminal device is currently using.

In an embodiment, the sidelink configuration may configure only the sidelink features the first terminal device supports, wishes to use, and/or is currently using.

In an embodiment, the sidelink configuration may configure a resource pool used by one or more second terminal devices supporting the same transmission format or 3GPP release as the first terminal device and/or supporting, wishing to use, and/or being currently using the same sidelink features as the first terminal device.

In an embodiment, the sidelink configuration may configure the first terminal device to perform sidelink communication with only one or more second terminal devices in a proximity of the first terminal device that support the same transmission format or 3GPP release as the first terminal device and/or support, wish to use, and/or are currently using the same sidelink features as the first terminal device.

In an embodiment, the memory 3230 may further contain instructions executable by the processor 3220 whereby the network node 3200 is operative to: transmit, to the first terminal device, an indication of a transmission format or 3GPP release or one or more features for use by the first terminal device to establish a sidelink connection with one or more second terminal devices.

In an embodiment, the request may be received, and/or the sidelink configuration may be transmitted, via: RRC signaling, MAC CE, or L1 signaling.

Alternatively, the memory 3230 may contain instructions executable by the processor 3220 whereby the network node 3200 is operative to perform the actions, e.g., of the process described earlier in conjunction with FIG. 19. Particularly, the memory 3230 may contain instructions executable by the processor 3220 whereby the network node 3200 is operative to: transmit, to a first terminal device, an indication of a transmission format or 3GPP release and/or one or more sidelink features for use by the first terminal device to transmit a message for establishing a sidelink connection.

In an embodiment, the transmission format or 3GPP release and/or the one or more sidelink features may be determined and/or updated based on one or more of: a presence of the first terminal device in a coverage of the network node, a service or traffic to be transmitted by the first terminal device over the sidelink connection, a Quality of Service (QoS) associated with the service or traffic, or a transmission format or 3GPP release and/or one or more sidelink features supported by the network node.

In an embodiment, the indication may be transmitted via: dedicated RRC signaling, system information, MAC CE, control PDU of a protocol layer, paging signaling, or L1 signaling.

Alternatively, the memory 3230 may contain instructions executable by the processor 3220 whereby the network node 3200 is operative to perform the actions, e.g., of the process described earlier in conjunction with FIG. 20. Particularly, the memory 3230 may contain instructions executable by the processor 3220 whereby the network node 3200 is operative to: transmit to a second terminal device, an indication of a transmission format or 3GPP release and/or one or more sidelink features for use by the second terminal device to respond to a message for establishing a sidelink connection.

In an embodiment, the transmission format or 3GPP release and/or the one or more sidelink features may be determined and/or updated based on one or more of: a presence of the second terminal device in a coverage of the network node, a service or traffic to be received by the second terminal device over the sidelink connection, a QoS associated with the service or traffic, or a transmission format or 3GPP release and/or one or more sidelink features supported by the network node.

In an embodiment, the indication may be transmitted via: dedicated RRC signaling, system information, MAC CE, control PDU of a protocol layer, paging signaling, or L1 signaling.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 3020 causes the first terminal device 3000 to perform the actions, e.g., of the procedure described earlier in conjunction with FIGS. 12, 15, and 17; code/computer readable instructions, which when executed by the processor 3120 causes the second terminal device 3100 to perform the actions, e.g., of the procedure described earlier in conjunction with FIGS. 13 and 18; or code/computer readable instructions, which when executed by the processor 3220 causes the network node 3200 to perform the actions, e.g., of the procedure described earlier in conjunction with FIGS. 14, 16, 19, and 20.

The computer program product may be configured as a computer program code structured in computer program modules. The computer program modules could essentially perform the actions of the flow illustrated in FIG. 12, 13, 14, 15, 16, 17, 18, 19, or 20.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

The present disclosure further includes the following embodiments.

The methods and solutions disclosed in the following, are referring to the NR RAT but can be applied also to LTE RAT and any other RAT enabling the direct transmission between two (or more) nearby devices without any loss of meaning.

Further, all the embodiments can be applied without any loss of meaning to a communication that happens between a UE1 that implements 3GPP release “X” and UE2 that implements 3GPP release “Y”, or vice versa. Similarly, all the embodiments can also be applied without any loss of meaning to a communication that happens between a UE1 that implements a feature “A” and UE2 that implements feature “B”, or vice versa (i.e., regardless of the 3GPP release they are implementing).

In the following embodiments, we also use the term “TX UE” to identify the UE, in a sidelink communication, that sends a first message/signalling and the term “RX UE” to identity the UE, in a sidelink communication, that receive a first message/signaling.

The following embodiments are applicable to any cast type (i.e., unicast, groupcast and broadcast). For groupcast and broadcast, a TX UE may be required to exchange control signaling or message with other RX UEs.

In the first embodiment, when a sidelink capable UE has a certain traffic incoming (i.e., so it's a TX UE) and wish to establish a sidelink communication with other UEs in its proximity, in the first message that is sent to establish a sidelink connectivity the UE includes information about what the UE is able to support (from a release and/or capability point of view). When sending this first message, the TX UE may include at least one of the following information:
What release(s) the TX UE is implementing
A list of features that the TX UE is supporting
A list of features that the TX UE is supporting and wish to use (e.g., the TX UE would like to use SL DRX for power saving purposes)
A list of features that the TX UE has currently active and is using

When the RX UE receives that first message sent by the TX UE, the RX UE reads the information shared by the TX UE and may perform at least one of the following actions:
Decide to not reply to the first message sent by the TX UE since the RX UE does not support the 3GPP release of feature that the TX UE is supporting. Note that not supporting a 3GPP release means that the 3GPP release of the RX is older of that one of the TX UE (i.e., RX UE implements Rel-16 while TX UE implements Rel-17).
Send a response message to the first message sent by the TX UE where the RX UE share the information on what is able to support (from a release and/or capability point of view). In such a case, the RX UE may indicate to the TX UE at least one of the following information:
What release(s) the RX UE is implementing
A list of features that the RX UE is supporting
A list of features that the RX UE is supporting and wish to use (e.g., the RX UE would like to use SL DRX for power saving purposes)
A list of features that the RX UE has currently active and is using
A list of features that are overlapping with the one supported by the TX UE

Once that this information is shared between the TX UE and RX UE, a proper sidelink configuration is generated and the sidelink communication is established. About who generates the configuration, this can be done by the TX UE, the RX UE, or by the serving gNB of the TX UE or RX UE. Please note that if the configuration is generated by the serving gNB of the TX UE or RX UE, this means that the TX UE and RX UE needs to report to their serving gNB the information that they received by the RX UE and TX UE, respectively.

In the second embodiment, when a sidelink capable UE has a certain traffic incoming (i.e., so it's a TX UE) and wish to establish a sidelink communication with other UEs in its proximity, the TX UE sends a message to its own serving gNB in order to ask a configuration to establish a sidelink transmission. When receiving such a request from the TX UE, gNB generate a sidelink configuration that allow the coexistence of this TX UE with all the other UEs that are within the coverage of the gNB. In order to do so, the gNB may pursue at least one of the following options:
Option 1: The gNB checks the capabilities of all the UEs under its coverage and generates a configuration by configuring only features that are supported by the TX UE.
Option 2: The gNB sends a configuration to the TX UE in which the TX UE is configured with a transmission and reception resource pool that is used by UEs that implements the same 3GPP release and/or features of the TX UE.
Option 3: The gNB checks which UEs are in proximity with the TX UE (i.e., so called the potential RX UEs) and sends a configuration to the TX UE that allow sidelink transmission only with such UEs in its proximity.
Option 4: The gNB sends an indication to the TX UE by informing the TX UE about which 3GPP release and/or which features the TX UE should use for sending the first message to other UEs in its proximity for establishing a sidelink connectivity.

What is described in this second embodiment, can also be applied without any loss of meaning to the RX UE.

In a third embodiment, the gNB sends an indication to all their UEs under its coverage about which 3GPP release and/or which features should be used. This decision may be taken by looking at the capabilities of all the UEs under its coverage. The indication may be sent to all the UEs by using at least one of the following signaling:
Dedicated RRC signalling
System information
MAC CE
Control PDU of a protocol layer (e.g., SDAP, PDCP, RLC)
Paging
L1 signaling carried on channels (e.g., PDCCH)

In the fourth embodiment, a default set of capabilities and/or features that needs to be used when the TX UE sends the first message to other UEs in its proximity for establish a sidelink communication is used. At the same time, the same default set of capabilities and/or features is also used by the RX UE when it needs to reply to the first message sent by the TX UE. This default set of capabilities can be decided by the gNB or be pre-configured (hardcoded) in the specification. Further, this default set of capabilities may mean that the TX UE and RX UE needs to mandatory support such capabilities/features in order to establish a sidelink communication. Alternatively, if is the gNB who decide this default set of capabilities, this can be changed over time based on the UEs' presence under its coverage, the service/traffic that need to be transmitted, the QoS that needs to be guaranteed, or a certain 3GPP release and features that the gNB itself support.

In the fifth embodiment, a RX UE that receives a first message for establishing a sidelink communication may understand itself what release, capabilities, or features the TX UE supports by using the ASN.1 decoder. This basically means that the ASN.1 decoder of the RX UE will look for all the extensions marker in the ASN.1 code (e.g., the suffix “-rXX” where the XX is the 3GPP release—“r16”, or the suffix “-vXy) and try to identity which release the TX UE is implementing and which feature the TX UE is using. Once knowing this information, the RX UE may send a reply message to the first message sent by the TX UE according to the TX UE capabilities and/or features. What is described in this embodiment can also be applied by the TX UE to understand which 3GPP release and which features the RX UE implements.

In the sixth embodiment, the solution and method described in the previous embodiments the UE should use is decided by the gNB and communicated to the UE via dedicated RRC signaling of via system information. As another alternative, which option the UE should use is decided by TX/RX UE or is pre-configured (hard-coded in the spec).

In the seventh embodiment, for any of the above embodiments, the signaling alternatives described will include at least one of the below:

For signaling between UE and the gNB:
RRC signaling
MAC CE
L1 signaling on channels such as PRACH, PUCCH, PDCCH

For signaling between UEs:
RRC signaling (e.g., PC5-RRC)
PC5-S signaling
Discovery signaling
MAC CE
L1 signaling on channels such as PSSCH, PSCCH, or PSFCH.

This document discloses new methods and solutions in order to allow sidelink UEs implementing different releases or different feature to communicate between each other.

This can be basically done according to at least one of the following options:
1. Sidelink UE may exchange information beforehand of the setup of the sidelink communication.
2. Network configures sidelink UEs, implementing different releases or features, with a configuration that allow the sidelink communication/coexistence.
3. A default set of capabilities and/or configurations are used for initial sidelink operation. This will guarantee that when setting up a sidelink communication all the UE involved will use the same set of capabilities and configurations.

The proposed solution allows for sidelink UEs from different releases to coexist:
It ensures sidelink UE implementing different 3GPP releases or features are able to transmit each other.
It ensures that new features are only configured when they are compatible with the different services that the UE is participating in.

For the 5th Generation (5G) or New Radio (NR) communication systems, Discontinuous Reception (DRX) procedures are described in the 3rd Generation Partnership Project (3GPP) Technical Specification (TS) 38.321, V16.4.0, which is incorporated herein by reference in its entirety. For details of the DRX procedures, reference can be made to Section 5.7 of TS 38.321 (see Annex 1).

When configured, the DRX functionality controls expected User Equipment (UE) behaviors in terms of reception and processing of transmissions. Broadly speaking, the DRX functionality defines Active Time (also referred to as Active Time state or ACTIVE state), in which a UE is expected to receive and process incoming transmissions as appropriate. For example, the UE is expected to decode downlink (DL) control channels, and process grants, etc. The DRX state is not related to a Radio Resource Control (RRC) state of the UE. That is, even if the UE is in the DRX ACTIVE or INACTIVE state, its RRC state is not changed (i.e., the UE stays in its current RRC state−RRC_CONNECTED/IDLE/INACTIVE).

When a UE is not in the Active Time, the UE is not expected to receive and process transmissions. That is, a network node, e.g., a (next) generation Node B (gNB) does not assume that the UE will be listening to DL transmissions. The DRX configuration specified in TS 38.321 defines transitions between DRX states. Typically, a UE that is not in the Active Time turns off some of its components and enters a low power (i.e., sleeping) mode. To ensure that the UE switches regularly to the Active Time (i.e., wakes up), a DRX cycle is defined. This DRX cycle is controlled by two parameters:
a periodicity of the DRX cycle, which controls how frequently the UE switches to the Active Time; and
a duration of the Active Time, which controls for how long the UE stays in the ACTIVE state.

The 3GPP specified the Long Term Evolution (LTE) Device-to-Device (D2D) technology, also known as Sidelink (SL) or PC5 interface, as part of Release 12 (Rel-12). The target use case were Proximity Services (communication and discovery). Support for the LTE sidelink was enhanced during Release 13 (Rel-13). In Release 14 (Rel-14), the LTE sidelink was extensively redesigned to support vehicular communications (commonly referred to as Vehicle-to-Everything (V2X) or Vehicle-to-Vehicle V2V). Support for the LTE sidelink was again enhanced during Release 15 (Rel-15). From the point of view of the lowest radio layers, the LTE sidelink uses broadcast communication. That is, transmission from a UE targets any receiver that is in a certain range.

ProSe (Proximity Services) is specified in the Rel-12 and Rel-13 of LTE. Later in Rel-14 and Rel-15, LTE V2X related enhancements targeting specific characteristics of vehicular communications were specified. In LTE V2X, only broadcast is supported over sidelink.

In Rel-16, the 3GPP introduced the sidelink for the 5G NR. The driving use cases were vehicular communications with more stringent requirements than those typically served by the LTE sidelink. To meet these requirements, the NR sidelink is capable of broadcast, groupcast, and unicast communications. In groupcast communication, intended receivers of a message are typically a group of the vehicles near a transmitter, whereas in unicast communication there is a single intended receiver.

Both the LTE sidelink and the NR sidelink can operate with and without network coverage and with varying degrees of interactions between UEs and a network node, including support for standalone, network-less operation.

In addition to the DRX cycle, the DRX procedures also define other conditions that may allow a UE to switch between the Active Time and the Inactive Time. For example, if a UE is expecting a retransmission from a gNB, the UE may enter the Inactive Time (i.e., while the gNB prepares the retransmission) and then may enter the Active Time (i.e., during a window in which the gNB may send the transmission).

The Active Time based on the DRX cycle is determined by the DRX configuration. In other words, it is easy to predict when a UE will be in the Active Time based on the DRX cycle (unless the UE is explicitly instructed to leave the Active Time). In contrast, it is difficult to predict whether a UE is in the Active Time based on other conditions or timers depending on data traffic.

In the upcoming Release 17 (Rel-17), the 3GPP will work on enhancements for the NR sidelink. The ambition is not only to improve capabilities of the NR sidelink for V2X, but also to address use cases such as National Security and Public Safety (NSPS) as well as commercial use cases such as Network Controlled Interactive Services (NCIS). In the future, the NR sidelink may be enhanced further to address other use cases as well.

In the V2X, UEs are typically mounted in vehicles and have no stringent power restrictions. In contrast, the NSPS or NCIS mostly uses handheld UEs, for which energy efficiency is a critical issue. With this in mind, a Rel-17 Work Item on NR sidelink enhancements (RP-193231) includes the study and specification of sidelink DRX mechanism as one of its objectives. This includes defining sidelink DRX configurations and corresponding UE procedures, specifying mechanisms to align sidelink DRX configurations among the UEs communicating with each other, and specifying mechanisms to align sidelink DRX configurations with Uu DRX configurations for in-coverage UEs. In a recent RAN2 meeting, it has been agreed that a DRX configuration like the Uu DRX configuration is applied to sidelink for broadcast, groupcast, and unicast. More specifically, a drx-onDurationTimer will be introduced for sidelink broadcast, groupcast, and unicast, a drx-InactivityTimer will be introduced for sidelink unicast while it is still under discussion whether to introduce the same timer for sidelink groupcast.

In the Work Item Description (WID) RP-201516, WID revision: NR sidelink enhancement, it is explicitly required that “enhancements introduced in Rel-17 should be based on the functionalities specified in Rel-16, and Rel-17 sidelink should be able to coexist with Rel-16 sidelink in the same resource pool”. However, when introducing sidelink DRX in Rel-17, there may be a compatibility issue between a Rel-16 transmitting UE not supporting sidelink DRX and a Rel-17 receiving UE configured with sidelink DRX, in which case the Rel-17 receiving UE may miss some transmissions from the Rel-16 transmitting UE. This issue may also happen when a Rel-17 UE supporting sidelink DRX and another Rel-17 UE not support sidelink DRX communicate with each other. The problem is especially critical in sidelink broadcast/groupcast where there is no PC5-RRC signaling between the transmitting UE and the receiving UEs, and the receiving UEs do not know the feature(s)/configuration(s) supported and applied by the transmitting UE.

According to the 3GPP TS 23.287, V16.5.0, which is incorporated herein by reference in its entirety, the higher layer provisions a mapping between service types and transmit profiles to the UE. A concept of transmit profile, or referred to as communication profile, on top of the framework of LTE transmit profile has been proposed in the International Application No. PCT/CN2021/098609. The concept covers three solutions:
1. Transmit profiles used for determining not only transmission parameters and configurations but also reception parameters and configurations.
2. Rules for multiplexing packets with different transmit profiles (e.g., from different service types).
3. Configuration of transmit profiles and determination of Access Stratum (AS) layer feature(s) to use based on transmit profiles.

The above concept provides a cell or system level solution to allow coexistence of legacy UEs and UEs with latest releases.

It is desired to fully utilize each individual UE's capabilities to achieve better performance in sidelink communications. For example, it may not be optimal to always disable sidelink DRX when a Rel-17 UE performs a groupcast/broadcast transmission for a service when a transmit profile corresponding to a service type of the service indicates Rel-16 (note that in unicast case, sidelink DRX may be used even when the transmitted service is a Rel-16 service, e.g., by utilizing PC5-RRC signaling). This also applies to other sidelink features than sidelink DRX.

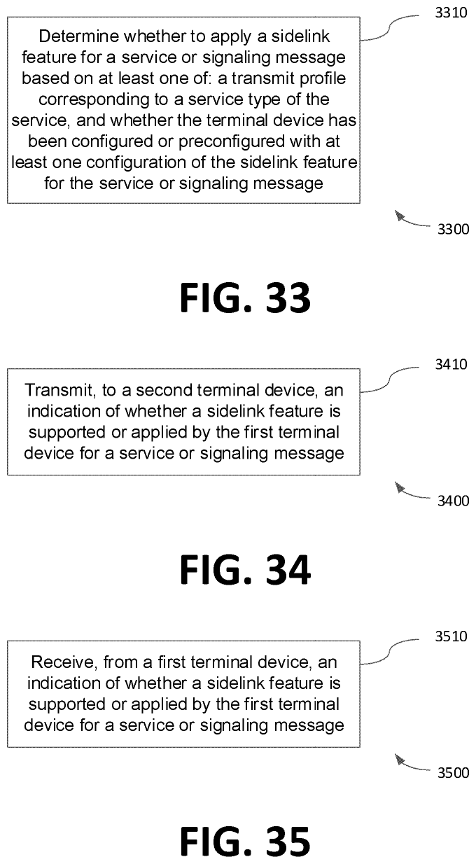

FIG. 33 is a flowchart illustrating a method 3300 according to an embodiment of the present disclosure. The method 3300 can be performed by a terminal device, e.g., a UE to transmit or receive a service or signaling message over sidelink.

At block 3310, the terminal device determines whether to apply a sidelink feature for a service or signaling message based on at least one of: a transmit profile corresponding to a service type of the service, and whether the terminal device has been configured or preconfigured with at least one configuration of the sidelink feature for the service or signaling message.

Here, the sidelink feature may include sidelink DRX. The at least one configuration of the sidelink feature may include at least one sidelink DRX configuration, which may include e.g., drx-onDurationTimer, drx-InactivityTimer, and other timers/parameters same as or similar to those specified in Section 5.7 of TS 38.321 (see Annex 1).

Here, the service may include a groupcast or broadcast service. It can be appreciated that the principle of the present disclosure is also applicable to unicast services. The signaling message may include a discovery message, a request for establishing a sidelink unicast connection (i.e., the first message in sidelink unicast connection establishment), or a response to the request (i.e., the second message in sidelink unicast connection establishment). The signaling message may be identified by an SLCH Identifier (ID) and/or a Layer 2 (L2) destination ID.

For the signaling message, the transmit profile may be configured or preconfigured based on the service type associated with the signaling message. That is, the transmit profile may indicate whether the sidelink feature is supported or applied for the signaling message based on the service type associated with the signaling message.

In an example, in the block 3310, it can be determined to apply the sidelink feature when the transmit profile indicates that the sidelink feature is to be applied to the service or signaling message, and the terminal device has been configured or preconfigured with the at least one configuration of the sidelink feature for the service or signaling message. On the other hand, in the block 3310, it can be determined not to apply the sidelink feature when the transmit profile indicates that the sidelink feature is not to be applied to the service or signaling message, and the terminal device has not been configured or preconfigured with the at least one configuration of the sidelink feature for the service or signaling message.

In another example, it can be determined to apply the sidelink feature when the terminal device has been configured or preconfigured with the at least one configuration of the sidelink feature for the service or signaling message, regardless of whether the transmit profile indicates that the sidelink feature is to be applied to the service or signaling message. That is, the terminal device may determine to apply the sidelink feature when the terminal device has been configured or preconfigured with the at least one configuration of the sidelink feature for the service or signaling message, even if the transmit profile indicates that the sidelink feature is not to be applied to the service or signaling message. The transmit profile is ignored or “overridden” in this sense.

For example, the terminal device's behavior of ignoring or overriding the transmit profile may be configured or preconfigured by a network node (e.g., a serving gNB of the terminal device), a core network node, or a controlling terminal device, or may be predefined (hard coded) in a specification or protocol. For example, the terminal device may receive, from a network node, an indication (e.g., referred to as overriding indication hereinafter) to apply the sidelink feature when the terminal device has been configured or preconfigured with the at least one configuration of the sidelink feature for the service or signaling message, regardless of whether the transmit profile indicates that the sidelink feature is to be applied to the service or signaling message.

In an example, the terminal device may have a plurality of services or signaling messages to transmit and/or receive, and may determine whether to apply the sidelink feature for each service or signaling message. When determining to apply the sidelink feature for a first service or signaling message, the terminal device may prioritize a first sidelink transmission of the first service or signaling message over a second sidelink transmission of a second service or signaling message to which the sidelink feature is not applied. In particular, the terminal device may allocate a resource to a first destination (e.g., to a first L2 destination) of the first sidelink transmission with a higher priority than a second destination (e.g., to a second L2 destination) of the second sidelink transmission. Within the same destination, the terminal device may allocate a resource to a first SLCH for the first sidelink transmission with a higher priority than a second SLCH for the second sidelink transmission. For example, upon receiving a sidelink grant, the terminal device may first assign the sidelink grant to L2 destinations supporting or applying sidelink DRX, or to SLCHs carrying services to which sidelink DRX is applied or enabled. Alternatively, the terminal device may apply a negative offset to a first SLCH priority of a first SLCH for the first sidelink transmission, and/or apply a positive offset to a second SLCH priority of a second SLCH for the second sidelink transmission. Here, the larger a value of an SLCH priority is, the lower the SLCH priority will be. Accordingly, a positive offset has an effect of lowering the SLCH priority, and vice versa. For example, the negative offset and/or the positive offset may be preconfigured or configured by a network node (e.g., a serving gNB of the terminal device). In this way, for example, L2 destinations supporting or applying sidelink DRX, or SLCHs carrying services to which sidelink DRX is applied or enabled, can be prioritized in resource allocation, so as to provide fair transmission opportunities between transmissions with sidelink DRX and transmissions without sidelink DRX.

FIG. 34 is a flowchart illustrating a method 3400 according to an embodiment of the present disclosure. The method 3400 can be performed by a first terminal device, e.g., a UE to transmit or receive a service or signaling message over sidelink.

At block 3410, the first terminal device transmits, to a second terminal device, an indication (e.g., referred to as sidelink feature indication hereinafter) of whether a sidelink feature is supported or applied by the first terminal device for a service or signaling message.

Here, the sidelink feature may include sidelink DRX.

Here, the service may include a groupcast or broadcast service. It can be appreciated that the principle of the present disclosure is also applicable to unicast services. The signaling message may include a discovery message, a request for establishing a sidelink unicast connection (i.e., the first message in sidelink unicast connection establishment), or a response to the request (i.e., the second message in sidelink unicast connection establishment). The signaling message may be identified by an SLCH ID and/or an L2 destination ID.

In an example, the sidelink feature indication may be carried in:
SCI (e.g., by using one or more reserved bits or adding a new field),
an SL-SCH MAC header (e.g., by using one or more reserved bits or adding a new field),
a MAC CE,
PC5-RRC signaling, which may be transmitted by means of unicast, groupcast, or broadcast, e.g., in a previous transmission,
PC5-S, which may be transmitted e.g., in a previous transmission, or
a control PDU of a protocol layer (e.g., SDAP, PDCP, RLC, or an adaptation layer when the indication is transmitted via a sidelink relay).

The above MAC CE may be transmitted when the first terminal device joins a connection-oriented group (e.g., a group with formation and management on an application layer), in response to a request (e.g., based on PC5-RRC signaling, MAC CE, or Layer 1 (L1) signaling) from the second terminal device, or periodically (e.g., with preconfigured or configured periodicity). The MAC CE may be identified using a new SLCH ID. The MAC CE may be a newly defined MAC CE or may reuse an existing MAC CE. The sidelink feature indication may be carried by the MAC CE either explicitly or implicitly. In the latter case, e.g., when the sidelink feature is sidelink DRX, the indication may be a DRX Command MAC CE implicitly indicating that the sidelink DRX is applied by the first terminal device.

In an example, the sidelink feature indication may be per service type, per application type, per traffic type, or per signaling message type. The first terminal device may have a plurality of services or signaling messages to transmit and/or receive, and may have a plurality of sidelink feature indications to transmit. In order to reduce signaling overhead, a bitmap can be used. The bitmap may contain a plurality of bits each associated with a service type, an application type, a traffic type, or a signaling message type.

In an example, the sidelink feature indication may be transmitted via another terminal device serving as a group header in groupcast communication. In another example, the sidelink feature indication may be transmitted to a group header, which may store the sidelink feature indication and later transmit the sidelink feature indication to other terminal devices when appropriate.

FIG. 35 is a flowchart illustrating a method 3500 according to an embodiment of the present disclosure. The method 3500 can be performed by a second terminal device, e.g., a UE to transmit or receive a service or signaling message over sidelink.

At block 3510, the second terminal device receives, from a first terminal device, an indication (e.g., referred to as sidelink feature indication hereinafter) of whether a sidelink feature is supported or applied by the first terminal device for a service or signaling message.

Here, the sidelink feature may include sidelink DRX.

Here, the service may include a groupcast or broadcast service. It can be appreciated that the principle of the present disclosure is also applicable to unicast services. The signaling message may include a discovery message, a request for establishing a sidelink unicast connection (i.e., the first message in sidelink unicast connection establishment), or a response to the request (i.e., the second message in sidelink unicast connection establishment). The signaling message may be identified by an SLCH ID and/or an L2 destination ID.

In an example, the sidelink feature indication may be carried in:
SCI (e.g., by using one or more reserved bits or adding a new field),
an SL-SCH MAC header (e.g., by using one or more reserved bits or adding a new field),
a MAC CE,
PC5-RRC signaling, which may be transmitted by means of unicast, groupcast, or broadcast, e.g., in a previous transmission,
PC5-S, which may be transmitted e.g., in a previous transmission, or
a control PDU of a protocol layer (e.g., SDAP, PDCP, RLC, or an adaptation layer when the indication is transmitted via a sidelink relay).

The above MAC CE may be transmitted when the first terminal device joins a connection-oriented group (e.g., a group with formation and management on an application layer), in response to a request (e.g., based on PC5-RRC signaling, MAC CE, or L1 signaling) from the second terminal device, or periodically (e.g., with preconfigured or configured periodicity). The MAC CE may be identified using a new SLCH ID. The MAC CE may be a newly defined MAC CE or may reuse an existing MAC CE. The sidelink feature indication may be carried by the MAC CE either explicitly or implicitly. In the latter case, e.g., when the sidelink feature is sidelink DRX, the indication may be a DRX Command MAC CE implicitly indicating that the sidelink DRX is applied by the first terminal device.

In an example, the sidelink feature indication may be per service type, per application type, per traffic type, or per signaling message type. The indication may be contained in a bitmap having a plurality of bits each associated with a service type, an application type, a traffic type, or a signaling message type.

In an example, the sidelink feature indication may be received via another terminal device serving as a group header in groupcast communication.

In an example, the second terminal device may determine whether to apply the sidelink feature in receiving the service or signaling message from the first terminal device based on the received sidelink feature indication.

In an example, the second terminal device may store information indicating the first terminal device as supporting or applying, or not supporting or applying, the sidelink feature based on the received sidelink feature indication. For example, the second terminal device may maintain in its local memory a list of UEs supporting or applying the sidelink feature, and/or a list of UEs not supporting or applying the sidelink feature. The stored information or list(s) can be updated periodically or in an event-triggered manner (e.g., each time a sidelink feature indication is received). In this case, the second terminal device may determine whether to apply the sidelink feature in receiving the service or signaling message from the first terminal device based on the stored information. For example, the second terminal device may determine to apply the sidelink feature in receiving the service or signaling message when the received sidelink feature indication or the stored information indicates that the sidelink feature is supported or applied by the first terminal device in transmitting the service or signaling message, and vice versa.

In an example, the second terminal device may determine not to apply the sidelink feature in receiving a transmission from the first terminal device in absence of knowledge that the sidelink feature is supported or applied by the first terminal device, i.e., when it is not sure whether the sidelink feature is supported or applied by the first terminal device, or even not sure which terminal device would be the transmitter, e.g., in case of broadcast or groupcast. For example, when the second terminal device is intended to receive a groupcast service associated with a connection-oriented group, it may check with a group header or all terminal device in the group whether sidelink DRX is supported or applied for the service when joining the group, i.e., before actual transmission/reception of the service. The second terminal device may not apply sidelink DRX for the service if it is not sure whether sidelink DRX is applied by a transmitter, e.g., in initial transmission(s) when the second terminal device is monitoring potential data reception for the service, as it does not know which terminal device would be the transmitter of the service and whether the transmitter supports or applies sidelink DRX before receiving the initial transmission(s) (especially for broadcast service or groupcast service). After reception of the initial transmission(s), the second terminal device can identify the transmitter of the service and whether or not the transmitter applies sidelink DRX. Then, the second terminal device can decide whether to apply sidelink DRX depending on whether the transmitter has applied sidelink DRX.

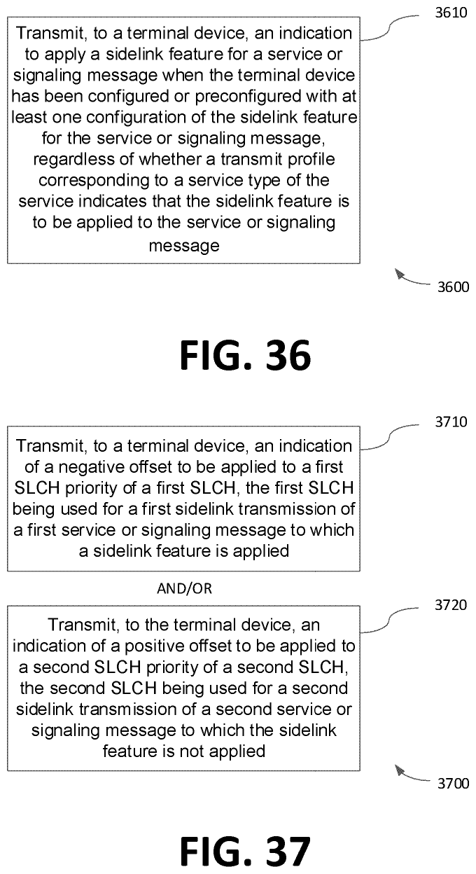

FIG. 36 is a flowchart illustrating a method 3600 according to an embodiment of the present disclosure. The method 3600 can be performed by a network node, e.g., a gNB.

At block 3610, the network node transmits, to a terminal device, an indication (e.g., the above overriding indication) to apply a sidelink feature for a service or signaling message when the terminal device has been configured or preconfigured with at least one configuration of the sidelink feature for the service or signaling message, regardless of whether a transmit profile corresponding to a service type of the service indicates that the sidelink feature is to be applied to the service or signaling message.

Here, the sidelink feature may include sidelink DRX. The at least one configuration of the sidelink feature may include at least one sidelink DRX configuration, which may include e.g., drx-onDurationTimer, drx-InactivityTimer, and other timers/parameters same as or similar to those specified in Section 5.7 of TS 38.321 (see Annex 1).

Here, the service may include a groupcast or broadcast service. It can be appreciated that the principle of the present disclosure is also applicable to unicast services. The signaling message may include a discovery message, a request for establishing a sidelink unicast connection (i.e., the first message in sidelink unicast connection establishment), or a response to the request (i.e., the second message in sidelink unicast connection establishment). The signaling message may be identified by an SLCH ID and/or an L2 destination ID.

FIG. 37 is a flowchart illustrating a method 3700 according to an embodiment of the present disclosure. The method 3700 can be performed by a network node, e.g., a gNB.

At block 3710, the network node transmits, to a terminal device, an indication (e.g., referred to as negative offset indication hereinafter) of a negative offset to be applied to a first SLCH priority of a first SLCH. The first SLCH is used for a first sidelink transmission of a first service or signaling message to which a sidelink feature is applied.

Additionally or alternatively, at block 3720, the network node transmits, to the terminal device, an indication (e.g., referred to as positive offset indication hereinafter) of a positive offset to be applied to a second SLCH priority of a second SLCH. The second SLCH is used for a second sidelink transmission of a second service or signaling message to which the sidelink feature is not applied.

Here, the above negative offset indication and positive offset indication may be carried in a same message or in different messages.

Here, the sidelink feature may include sidelink DRX. The first service and/or the second service may include a groupcast or broadcast service. It can be appreciated that the principle of the present disclosure is also applicable to unicast services. The first signaling message and/or the second signaling message may include a discovery message, a request for establishing a sidelink unicast connection (i.e., the first message in sidelink unicast connection establishment), or a response to the request (i.e., the second message in sidelink unicast connection establishment). Each signaling message may be identified by an SLCH ID and/or an L2 destination ID.

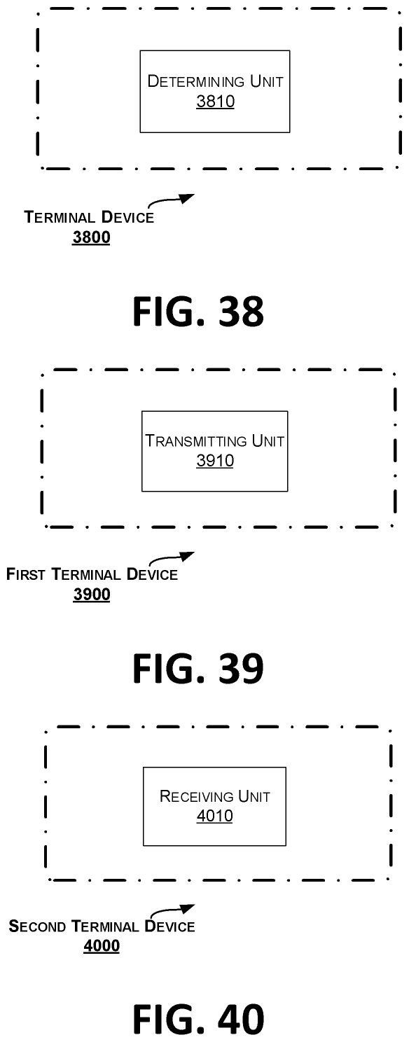

Correspondingly to the method 3300 as described above, a terminal device is provided. FIG. 38 is a block diagram of a terminal device 3800 according to an embodiment of the present disclosure.

The terminal device 3800 is operative to perform the method 3300 as described above in connection with FIG. 33. The terminal device 3800 includes a determining unit 3810 configured to determine whether to apply a sidelink feature for a service or signaling message based on at least one of: a transmit profile corresponding to a service type of the service, and whether the terminal device has been configured or preconfigured with at least one configuration of the sidelink feature for the service or signaling message.

In an embodiment, the determining unit 3810 may be configured to: determine to apply the sidelink feature when the transmit profile indicates that the sidelink feature is to be applied to the service or signaling message, and the terminal device has been configured or preconfigured with the at least one configuration of the sidelink feature for the service or signaling message, or determine not to apply the sidelink feature when the transmit profile indicates that the sidelink feature is not to be applied to the service or signaling message, and the terminal device has not been configured or preconfigured with the at least one configuration of the sidelink feature for the service or signaling message.

In an embodiment, the determining unit 3810 may be configured to: determine to apply the sidelink feature when the terminal device has been configured or preconfigured with the at least one configuration of the sidelink feature for the service or signaling message, regardless of whether the transmit profile indicates that the sidelink feature is to be applied to the service or signaling message.

In an embodiment, the terminal device 3800 may further include a receiving unit configured to receive, from a network node, an indication to apply the sidelink feature when the terminal device has been configured or preconfigured with the at least one configuration of the sidelink feature for the service or signaling message, regardless of whether the transmit profile indicates that the sidelink feature is to be applied to the service or signaling message.

In an embodiment, the terminal device 3800 may further include a prioritizing unit configured to, subsequent to determining to apply the sidelink feature for the service or signaling message: prioritize a first sidelink transmission of the service or signaling message over a second sidelink transmission of another service or signaling message to which the sidelink feature is not applied.

In an embodiment, the prioritizing unit may be configured to: allocate a resource to a first destination of the first sidelink transmission with a higher priority than a second destination of the second sidelink transmission.

In an embodiment, the prioritizing unit may be configured to: allocate a resource to a first SLCH for the first sidelink transmission with a higher priority than a second SLCH for the second sidelink transmission.

In an embodiment, the prioritizing unit may be configured to: apply a negative offset to a first SLCH priority of a first SLCH for the first sidelink transmission, and/or apply a positive offset to a second SLCH priority of a second SLCH for the second sidelink transmission.

In an embodiment, the negative offset and/or the positive offset may be preconfigured or configured by a network node.

In an embodiment, the sidelink feature may include sidelink DRX, and/or the at least one configuration of the sidelink feature may include at least one sidelink DRX configuration.

In an embodiment, the service may include a groupcast or broadcast service, or the signaling message may include a discovery message, a request for establishing a sidelink unicast connection, or a response to the request.

The unit 3810 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 33.

Correspondingly to the method 3400 as described above, a first terminal device is provided. FIG. 39 is a block diagram of a first terminal device 3900 according to an embodiment of the present disclosure.

The first terminal device 3900 is operative to perform the method 3400 as described above in connection with FIG. 34. The first terminal device 3900 includes a transmitting unit 3910 configured to: transmit, to a second terminal device, an indication of whether a sidelink feature is supported or applied by the first terminal device for a service or signaling message.

In an embodiment, the indication may be carried in: SCI, an SL-SCH MAC header, a MAC CE, PC5-RRC signaling, PC5-S, or a control PDU of a protocol layer.

In an embodiment, the MAC CE may be transmitted when the first terminal device joins a connection-oriented group, in response to a request from the second terminal device, or periodically, the PC5-RRC signaling may be transmitted by means of unicast, groupcast, or broadcast, or the protocol layer may include SDAP, PDCP, RLC, or an adaptation layer when the indication is transmitted via a sidelink relay.

In an embodiment, the indication may be per service type, per application type, per traffic type, or per signaling message type.

In an embodiment, the indication may be contained in a bitmap having a plurality of bits each associated with a service type, an application type, a traffic type, or a signaling message type.

In an embodiment, the sidelink feature may include sidelink DRX, and the indication may include a DRX Command MAC CE implicitly indicating that the sidelink DRX is applied by the first terminal device.

In an embodiment, the sidelink feature may include sidelink DRX.

In an embodiment, the service may include a groupcast or broadcast service, or the signaling message may include a discovery message, a request for establishing a sidelink unicast connection, or a response to the request.

In an embodiment, the indication may be transmitted via another terminal device serving as a group header in groupcast communication.

The unit 3910 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 34.

Correspondingly to the method 3500 as described above, a second terminal device is provided. FIG. 40 is a block diagram of a second terminal device 4000 according to an embodiment of the present disclosure.

The second terminal device 4000 is operative to perform the method 3500 as described above in connection with FIG. 35. The second terminal device 4000 includes a receiving unit 4010 configured to receive, from a first terminal device, an indication of whether a sidelink feature is supported or applied by the first terminal device for a service or signaling message.

In an embodiment, the indication may be carried in: SCI, an SL-SCH MAC header, a MAC CE, PC5-RRC signaling, PC5-S, or a control PDU of a protocol layer.

In an embodiment, the MAC CE may be transmitted when the first terminal device joins a connection-oriented group, in response to a request from the second terminal device, or periodically, the PC5-RRC signaling may be transmitted by means of unicast, groupcast, or broadcast, or the protocol layer may include SDAP, PDCP, RLC, or an adaptation layer when the indication is transmitted via a sidelink relay.

In an embodiment, the indication may be per service type, per application type, per traffic type, or per signaling message type.

In an embodiment, the indication may be contained in a bitmap having a plurality of bits each associated with a service type, an application type, a traffic type, or a signaling message type.

In an embodiment, the sidelink feature may include sidelink DRX, and the indication may include a DRX Command MAC CE implicitly indicating that the sidelink DRX is applied by the first terminal device.

In an embodiment, the sidelink feature may include sidelink DRX.

In an embodiment, the service may include a groupcast or broadcast service, or the signaling message may include a discovery message, a request for establishing a sidelink unicast connection, or a response to the request.

In an embodiment, the indication may be received via another terminal device serving as a group header in groupcast communication.

In an embodiment, the second terminal device 4000 may further include a determining unit configured to determine whether to apply the sidelink feature in receiving the service or signaling message from the first terminal device based on the received indication.

In an embodiment, the second terminal device 4000 may further include a storing unit configured to store information indicating the first terminal device as supporting or applying, or not supporting or applying, the sidelink feature based on the indication.

In an embodiment, the second terminal device 4000 may further include a determining unit configured to determine whether to apply the sidelink feature in receiving the service or signaling message from the first terminal device based on the stored information.

In an embodiment, the second terminal device 4000 may further include a determining unit configured to determine not to apply the sidelink feature in receiving a transmission from the first terminal device in absence of knowledge that the sidelink feature is supported or applied by the first terminal device.

The unit 4010 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 35.

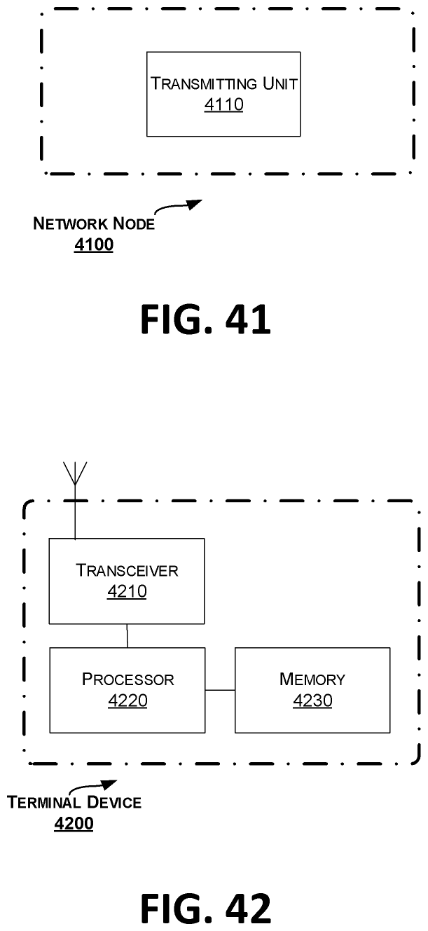

Correspondingly to the method 3600 or 3700 as described above, a network node is provided. FIG. 41 is a block diagram of a network node 4100 according to an embodiment of the present disclosure.

The network node 4100 is operative to perform the method 3600 as described above in connection with FIG. 36. The network node 4100 includes a transmitting unit 4110 configured to transmit, to a terminal device, an indication to apply a sidelink feature for a service or signaling message when the terminal device has been configured or preconfigured with at least one configuration of the sidelink feature for the service or signaling message, regardless of whether a transmit profile corresponding to a service type of the service indicates that the sidelink feature is to be applied to the service or signaling message.

In an embodiment, the sidelink feature may include sidelink DRX, and/or the at least one configuration of the sidelink feature may include at least one sidelink DRX configuration.

In an embodiment, the service may include a groupcast or broadcast service, or the signaling message may include a discovery message, a request for establishing a sidelink unicast connection, or a response to the request.

Alternatively, the network node 4100 is operative to perform the method 3700 as described above in connection with FIG. 37. The network node 4100 includes a transmitting unit 4110 configured to transmit, to a terminal device, an indication of a negative offset to be applied to a first SLCH priority of a first SLCH, the first SLCH being used for a first sidelink transmission of a first service or signaling message to which a sidelink feature is applied; and/or transmit, to the terminal device, an indication of a positive offset to be applied to a second SLCH priority of a second SLCH, the second SLCH being used for a second sidelink transmission of a second service or signaling message to which the sidelink feature is not applied.

In an embodiment, the sidelink feature may include sidelink DRX.

In an embodiment, the first service and/or the second service may include a groupcast or broadcast service, or the first signaling message and/or the second signaling message may include a discovery message, a request for establishing a sidelink unicast connection, or a response to the request.

The unit 4110 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 36 or 37.

FIG. 42 is a block diagram of a terminal device 4200 according to another embodiment of the present disclosure.

The terminal device 4200 includes a transceiver 4210, a processor 4220 and a memory 4230. The memory 4230 may contain instructions executable by the processor 4220 whereby the terminal device 4200 is operative to perform the actions, e.g., of the procedure described earlier in conjunction with FIG. 33. Particularly, the memory 4230 may contain instructions executable by the processor 4220 whereby the terminal device 4200 is operative to: determine whether to apply a sidelink feature for a service or signaling message based on at least one of: a transmit profile corresponding to a service type of the service, and whether the terminal device has been configured or preconfigured with at least one configuration of the sidelink feature for the service or signaling message.

In an embodiment, the operation of determining may include: determining to apply the sidelink feature when the transmit profile indicates that the sidelink feature is to be applied to the service or signaling message, and the terminal device has been configured or preconfigured with the at least one configuration of the sidelink feature for the service or signaling message, or determining not to apply the sidelink feature when the transmit profile indicates that the sidelink feature is not to be applied to the service or signaling message, and the terminal device has not been configured or preconfigured with the at least one configuration of the sidelink feature for the service or signaling message.

In an embodiment, the operation of determining may include: determining to apply the sidelink feature when the terminal device has been configured or preconfigured with the at least one configuration of the sidelink feature for the service or signaling message, regardless of whether the transmit profile indicates that the sidelink feature is to be applied to the service or signaling message.

In an embodiment, the memory 4230 may further contain instructions executable by the processor 4220 whereby the terminal device 4200 is operative to: receive, from a network node, an indication to apply the sidelink feature when the terminal device has been configured or preconfigured with the at least one configuration of the sidelink feature for the service or signaling message, regardless of whether the transmit profile indicates that the sidelink feature is to be applied to the service or signaling message.

In an embodiment, the memory 4230 may further contain instructions executable by the processor 4220 whereby the terminal device 4200 is operative to: subsequent to determining to apply the sidelink feature for the service or signaling message: prioritize a first sidelink transmission of the service or signaling message over a second sidelink transmission of another service or signaling message to which the sidelink feature is not applied.

In an embodiment, the operation of prioritizing may include: allocating a resource to a first destination of the first sidelink transmission with a higher priority than a second destination of the second sidelink transmission.

In an embodiment, the operation of prioritizing may include: allocating a resource to a first SLCH for the first sidelink transmission with a higher priority than a second SLCH for the second sidelink transmission.

In an embodiment, the operation of prioritizing may include: applying a negative offset to a first SLCH priority of a first SLCH for the first sidelink transmission, and/or applying a positive offset to a second SLCH priority of a second SLCH for the second sidelink transmission.

In an embodiment, the negative offset and/or the positive offset may be preconfigured or configured by a network node.

In an embodiment, the sidelink feature may include sidelink DRX, and/or the at least one configuration of the sidelink feature may include at least one sidelink DRX configuration.

In an embodiment, the service may include a groupcast or broadcast service, or the signaling message may include a discovery message, a request for establishing a sidelink unicast connection, or a response to the request.

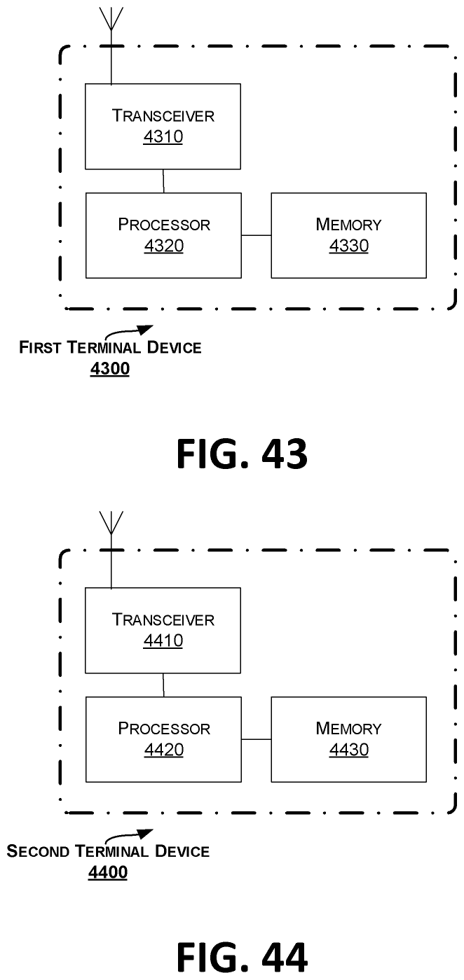

FIG. 43 is a block diagram of a first terminal device 4300 according to another embodiment of the present disclosure.

The first terminal device 4300 includes a transceiver 4310, a processor 4320 and a memory 4330. The memory 4330 may contain instructions executable by the processor 4320 whereby the first terminal device 4300 is operative to perform the actions, e.g., of the procedure described earlier in conjunction with FIG. 34. Particularly, the memory 4330 may contain instructions executable by the processor 4320 whereby the first terminal device 4300 is operative to: transmit, to a second terminal device, an indication of whether a sidelink feature is supported or applied by the first terminal device for a service or signaling message.

In an embodiment, the indication may be carried in: SCI, an SL-SCH MAC header, a MAC CE, PC5-RRC signaling, PC5-S, or a control PDU of a protocol layer.

In an embodiment, the MAC CE may be transmitted when the first terminal device joins a connection-oriented group, in response to a request from the second terminal device, or periodically, the PC5-RRC signaling may be transmitted by means of unicast, groupcast, or broadcast, or the protocol layer may include SDAP, PDCP, RLC, or an adaptation layer when the indication is transmitted via a sidelink relay.

In an embodiment, the indication may be per service type, per application type, per traffic type, or per signaling message type.

In an embodiment, the indication may be contained in a bitmap having a plurality of bits each associated with a service type, an application type, a traffic type, or a signaling message type.

In an embodiment, the sidelink feature may include sidelink DRX, and the indication may include a DRX Command MAC CE implicitly indicating that the sidelink DRX is applied by the first terminal device.

In an embodiment, the sidelink feature may include sidelink DRX.

In an embodiment, the service may include a groupcast or broadcast service, or the signaling message may include a discovery message, a request for establishing a sidelink unicast connection, or a response to the request.

In an embodiment, the indication may be transmitted via another terminal device serving as a group header in groupcast communication.

FIG. 44 is a block diagram of a second terminal device 4400 according to another embodiment of the present disclosure.

The second terminal device 4400 includes a transceiver 4410, a processor 4420 and a memory 4430. The memory 4430 may contain instructions executable by the processor 4420 whereby the second terminal device 4400 is operative to perform the actions, e.g., of the procedure described earlier in conjunction with FIG. 35. Particularly, the memory 4430 may contain instructions executable by the processor 4420 whereby the second terminal device 4400 is operative to: receive, from a first terminal device, an indication of whether a sidelink feature is supported or applied by the first terminal device for a service or signaling message.

In an embodiment, the indication may be carried in: SCI, an SL-SCH MAC header, a MAC CE, PC5-RRC signaling, PC5-S, or a control PDU of a protocol layer.

In an embodiment, the MAC CE may be transmitted when the first terminal device joins a connection-oriented group, in response to a request from the second terminal device, or periodically, the PC5-RRC signaling may be transmitted by means of unicast, groupcast, or broadcast, or the protocol layer may include SDAP, PDCP, RLC, or an adaptation layer when the indication is transmitted via a sidelink relay.

In an embodiment, the indication may be per service type, per application type, per traffic type, or per signaling message type.

In an embodiment, the indication may be contained in a bitmap having a plurality of bits each associated with a service type, an application type, a traffic type, or a signaling message type.

In an embodiment, the sidelink feature may include sidelink DRX, and the indication may include a DRX Command MAC CE implicitly indicating that the sidelink DRX is applied by the first terminal device.

In an embodiment, the sidelink feature may include sidelink DRX.

In an embodiment, the service may include a groupcast or broadcast service, or the signaling message may include a discovery message, a request for establishing a sidelink unicast connection, or a response to the request.

In an embodiment, the indication may be received via another terminal device serving as a group header in groupcast communication.

In an embodiment, the memory 4430 may further contain instructions executable by the processor 4420 whereby the second terminal device 4400 is operative to: determine whether to apply the sidelink feature in receiving the service or signaling message from the first terminal device based on the received indication.

In an embodiment, the memory 4430 may further contain instructions executable by the processor 4420 whereby the second terminal device 4400 is operative to: store information indicating the first terminal device as supporting or applying, or not supporting or applying, the sidelink feature based on the indication.

In an embodiment, the memory 4430 may further contain instructions executable by the processor 4420 whereby the second terminal device 4400 is operative to: determine whether to apply the sidelink feature in receiving the service or signaling message from the first terminal device based on the stored information.

In an embodiment, the memory 4430 may further contain instructions executable by the processor 4420 whereby the second terminal device 4400 is operative to: determine not to apply the sidelink feature in receiving a transmission from the first terminal device in absence of knowledge that the sidelink feature is supported or applied by the first terminal device.

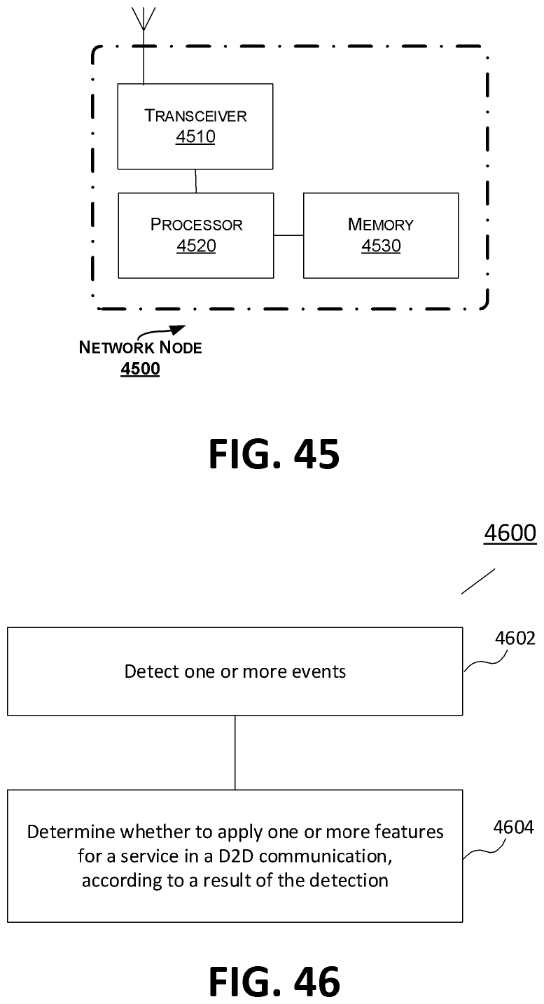

FIG. 45 is a block diagram of a network node 4500 according to another embodiment of the present disclosure.

The network node 4500 includes a transceiver 4510, a processor 4520 and a memory 4530. The memory 4530 may contain instructions executable by the processor 4520 whereby the network node 4500 is operative to perform the actions, e.g., of the procedure described earlier in conjunction with FIG. 36. Particularly, the memory 4530 may contain instructions executable by the processor 4520 whereby the network node 4500 is operative to: transmit, to a terminal device, an indication to apply a sidelink feature for a service or signaling message when the terminal device has been configured or preconfigured with at least one configuration of the sidelink feature for the service or signaling message, regardless of whether a transmit profile corresponding to a service type of the service indicates that the sidelink feature is to be applied to the service or signaling message.

In an embodiment, the sidelink feature may include sidelink DRX, and/or the at least one configuration of the sidelink feature may include at least one sidelink DRX configuration.

In an embodiment, the service may include a groupcast or broadcast service, or the signaling message may include a discovery message, a request for establishing a sidelink unicast connection, or a response to the request.

Alternatively, the memory 4530 may contain instructions executable by the processor 4520 whereby the network node 4500 is operative to perform the actions, e.g., of the procedure described earlier in conjunction with FIG. 37. Particularly, the memory 4530 may contain instructions executable by the processor 4520 whereby the network node 4500 is operative to: transmit, to a terminal device, an indication of a negative offset to be applied to a first SLCH priority of a first SLCH, the first SLCH being used for a first sidelink transmission of a first service or signaling message to which a sidelink feature is applied; and/or transmit, to the terminal device, an indication of a positive offset to be applied to a second SLCH priority of a second SLCH, the second SLCH being used for a second sidelink transmission of a second service or signaling message to which the sidelink feature is not applied.

In an embodiment, the sidelink feature may include sidelink DRX.

In an embodiment, the first service and/or the second service may include a groupcast or broadcast service, or the first signaling message and/or the second signaling message may include a discovery message, a request for establishing a sidelink unicast connection, or a response to the request.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 4220 causes the terminal device 4200 to perform the actions, e.g., of the procedure described earlier in conjunction with FIG. 33; code/computer readable instructions, which when executed by the processor 4320 causes the first terminal device 4300 to perform the actions, e.g., of the procedure described earlier in conjunction with FIG. 34; code/computer readable instructions, which when executed by the processor 4420 causes the second terminal device 4400 to perform the actions, e.g., of the procedure described earlier in conjunction with FIG. 35; or code/computer readable instructions, which when executed by the processor 4520 causes the network node 4500 to perform the actions, e.g., of the procedure described earlier in conjunction with FIG. 36 or 37.

The computer program product may be configured as a computer program code structured in computer program modules. The computer program modules could essentially perform the actions of the flow illustrated in FIG. 33, 34, 35, 36, or 37.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs).

The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

The present disclosure further includes the following embodiments.

The present disclosure is described in the context of NR sidelink (SL) communications. However, most of the embodiments are in general applicable to any kind of direct communications between UEs involving device-to-device (D2D) communications such as LTE SL. Embodiments are described from a TX UE and RX UE point of view. Further, it is assumed that a SL UE and its serving gNB (if the UE is in NW coverage) operates with the same radio access technology (RAT) e.g., NR, LTE, and so on. However, all the embodiments apply without loss of meaning to any combination of RATs between the SL UE and its serving gNB.

Further, all the embodiments can be applied without any loss of meaning to a communication that happens between a UE1 that implements 3GPP release “X” and UE2 that implements 3GPP release “Y”, or vice versa. Similarly, all the embodiments can also be applied without any loss of meaning to a communication that happens between a UE1 that implements a feature such as SL DRX and UE2 that does not implement the feature, or vice versa (regardless of the 3GPP release they are implementing).

In the following embodiments, we use the term “advanced UE” to stand for a Rel-17(+) UE and/or a UE supporting SL DRX functionalities, and the term “legacy UE” to stand for a Rel-16(−) UE and/or a UE not supporting SL DRX functionalities. Besides, we use the term “TX profile” to stand for a communication profile which is available at TX UE and/or RX UE. The embodiments are not restricted by the term. Any similar term such as “communication profile”, “transmission and reception profile”, etc. is equally applicable here.

Further, in the following we use the terminology “UE implementing a 3GPP release that support feature x” to indicate a UE that implements a 3GPP when the feature x is supported. However, this does not mean that this given UE is capable of supporting feature x as this it depends by its own implementation. In such a case, hereafter we use the terminology “A UE that supports feature x” to describe a UE that implements a 3GPP that support feature x and, at the same time, is also able to use feature x because it is actually implementing it.

In the following embodiments, we assume that the solution based on TX profile is applied to the UE.

In addition, we take the functionality of SL DRX as an example in the below embodiments. In fact, the embodiments are not limited by the example, the similar embodiments as described in the below are also applicable to any other SL function, which may be configured/preconfigured to the UE.

In addition, the below embodiments are applicable to any service/application/traffic type based on groupcast or broadcast transmission fashion if without otherwise specified.

The present disclosure discloses mechanisms to handle compatibility issues for SL functionalities such as SL DRX with SL groupcast and broadcast. The main inventive aspects include:
A SL UE may skip what is indicated in the TX profile (e.g., whether to use SL DRX or not) and decide what functionalities to use according to its own capabilities, according to a certain service that the UE need to handle, or according to an indication received by the network, or another UE;
A new control signalling is introduced for SL groupcast and broadcast, where a SL UE may indicate to other UEs in proximity or the UEs within a certain group that a certain SL functionality is enabled/disabled (e.g., SL DRX).
When a UE is interested to receive a service from other UE, the UE may check if the transmitter UE has applied SL DRX and decide whether to apply SL DRX for the reception based on the check results.
For a UE with multiple services to transmit, the UE may prioritize transmissions of services with DRX applied than other transmission of services without DRX applied.

In the first embodiment, there may be two tools available for a UE to determine whether SL DRX shall be applied for a service/applicable/traffic type.
Determine whether to apply SL DRX for the service based on the TX profile configured/mapped to the service type. The TX profile indicates whether the UE shall apply SL DRX for the service type associated with the TX profile.
Determine whether to apply SL DRX for the service depending on whether at least one SL DRX configuration has been configured/preconfigured for the service.

If the TX profile indicates that SL DRX shall not be applied for the associated service type and/or there is not any SL DRX configuration configured/preconfigured for the service, the UE will not apply SL DRX for the service.

Alternatively, the UE may check whether the UE is allowed to skip/override the indication given by the TX profile. Such skipping/override behavior is configured to the UE by gNB, the core network or another controlling UE. Alternatively, such behavior is preconfigured to the UE. Alternatively, such behavior is captured in specs in a hard coded fashion.

If the UE is allowed to skip/override the indication given by the TX profile for the service, the UE will apply SL DRX for the service ignoring whatever indication given by the TX profile, i.e. only taking into account whether there is any SL DRX configuration (pre)configured for the service. Otherwise, the UE will perform actions according to indication made by the TX profile, i.e.,
Apply SL DRX for the service during transmission and/reception if the TX profile indicates that SL DRX can be applied
Doesn't apply SL DRX for the service during transmission and/reception if the TX profile indicates that SL DRX cannot be applied

In the second embodiment, for a UE with multiple services, for each service, the UE determines whether to apply SL DRX according to what described in the first embodiment. Upon obtainment of a SL grant, the UE may prioritize transmissions of services with DRX than other transmission of services without DRX. For instance, the UE may first assign the SL grant to the destinations with SL DRX applied/enabled. For the same destination, the UE may first assign the resources to LCHs carrying services with DRX applied/enabled. Alternatively, the UE may add a (pre)configured positive offset to the SLCH priority of SLCH(s) carrying service(s) w/o SL DRX applied/enabled and/or add a (pre)configured negative offset to the SLCH priority of SLCH(s) carrying service(s) with SL DRX applied/enabled, by this L2 destination ID(s) with SL DRX applied/enabled and SLCH(s) carrying service(s) with SL DRX applied/enabled are prioritized during the transmission.

In the third embodiment, a UE signals to other UEs on whether SL DRX supported/enabled/applied (for a service) via any one or more of the following options:
Include the indication in SCI by using the reserved bit(s) or adding new field.
Include the indication in SL-SCH MAC header by using the reserved bit(s) or adding new field.
Include the indication in a MAC CE to convey the indication, the MAC CE may be transmitted when the UE joins a connection-oriented group (i.e. a group with formation and management on application layer), or upon request (e.g., based on PC5-RRC signaling or MAC CE or L1 signaling) from another UE, or periodically with a (pre)configured periodicity, A new SLCH ID may be used to identify this MAC CE.
The MAC CE may be a new defined MAC CE, or use/reuse of an existing MAC CE
The indication may be carried by the MAC CE explicitly or inexplicitly. For the latter, a UE may indicate that SL DRX is applied if the UE sends DRX command MAC CE to other UEs.
Include the indication in PC5-RRC signaling which is transmitted in unicast or groupcast or broadcast fashion.
Include the indication in PC5-S signaling
Include the indication in a control PDU of a protocol layer (e.g., SDAP, PDCP, RLC or an adaptation layer in case of SL relay)

Note: for any one of the above options, the indication may be defined per service/application/traffic type. There may be multiple indications/indicators signaled to other UE if the UE is with multiple services. In order to reduce signaling overhead, bitmap containing multiple bits may be applied in the signaling, wherein each bit is associated with a different service type.

Note: for any one of the above options, the signaling may be signaled by a UE via a group header to other UEs. Alternatively, the signaling may be transmitted for a UE by a group header, to other UEs if the group header has already information on whether the UE applies SL DRX.

In the fourth embodiment, a UE may store a list of UEs which support/enable/apply SL DRX in its memory. Optionally the UE may also store a list of UEs which do not support/enable/apply SL DRX in its memory. The stored information may be updated periodically or in event-triggering fashion. In an example, the UE update the list for a UE if a certain event is triggered. In another example, the UE removes a UE from the list if another event is triggered.

In the fifth embodiment, when a UE is interested to receive a service from other UE, the UE may check if the transmitter UE has applied SL DRX according to e.g. received indication (as described in the third embodiment) or stored info (as described in the fourth embodiment) on related to SL DRX, if SL DRX has been applied by the transmitter UE, the UE may decide to also apply SL DRX for the reception, otherwise the UE may not apply SL DRX for the reception. When the UE is interested to receive a groupcast service associated with a connection-oriented group, the UE may perform such check with the group header UE or all the UEs in the group when it joins the group, i.e. before the actual transmission/reception of the service. The UE may not apply SL DRX for an interested service if the UE is not sure whether SL DRX has been applied by the transmitted UE, e.g. for initial receptions when the UE monitors potential data reception for that service. This is because the UE may have no clue on which UE will transmit the service and whether the transmitter UE has applied SL DRX before receiving the initial transmission (especially for broadcast service or groupcast service w/o a connection-oriented group). After reception of initial transmission (e.g., one or multiple transmission), the UE can identify which UE is the transmitter, and whether or not the transmitter applies SL DRX. Thereafter, the UE can decide whether to apply SL DRX depending on whether the transmitter has applied SL DRX.

In the sixth embodiment, specific Tx profile/SL DRX configuration may be (pre)configured to certain control signaling identified by specific SLCH ID and/or L2 destination ID, the UE may be (pre)configured to override Tx profile associated with a certain control signaling, the indication on whether SL DRX is supported/enabled/applied may also be introduced for control signaling. By this the methods described in the above embodiments are equally applied to control signaling. Example of such signaling comprises discovery message, the first message in SL unicast connection establishment (i.e. the establishment request), the second message in SL unicast connection establishment (i.e. the response message), etc.

By implementing the mechanisms proposed in the present disclosure, the compatibility issue between a UE that supports a certain SL functionality and other UE(s) that do not support the same SL functionality (e.g., SL DRX) can be solved, meanwhile, different UEs could apply different functionality as long as this does not cause compatibility issue. By this UEs implementing different 3GPP releases and/or different SL functionalities are able to communicate properly and more efficiently over SL.

Communication service providers and network operators have been continually facing challenges to deliver value and convenience to consumers by, for example, providing compelling network services and performance. With the evolution of wireless communication, a requirement for supporting device-to-device (D2D) communication features in various applications is proposed. An extension for the D2D work may consist of supporting vehicle-to-everything (V2X) communication, which may include any combination of direct communications among vehicles, pedestrians and infrastructure. Wireless communication networks such as fourth generation (4G)/long term evolution (LTE) and fifth generation (5G)/new radio (NR) networks may be expected to use V2X services and support communication for V2X capable user equipment (UE).

D2D communications (also referred to as sidelink (SL) communications or communication over the PC5 interface) between neighboring devices are specified by 3GPP in Release-12 (Rel-12). Some enhancements of the SL are introduced in subsequent releases for vehicle-to-vehicle (V2V) or V2X communications. However, unlike cellular communications, there is no mechanism for SL communications to ensure coexistence between UEs of different releases yet. For example, when a UE has a new service/traffic type for transmission or reception, the new service/traffic type may need to use a feature (e.g., SL discontinuous reception (DRX), etc.) that is not allowed to apply by the existing service/traffic type. This may affect applicability of the feature. Therefore, it may be desirable to address the UE coexistence issue in a D2D or SL communication scenario.

Various exemplary embodiments of the present disclosure propose a solution for handling UE coexistence.

It can be appreciated that the term “feature” described in this document may refer to a capability or a functionality of a UE. Thus, the terms “feature”, “capability” and “functionality” may be used interchangeably in this document. Further, the term “feature” may be used to identify a single feature that the UE may apply for a service/traffic type (e.g., intelligent transport systems (ITS) safety, cooperative driving, etc.) during transmissions or receptions, and the term “feature group” may be used to identify a group of features that the UE may apply during transmissions or receptions all together (and not only a subset of these features).

It also can be appreciated that in various exemplary embodiments, the term “TX profile” is used to stand for a communication profile which is available at a transmission/transmitting/transmitter (TX) UE and/or a reception/receiving/receiver (RX) UE. The exemplary embodiments are not restricted by this term. Any similar term such as “communication profile”, “transmission and reception profile”, etc. may be equally applicable in this document.

In addition to the previous discussion, there is an on-going email discussion in 3GPP, i.e., 3GPP TSG-RAN WG2 Meeting #115 electronic “Summary of [POST114-e][704][V2X/SL] How to make sure Rel-16 UEs not supporting SL DRX are not involved in SL communication in DRX manner (Sharp)”, which may be found at “https./www.3gpp.org/ftp/Email Discussions/RAN2/%5BRAN2%23114-e%5D/%5BPost114-e%5D%5B704%5D%5BSL%5D %20Rel-16%20UEs%20not%20supporting%20SL%20DRX%20(Sharp)/R2-21xxxxx%20-%20Summary%20of%20%5BPOST114-e%5D%5B704%5D%5BV2XSL%5D_Phase2_v00.doc”. This contribution is a summary of the following email discussion which was triggered at RAN2 #114-e.
[POST114-e][704][V2X/SL] How to make sure Rel-16 UEs not supporting SL DRX are not involved in SL communication in DRX manner (Sharp).
Scope: Discuss possible options (e.g., based on SL UE capability information via PC5-RRC, TX profile information, or resource pool separation, etc.) (including pros, cons and preference) and decide the most agreeable one. Good to have two sub-deadlines. First one is to collect companies' options, and the second one is for the discussion and decision.
Intended outcome: Discussion summary.
Deadline: Long email discussion.

This email discussion is organized into two phases.
Phase 1 is intended to identify use cases and corresponding open issues relevant to this email discussion, and collect companies' views on potential solutions for the identified open issues (if any). The deadline is Friday July 2nd, 09:00 UTC.
Phase 2 is intended to consolidate and further discuss potential solutions (if any), and strive to identify an agreeable way forward. The deadline is Friday August 6th, 09:00 UTC. Companies are encouraged to provide feedback to Phase 2 questions by Wednesday August 4th, 12:00 UTC so that some time is left for discussion of potential proposals.

There are at least three mechanisms to address the coexistence issues which are under discussions. The following mechanisms are applicable to all cast types including unicast, groupcast and broadcast if not otherwise specified

### Mechanism 1: TX Profile Based Approach

Draft description of the TX profile based approach:
A service is associated with a service type, which can be mapped to a TX profile.
Since a service type is also mapped to a Destination Layer-2 ID, each Destination Layer-2 ID can be associated with a TX profile.
A TX profile identifies [a Release, or one or more sidelink features, or one or more sidelink feature groups].
A TX profile is indicated from the upper layer to the AS layer.
   Multiple TX profiles can be defined/configured/indicated.
For GC/BC,
   A Rel-16 TX UE [or a Rel-16 RX UE] shall not be provided a Layer-2 Destination ID with an associated TX profile corresponding to SL DRX. [FFS how this is ensured.]
   A Rel-17 TX UE or a Rel-17 RX UE shall only apply a SL DRX configuration for a Layer-2 Destination ID with an associated TX profile corresponding to SL DRX.

### Mechanism 2: Pool Separation Based Approach

Proposed description of the pool separation based approach:
A RX pool can be configured as one of the following to a Rel-17 UE,
SL DRX enabled”: a Rel-17 RX UE monitors slots in the RX pool only during SL DRX active time (i.e. “normal” SL DRX behavior).
SL DRX disabled”: a Rel-17 RX UE monitors all slots in the RX pool, even for slots falling into SL DRX inactive time (i.e. Rel-16 RX UE behavior).
A TX pool can be configured as one of the following to a Rel-17 UE,
SL DRX enabled”: the TX pool is included in the set of TX pools from which a pool is chosen for resource selection, for and only for SL transmissions for which a SL DRX configuration is applied.
   A TX pool configured with “SL DRX enabled” is not visible to a Rel-16 TX UE.
   “SL DRX disabled”: the TX pool is included in the set of TX pools from which one pool is chosen for resource selection, for and only for SL transmissions for which no SL DRX configuration is applied.

### Mechanism 3: Coexistence Negotiation Based on UE Capability

At least for unicast, two UEs supporting different releases can exchange the information on the supported 3GPP releases between each other using RRC signaling carrying UE capabilities. In this way, both UEs can determine whether to apply a specific feature or feature group of a 3GPP release for a service.

In the WID (3GPP RP-202846, “WID revision: NR sidelink enhancement”) for the WI “SL Enhancement” in Rel-17, one study objective regarding coexistence between Rel-16 UE and Rel-17 UE is defined in “Enhancements introduced in Rel-17should be based on the functionalities specified in Rel-16, and Rel-17 sidelink should be able to coexist with Rel-16 sidelink in the same resource pool”.

In the specification, NR SL has no mechanism to ensure coexistence between UEs of different releases yet. The LTE SL framework for coexistence between UEs of different releases (i.e., TX profile), as a promising option, is being discussed and will be most probably adopted with necessary enhancement for NR to address the coexistence issue. In some enhancement embodiments, a TX profile is extended to comprise at least one of the following parameters or information elements which are associated with the profile:
a unique index/ID associated with the profile;
one or multiple service/traffic types;
indices or indicators of one or multiple 3GPP releases;
indices or indicators of one or multiple 3GPP features/functionalities.

In the concept, a profile may be mapped to features or feature group. In this way, the mechanism may not only address the coexistence issue due to introduction of SL DRX in Rel-17, but also address the coexistence issues in future releases due to introduction of any new feature. This gives better potential to avoid compatibility issues in future.

Thus, a UE may only apply a feature (e.g., SL DRX) from a receiver point of view if the transmission profiles of all the service types include the feature (e.g., SL DRX) as a supported feature. From a transmitter point of view, the UE may still use a feature (e.g., SL DRX parameters/configuration) to ensure alignment with the receivers of transmissions of a service type for which the correspond transmission profile supports the feature (e.g., SL DRX). For example, the UE may take receiver DRX parameters/configuration into account while performing resource allocation to ensure that the transmission is properly received by a RX UE that may be using SL DRX.

There is a remaining issue which has not been addressed. In the case that a UE has a new service/traffic type for transmission or reception, the TX profile associated with the new service/traffic type may have different mapping to a specific feature compared to the TX profiles which the UE is already applying. This may affect applicability of the feature.

In an example, from a receiver point of view, the UE is allowed to apply SL DRX by the existing TX profiles, while the new TX profile does not allow the UE to apply SL DRX. In this case, the UE needs stopping SL DRX. Meanwhile, the UE may also need to inform all neighbor UEs and/or gNBs which have connections to the UE. The similar issue is also existing for the UE from a transmitter point of view.

In addition to the TX profile based mechanism, the same issue is also relevant for other mechanisms for addressing the coexistence issue.

Therefore, there is a need to study how to address the coexistence issue as mentioned above and develop corresponding solutions.

Various exemplary embodiments of the present disclosure propose a solution for handling UE coexistence. In accordance with an exemplary embodiment, the UE coexistence may be triggered by arrival of new services/traffic types. For example, when a UE is interested to a new service/traffic type, the UE can determine whether to apply a feature for the new service/traffic type and/or whether the feature needs to be configured, reconfigured or de-configured. In an embodiment, if one or more specific events occur, indicating that the feature needs to be applied for the new service/traffic type, or that the feature which is being applied by the UE becomes unavailable or unnecessary to apply, or that a change of configuration of the feature is required for the new service/traffic type, etc., the UE may perform one or more operations/actions to change the configuration of the feature for the new service/traffic type and optionally inform it to a gNB and/or other neighbor UEs. Alternatively or additionally, the UE may perform one or more operations/actions with respect to the configuration of the feature for the new service/traffic type, according to an instruction from a gNB and/or another UE.

Based on the proposed solution, at least one of the following benefits may be achieved:
UEs supporting different 3GPP releases can communicate between each other.
UEs supporting different 3GPP features can communicate between each other.
Interruptions to service QoS due to misaligned feature configuration may be avoided.

It can be appreciated that although exemplary embodiments in this disclosure are referring to the NR RAT, they can be applied also to LTE RAT and any other RAT enabling the direct transmission between two (or more) nearby devices without any loss of meaning.

Various exemplary embodiments may be applicable regardless which mechanism (e.g., TX profile based approach, pool separation based approach, or UE capability based approach) is adopted to address the coexistence issue. Or in other words, the exemplary embodiments are not restricted by any mechanism for addressing the coexistence issue.

In accordance with an exemplary embodiment, a UE may perform transmission or reception of at least one interested service/traffic type. For a feature or a feature group, the UE may determine whether or not the feature or the feature group needs to be configured or reconfigured or de-configured. In an embodiment, if the feature or the feature group that is being applied by the UE becomes unavailable or unnecessary to apply, e.g., due to a specific event, the UE may determine to de-configure the feature or the feature group, or reconfigure the feature or the feature group by disabling/deactivating the feature or the feature group.

In accordance with an exemplary embodiment, the UE may perform detection of at least one of the following events for determining whether a feature or a feature group can be applied by the UE. According to an embodiment, the feature or the feature group is not allowed to use if at least one of the following events occur:
i. A new service or traffic type which is not mapped to the feature or the feature group (explicitly or inexplicitly) arrives.
ii. Presence of another UE which is not capable of supporting the feature or the feature group. In this case, the other UE communicates with the UE using at least one same service or traffic type.
iii. The UE has finished data transfer or reception for the services which are associated with the feature or the feature group.
iv. When a timer (e.g., a prohibit timer, etc.) is running during which the feature or the feature group cannot be used.
v. An indication from the network or another UE indicating that the feature or the feature group is not allowed to be used anymore.

For point “iv”, it may refer to the case where a prohibit timer is used for a certain feature. For instance, the UE may use a certain feature, and once the feature is used, the UE starts a timer (e.g., with a duration configured by a gNB or eventually another UE). When the timer is running, the UE is forbidden to use this feature, and when the timer expires, the UE can start to use this feature again. In an embodiment, the use of the prohibit timer can be enabled/disabled by the gNB or another UE.

According to another embodiment, the feature or the feature group is allowed to use if none of the above events are detected and all the following conditions are met:
a. The feature or the feature group are mapped to all services or traffic types (explicitly or inexplicitly) that the UE is interested to or involved with.
b. All UEs communicating with the UE can support the feature or the feature group.
c. The UE has data transfer or reception for at least one service or traffic type that is associated with the feature or the feature group.
d. There is not any running timer (e.g., a prohibit timer, etc.) during which the feature or the feature group cannot be used.
e. There is not any indication from the network or another UE indicating that the feature or the feature group is not allowed to be used.

In accordance with an exemplary embodiment, the UE may change configuration of the feature or the feature group by performing at least one of the following actions:
1) Reconfiguration of the feature or the feature group, from “disabling/not applying/deactivation” to “enabling/applying/activation”.
2) Reconfiguration of the feature or the feature group, from “enabling/applying/activation” to “disabling/not applying/deactivation”.
3) Configuration of the feature/feature group so that the UE can apply the feature/feature group after the configuration (i.e., the feature/feature group was not configured to the UE before).
4) De-configuration of the feature/feature group so that the UE does not apply the feature/feature group after the de-configuration (i.e., the feature/feature group was configured to the UE before).
5) Reconfiguration of the feature/feature group to the UE. So, the UE is still able to apply the feature/feature group, however with some different settings compared to before.

It is noted that for any one of the above actions, the action procedure may involve not only the UE itself, but also involve one or more other UEs employing the same service/traffic type, and/or one or more gNBs which serve the UEs. In this case, the action procedure may also include signaling exchange between UEs and/or between the UE(s) and the gNB(s). As an example, for a procedure involving the action 1), the UE may send a PC5 RRC reconfiguration message (e.g., RRCReconfigurationSidelink, etc.) to another UE, and upon reception of the reconfiguration message, the other UE may reply with a response message (e.g., RRCReconfigurationCompleteSidelink or RRCReconfigurationFailureSidelink, etc.) indicating completion or failure of the procedure.

In accordance with an exemplary embodiment, the UE may inform one or more gNBs and/or other neighbor UEs of: one or more events detected by the UE, and/or one or more actions performed by the UE for changing the configuration of the feature or the feature group.

In accordance with an exemplary embodiment, any of the actions for changing the configuration of the feature or the feature group may be performed by the UE proactively or passively. For the former, the UE can determine which action(s) may need to be performed by itself. For the latter, the UE may perform the action(s) following one or more instructions from the gNB or other UEs. In an embodiment, the instruction may be triggered after the UE has informed the gNB or the other UEs of the detected events.

In accordance with an exemplary embodiment, the UE may monitor the events in a periodic fashion. A periodic timer may be defined accordingly. Alternatively or additionally, the UE may monitor the events after reception (e.g., after each reception) or before transmission (e.g., before each transmission). Alternatively or additionally, the UE may monitor the events after getting an explicit or implicit indication from another UE or a gNB.

In accordance with an exemplary embodiment, the UE may select at least one of the following signaling alternatives:
RRC signaling (e.g., PC5 RRC or Uu RRC);
MAC CE;
Control PDU of a protocol layer such as service data adaptation protocol (SDAP), packet data convergence protocol (PDCP), radio link control (RLC) or an adaptation layer in case of SL relay; and
Physical layer (L1) signaling (e.g., carried on channels such as physical downlink control channel (PDCCH), random access channel (RACH), physical uplink control channel (PUCCH) on Uu interface or PSSCH, PSCCH, PSFCH on PC5 interface).

In accordance with an exemplary embodiment, the selected signaling may be used by the UE to perform an action(s) or implement an action procedure(s) for changing the configuration of the feature or the feature group. In this case, the signaling itself may be one component/step of the action procedure. According to an embodiment, the UE may use the signaling to inform one or more gNBs and/or other neighbor UEs of the fact that the configuration of the feature or the feature group is changed or may need to change.

In accordance with an exemplary embodiment, the signaling may include at least one of the following information:
a cause which triggers the change of the configuration for the feature or the feature group;
If the changing of the configuration for the feature or the feature group is due to presence of a new service or a new traffic type, the signaling may further include at least one of the following:
   the index of the service or the traffic type; and
   QoS parameters associated with the service or the traffic type, e.g., a priority index, a delay requirement, a bit rate requirement, etc.
If the changing of the configuration for the feature or the feature group is due to presence of other UEs which are not capable of supporting the feature or the feature group, the signaling may further include at least one of the following:
   release numbers (e.g., numbers of 3GPP releases) that the other UEs support; and
   UE capabilities (on whether or not supporting the feature or the feature group) that other UEs support.
If the changing of the configuration for the feature or the feature group is due to that the UE has finished data transmission or reception for the service which is associated with the feature or the feature group, the signaling may further include at least one of the following:
   the data volume or data rate that the UE has achieved during data transmission or reception; and
   a time period that the UE has performed data transmission or reception.
If the changing of the configuration for the feature or the feature group is due to a timer running (e.g., prohibit timer, etc.) during which a certain feature or feature group cannot be used, the signaling may further include at least one of the following:
   a duration of the timer;
   whether the timer is applied to one single feature or a group of features; and
   how many times the timer has been started/stopped.

In accordance with an exemplary embodiment, in order to reduce the signaling overhead, a bitmap field may be introduced in the signaling so that the bitmap field may contain one or multiple bits, where each bit corresponds to a specific feature or feature group. According to an embodiment, each of the bits in the bitmap may take the following values:
the value of “1” indicates that the feature or the feature group is activated/enabled; and
the value of “0” indicates that the feature or the feature group is deactivated/disabled.

According to another embodiment, each of the bits in the bitmap may take the following values:
the value of “0” indicates that the feature or the feature group is activated/enabled; and
the value of “1” indicates that the feature or the feature group is deactivated/disabled.

It can be appreciated that the value “0” and “1” can also be exchanged with a Boolean value such as “true” and “false” and any combination of it. Further, the signaling can also be described as the presence or absence or a certain field. For instance, the signaling can be an ENUMERATED field. The presence of this field means that the feature or the feature group is activated/enabled, and the absence of this field means that the feature or the feature group is deactivated/disabled.

In accordance with an exemplary embodiment, for a new service or new traffic type that the UE is interested to, a feature may be configured or preconfigured with one of the following application capabilities:
mandatory to be applied;
optional to be applied; and
not allowed to be applied.

Correspondingly, the UE may apply one of the following Options to determine whether to start the service or the traffic type:
Option 1: in the case that the feature is mandatory to be applied for the service or the traffic type, the UE may start transmission or reception of the service using the feature only when the existing service(s) or traffic type(s) allow the feature to be applied (i.e., the feature is mandatory or optional to be applied for any existing service or traffic type).
Option 2: in the case that the feature is mandatory to be applied for the service or the traffic type, if the priority of the new type of service is higher than the highest priority of the existing service(s) to which the feature is not allowed to be applied, the UE may start transmission or reception of the service using the feature, meanwhile stop the existing service(s) to which the feature is not allowed to be applied. Otherwise, if the priority of the new type of service is lower than the highest priority of the existing service(s) to which the feature is not allowed to be applied, the UE may not start transmission or reception of the service.
Option 3: in the case that the feature is optionally to be applied for the service or the traffic type, the UE may start transmission or reception of the service. In such a case, the feature may or may not be used. Whether to use this feature may be determined by the UE by considering whether application of this feature may affect the existing services or traffic types.
Option 4: in the case that the feature is not allowed to be applied for the service or the traffic type, the UE may start transmission or reception of the service not using the feature.

Various exemplary embodiments in this disclosure can address the UE coexistence issue by enabling UEs supporting different features/releases to communicate with each other over a D2D link or SL. In an embodiment, UE2 receives data of service 1 from UE1, and service 1 is associated with TX profile 1 which indicates support of SL DRX. So, both UE1 and UE2 apply the feature of SL DRX for service 1. After a while, UE2 may receive data of service 2 from UE3, and service 2 is associated with TX profile 2 which indicates no support of SL DRX. In this case, UE2 may take one or more proper actions to change feature configuration. After that, UE2 may not apply SL DRX. Given this, in the case that UE2 stops using SL DRX, UE1 and UE3 may or may not be informed of this. Since UE2 may be always in “on” state, so UE2 is able to receive data from UE1 or UE3 at any time. However, if UE2 intends to start data transmission towards UE1/UE3, UE2 may have to inform UE1/UE3 of whether UE2 applies SL DRX. Otherwise, UE1/UE3 may miss data reception due to misaligned active state between UE2 and UE1/UE3. On the other hand, if UE2 decides to start using SL DRX, it may need to inform UE1 and/or UE3 since their transmissions need to happen when UE2 is in “on” state (e.g., according to its SL DRX configuration). Yet, as a further alternative, UE2 may always inform UE1 and UE3 of the change of feature configuration for UE2.

It is noted that some embodiments of the present disclosure are mainly described in relation to 4G/LTE or 5G/NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

FIG. 46 is a flowchart illustrating a method 4600 according to some embodiments of the present disclosure. The method 4600 illustrated in FIG. 46 may be performed by a UE or an apparatus communicatively coupled to the UE. In accordance with an exemplary embodiment, the UE may be configured to support D2D communications (e.g., V2X or SL communications, etc.) with other devices. In an exemplary embodiment, the UE may be configured to communicate with a network node (e.g., a base station such as an eNB, a gNB, etc.) directly or via another UE.

According to the exemplary method 4600 illustrated in FIG. 46, the UE may detect one or more events, as shown in block 4602. According to a result of the detection, the UE may determine whether to apply one or more features for a service in a D2D communication, as shown in block 4604. In accordance with an exemplary embodiment, the one or more features may be related to one or more capabilities of the UE.

In accordance with an exemplary embodiment, the UE may determine not to apply the one or more features for the service in the D2D communication, when the one or more events detected by the UE belong to a predefined set of events. In an embodiment, the predefined set of events may comprise one or more of the following events:
the service being not mapped to the one or more features;
presence of one or more other UEs which are not capable of supporting the one or more features;
completion of data transmission or reception by the UE for the service associated with the one or more features;
when a timer is running during which the one or more features are unavailable; and
an indication that the one or more features are not allowed to be used.

In accordance with an exemplary embodiment, the UE may determine to apply the one or more features for the service in the D2D communication, when none of the predefined set of events are detected by the UE and the following conditions are met:
the one or more features are mapped to all services which the UE is interested to or involved with;
all UEs communicating with the UE are capable of supporting the one or more features;
the UE has data transmission or reception for at least one service which is associated with the one or more features;
there is not any running timer during which the one or more features are not allowed to be used; and
the UE does not get any indication indicating that the one or more features are not allowed to be used.
In accordance with an exemplary embodiment, the UE may change configuration of the one or more features by performing one or more of the following actions:
reconfiguring the one or more features by enabling the one or more features;
reconfiguring the one or more features by disabling the one or more features;
configuring the one or more features which are not configured to the UE previously;
de-configuring the one or more features which are configured to the UE previously; and
reconfiguring the one or more features by changing parameter settings of the one or more features previously configured to the UE.

In accordance with an exemplary embodiment, the configuration of the one or more features may be changed by the UE proactively or in response to an instruction from a communication device. In an exemplary embodiment, the communication device may be a base station or another UE (e.g., a UE capable of controlling at least part of D2D/SL communications).

In accordance with an exemplary embodiment, when determining to apply the one or more features for the service in the D2D communication, the UE may not change the configuration of the one or more features, e.g., if the one or more features are being used for an existing service with the same configuration.

In accordance with an exemplary embodiment, the UE may transmit a first message (e.g., RRCReconfigurationSidelink, etc.) to a communication device (e.g., a base station or another UE, etc.). In an embodiment, the first message may indicate one or more of:
a request for changing configuration of the one or more features;
a change of the configuration of the one or more features;
at least one of the one or more events detected by the UE; and
one or more actions performed by the UE for changing the configuration of the one or more features.

In accordance with an exemplary embodiment, the first message may be transmitted by the UE via one or more of:
RRC signaling;
a MAC CE;
a control PDU; and
L1 signaling.
In accordance with an exemplary embodiment, the first message may indicate one or more of:
a cause which triggers the change of the configuration of the one or more features;
an index of the service;
one or more QoS parameters associated with the service;
one or more release numbers supported by one or more other UEs;
one or more capabilities of the one or more other UEs;
a data volume and/or data rate achieved by the UE;
a time period that the UE performs data transmission and/or data reception;
a duration of a timer for prohibiting application of one or more corresponding features;
whether the timer is applied to a specific feature or a group of features; and
a number of times the timer has been started or stopped.

In accordance with an exemplary embodiment, the first message may include a bitmap field. In an embodiment, each bit of the bitmap field may correspond to a specific feature or feature group, and may be used to indicate activation or deactivation of the specific feature or feature group.

In accordance with an exemplary embodiment, the UE may receive a second message (e.g., RRCReconfigurationCompleteSidelink or RRCReconfigurationFailureSidelink, etc.) from the communication device. As an example, the second message may or may not be a response to the first message. In an embodiment, the second message may include one or more of:
an instruction of changing the configuration of the one or more features;
an indication of completion or failure of changing the configuration of the one or more features; and
configuration information for detecting the one or more events.

In accordance with an exemplary embodiment, the instruction of changing the configuration of the one or more features may indicate one or more actions to be performed by the UE for changing the configuration of the one or more features.

In accordance with an exemplary embodiment, the one or more features may be detected by the UE according to at least one of the following criteria:
periodically;
after data reception;
before data transmission; and
after getting a detection indication from a communication device.

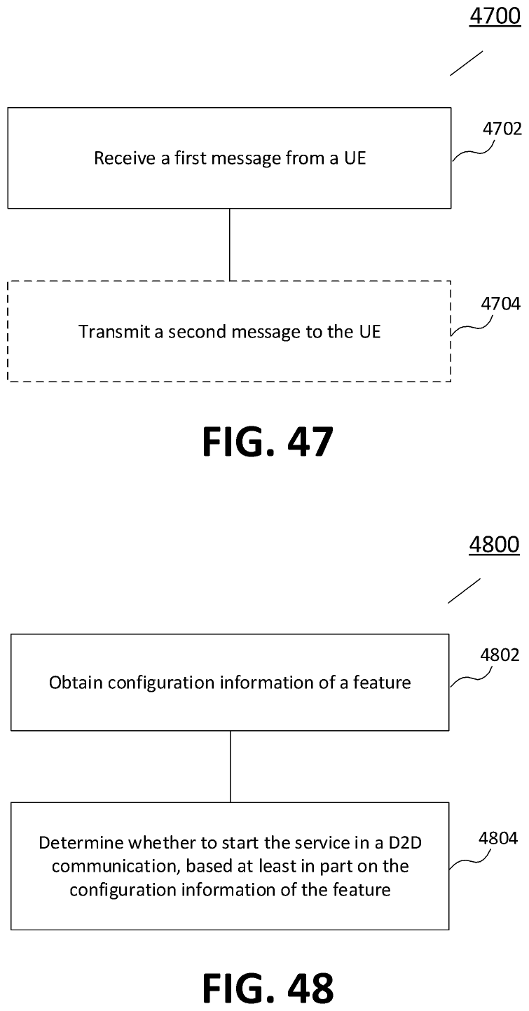

FIG. 47 is a flowchart illustrating a method 4700 according to some embodiments of the present disclosure. The method 4700 illustrated in FIG. 47 may be performed by a communication device or an apparatus communicatively coupled to the communication device. In accordance with an exemplary embodiment, the communication device (e.g., a base station, an access point, etc.) may be configured to support cellular communications and parameters provisioning of one or more UEs in a network. In accordance with another exemplary embodiment, the communication device (e.g., a UE, a mobile station, etc.) may be configured to support D2D communications (e.g., V2X or SL communications, etc.) with other devices, and/or cellular communications with a network node (e.g., an eNB, a gNB, etc.) directly or via a relay device.

According to the exemplary method 4700 illustrated in FIG. 47, the communication device may receive a first message from a UE (e.g., the UE as described with respect to FIG. 46), as shown in block 4702. In accordance with an exemplary embodiment, the first message may indicate one or more of:
a request for changing configuration of one or more features for a service in a D2D communication, where the one or more features may be related to one or more capabilities of the UE;
a change of the configuration of the one or more features;
at least one of one or more events detected by the UE; and
one or more actions performed by the UE for changing the configuration of the one or more features.

In accordance with an exemplary embodiment, the first message received by the communication device according to the method 4700 may correspond to the first message transmitted by the UE according to the method 4600. Thus, the first message as described with respect to FIG. 46 and the first message as described with respect to FIG. 47 may have the same or similar contents and/or information elements.

In accordance with an exemplary embodiment, the one or more features may not to be applied for the service in the D2D communication, when the one or more events detected by the UE belong to a predefined set of events (e.g., the predefined set of events as described with respect to FIG. 46).

In accordance with an exemplary embodiment, the communication device may optionally transmit a second message to the UE, as shown in block 4704. In accordance with an exemplary embodiment, the second message may include one or more of:
an instruction of changing the configuration of the one or more features;
an indication of completion or failure of changing the configuration of the one or more features; and
configuration information for detecting the one or more events.

In accordance with an exemplary embodiment, the second message transmitted by the communication device according to the method 4700 may correspond to the second message received by the UE according to the method 4600. Thus, the second message as described with respect to FIG. 46 and the second message as described with respect to FIG. 47 may have the same or similar contents and/or information elements FIG. 48 is a flowchart illustrating a method 4800 according to some embodiments of the present disclosure. The method 4800 illustrated in FIG. 48 may be performed by a UE or an apparatus communicatively coupled to the UE. In accordance with an exemplary embodiment, the UE may be configured to support D2D communications (e.g., V2X or SL communications, etc.) with other devices. In an exemplary embodiment, the UE may be configured to communicate with a network node (e.g., an eNB, a gNB, etc.) directly or via another UE.

According to the exemplary method 4800 illustrated in FIG. 48, the UE may obtain configuration information of a feature, as shown in block 4802. The feature may be related to one or more capabilities/functionalities of the UE, and the configuration information may indicate whether the feature is mandatory to be applied for a service. In accordance with an exemplary embodiment, based at least in part on the configuration information of the feature, the UE may determine whether to start the service in a D2D communication, as shown in block 304.

In accordance with an exemplary embodiment, when the configuration information indicates that the feature is mandatory to be applied for the service, and when existing services of the UE allow the feature to be applied, the UE may determine to start the service using the feature.

In accordance with an exemplary embodiment, when the configuration information indicates that the feature is mandatory to be applied for the service, and when a priority of the service is higher than a highest priority of existing services of the UE for which the feature is not allowed to be applied, the UE may determine to start the service using the feature. According to an embodiment, the UE may stop the existing services for which the feature is not allowed to be applied.

In accordance with an exemplary embodiment, when the configuration information indicates that the feature is mandatory to be applied for the service, and when a priority of the service is lower than a highest priority of existing services of the UE for which the feature is not allowed to be applied, the UE may determine not to start the service.

In accordance with an exemplary embodiment, when the configuration information indicates that the feature is not mandatory but optional to be applied for the service, the UE may determine to start the service, e.g., using or not using the feature.

In accordance with an exemplary embodiment, when the configuration information indicates that the feature is not mandatory and not allowed to be applied for the service, the UE may determine to start the service without using the feature.

It can be appreciated that the UE as described with respect to FIG. 46 may also be configured to perform the method 4700 described in connection with FIG. 47 and/or the method 4800 described in connection with FIG. 48, e.g., according to different service requirements and/or capabilities of the UE. Similarly, the UE as described with respect to FIG. 48 may also be configured to perform the method 4600 described in connection with FIG. 46 and/or the method 4700 described in connection with FIG. 47, e.g., according to different service requirements and/or capabilities of the UE.

The various blocks shown in FIGS. 46-48 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

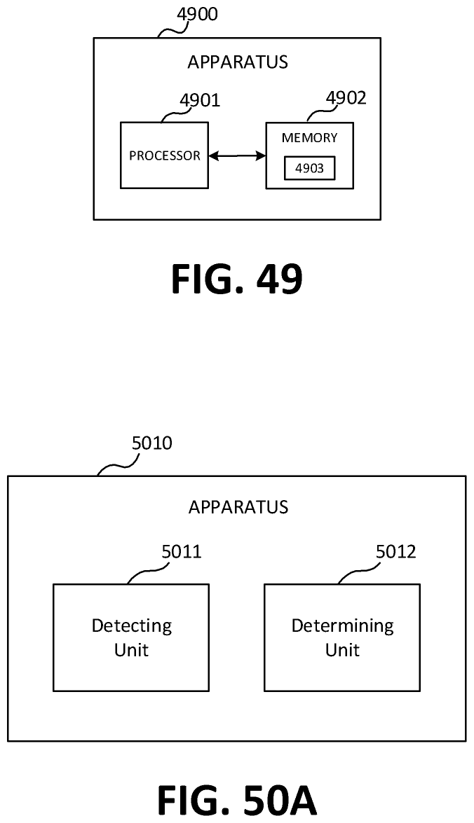

FIG. 49 is a block diagram illustrating an apparatus 4900 according to various embodiments of the present disclosure. As shown in FIG. 49, the apparatus 4900 may comprise one or more processors such as processor 4901 and one or more memories such as memory 4902 storing computer program codes 4903. The memory 4902 may be non-transitory machine/processor/computer readable storage medium. In accordance with some exemplary embodiments, the apparatus 4900 may be implemented as an integrated circuit chip or module that can be plugged or installed into a UE as described with respect to FIG. 46 or FIG. 48, or a communication device as described with respect to FIG. 47. In such cases, the apparatus 4900 may be implemented as a UE as described with respect to FIG. 46 or FIG. 48, or a communication device as described with respect to FIG. 47.

In some implementations, the one or more memories 4902 and the computer program codes 4903 may be configured to, with the one or more processors 4901, cause the apparatus 4900 at least to perform any operation of the method as described in connection with FIG. 46. In other implementations, the one or more memories 4902 and the computer program codes 4903 may be configured to, with the one or more processors 4901, cause the apparatus 4900 at least to perform any operation of the method as described in connection with FIG. 47. In other implementations, the one or more memories 4902 and the computer program codes 4903 may be configured to, with the one or more processors 4901, cause the apparatus 4900 at least to perform any operation of the method as described in connection with FIG. 48. Alternatively or additionally, the one or more memories 4902 and the computer program codes 4903 may be configured to, with the one or more processors 4901, cause the apparatus 4900 at least to perform more or less operations to implement the proposed methods according to the exemplary embodiments of the present disclosure.

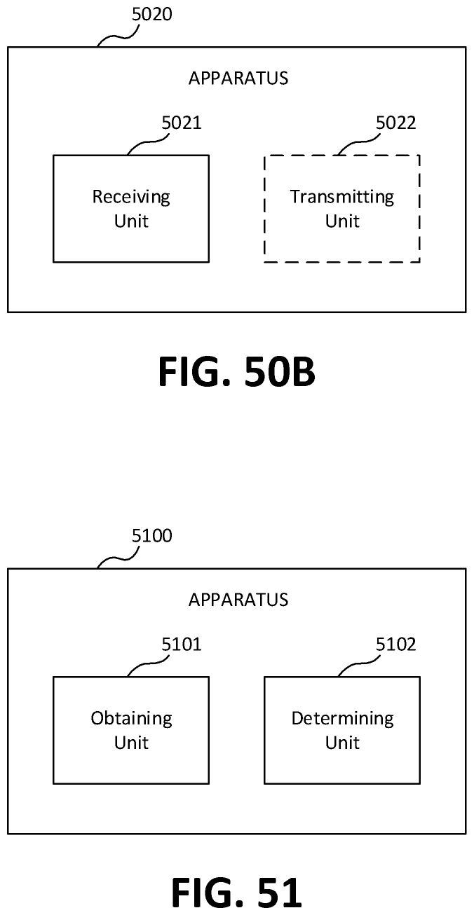

FIG. 50A is a block diagram illustrating an apparatus 5010 according to some embodiments of the present disclosure. As shown in FIG. 50A, the apparatus 5010 may comprise a detecting unit 5011 and a determining unit 5012. In an exemplary embodiment, the apparatus 5010 may be implemented in a UE. The detecting unit 5011 may be operable to carry out the operation in block 4602, and the determining unit 5012 may be operable to carry out the operation in block 4604. Optionally, the detecting unit 5011 and/or the determining unit 5012 may be operable to carry out more or less operations to implement the proposed methods according to the exemplary embodiments of the present disclosure.

FIG. 50B is a block diagram illustrating an apparatus 5020 according to some embodiments of the present disclosure. As shown in FIG. 50B, the apparatus 5020 may comprise a receiving unit 5021 and optionally a transmitting unit 5022. In an exemplary embodiment, the apparatus 5020 may be implemented in a communication device such as a base station or a UE. The receiving unit 5021 may be operable to carry out the operation in block 4702, and the transmitting unit 5022 may be operable to carry out the operation in block 4704. Optionally, the receiving unit 5021 and/or the transmitting unit 5022 may be operable to carry out more or less operations to implement the proposed methods according to the exemplary embodiments of the present disclosure.

FIG. 51 is a block diagram illustrating an apparatus 5100 according to some embodiments of the present disclosure. As shown in FIG. 51, the apparatus 5100 may comprise an obtaining unit 5101 and a determining unit 5102. In an exemplary embodiment, the apparatus 5100 may be implemented in a UE. The obtaining unit 5101 may be operable to carry out the operation in block 4802, and the determining unit 5102 may be operable to carry out the operation in block 4804. Optionally, the obtaining unit 5101 and/or the determining unit 5102 may be operable to carry out more or less operations to implement the proposed methods according to the exemplary embodiments of the present disclosure.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 4700 as describe with respect to FIG. 47.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 4700 as describe with respect to FIG. 47.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 4600 as describe with respect to FIG. 46, or any step of the exemplary method 4700 as describe with respect to FIG. 47, or any step of the exemplary method 4800 as describe with respect to FIG. 48.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 4600 as describe with respect to FIG. 46, or any step of the exemplary method 4700 as describe with respect to FIG. 47, or any step of the exemplary method 4800 as describe with respect to FIG. 48.

According to some exemplary embodiments, there is provided a method implemented in a communication system which may include a host computer, a base station and a UE. The method may comprise, at the host computer, receiving user data transmitted to the base station from the UE which may perform any step of the exemplary method 4600 as describe with respect to FIG. 46, or any step of the exemplary method 4700 as describe with respect to FIG. 47, or any step of the exemplary method 4800 as describe with respect to FIG. 48.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 4600 as describe with respect to FIG. 46, or any step of the exemplary method 4700 as describe with respect to FIG. 47, or any step of the exemplary method 4800 as describe with respect to FIG. 48.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 4700 as describe with respect to FIG. 47.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 4700 as describe with respect to FIG. 47.

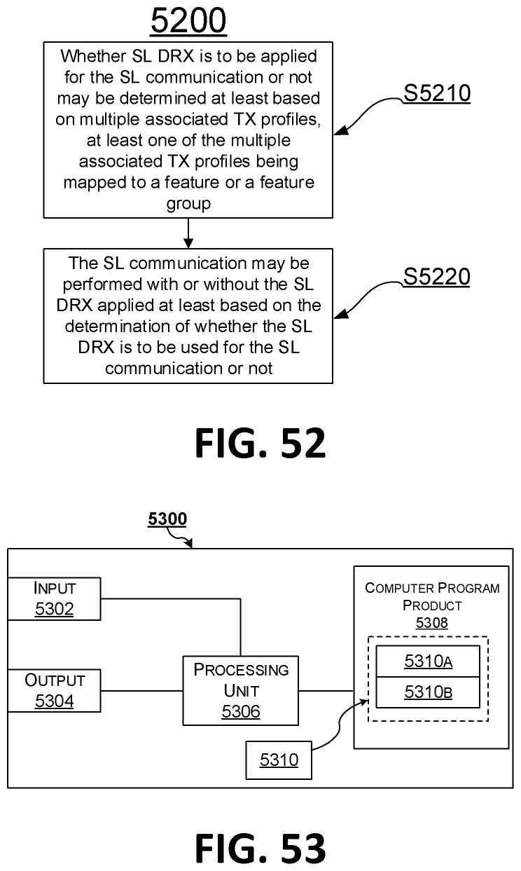

FIG. 52 is a flow chart of an exemplary method 5200 at a UE for SL communication according to an embodiment of the present disclosure. The method 5200 may be performed at a UE (e.g., the UEs 100) for TX profile based D2D communication. The method 5200 may comprise steps S5210 and S5220. However, the present disclosure is not limited thereto. In some other embodiments, the method 5200 may comprise more steps, less steps, different steps, or any combination thereof. Further the steps of the method 5200 may be performed in a different order than that described herein. Further, in some embodiments, a step in the method 5200 may be split into multiple sub-steps and performed by different entities, and/or multiple steps in the method 5200 may be combined into a single step.

The method 5200 may begin at step S5210 where whether SL DRX is to be applied for the SL communication or not may be determined at least based on multiple associated TX profiles, at least one of the multiple associated TX profiles being mapped to a feature or a feature group.

At step S5220, the SL communication may be performed with or without the SL DRX applied at least based on the determination of whether the SL DRX is to be used for the SL communication or not.

In some embodiments, when the UE is a TX UE in the SL communication, the step of determining whether SL DRX is to be applied for the SL communication or not at least based on multiple associated TX profiles may comprise: determining whether the multiple associated TX profiles support the SL DRX or not; and determining that the SL DRX is to be applied for the SL communication in response to determining that all of the multiple associated TX profiles support the SL DRX. In some embodiments, when the UE is a TX UE in the SL communication, the step of determining whether SL DRX is to be applied for the SL communication or not at least based on multiple associated TX profiles may comprise: determining whether the multiple associated TX profiles support the SL DRX or not; and determining that the SL DRX is not to be applied for the SL communication in response to determining that at least one of the multiple associated TX profiles does not support the SL DRX.

In some embodiments, when the UE is an RX UE in the SL communication, the step of determining whether SL DRX is to be applied for the SL communication or not at least based on multiple associated TX profiles may comprise: determining whether multiple TX profiles that are associated with all service types and/or L2 IDs of interest support the SL DRX or not; and determining that the SL DRX is to be applied for the SL communication in response to determining that all of the multiple associated TX profiles support the SL DRX. In some embodiments, when the UE is an RX UE in the SL communication, the step of determining whether SL DRX is to be applied for the SL communication or not at least based on multiple associated TX profiles may comprise: determining whether multiple TX profiles that are associated with all service types and/or L2 IDs of interest support the SL DRX or not; and determining that the SL DRX is not to be applied for the SL communication in response to determining that at least one of the multiple associated TX profiles does not support the SL DRX. In some embodiments, the SL communication may be SL groupcast communication or SL broadcast communication.

In some embodiments, each of the multiple associated TX profiles may indicate at least one of: a unique index and/or ID associated with the communication profile; one or more service types and/or traffic types; one or more L2 destination IDs; one or more L2 source IDs; one or more indices or indicators of one or more 3GPP releases; one or more SL feature groups and/or functionalities; one or more transmission parameters; one or more HARQ retransmission modes; one or more resource pool identifiers; one or more cast types; one or more indices and/or IDs of one or more logical channels; one or more indices and/or IDs of one or more logical channel groups; one or more indices and/or IDs of one or more radio bearers; one or more service priority levels and/or traffic priority levels; one or more QoS indicators and/or requirements; and a priority level associated with the communication profile.

In some embodiments, a service type of the SL communication may be mapped to at least one of the multiple TX profiles. In some embodiments, the service type may be at least one of: V2X; and ProSe. In some embodiments, the multiple associated TX profiles may comprise at least one of: one or more TX profiles indicated by an upper layer to an AS layer at the UE; one or more TX profiles that are received by the UE from another UE for the D2D communication; and one or more TX profiles that are received by the UE from a network node for the D2D communication.

FIG. 53 schematically shows an embodiment of an arrangement which may be used in a UE according to an embodiment of the present disclosure. Comprised in the arrangement 5300 are a processing unit 5306, e.g., with a DSP or a CPU. The processing unit 5306 may be a single unit or a plurality of units to perform different actions of procedures described herein. The arrangement 5300 may also comprise an input unit 5302 for receiving signals from other entities, and an output unit 5304 for providing signal(s) to other entities. The input unit 5302 and the output unit 5304 may be arranged as an integrated entity or as separate entities.

Furthermore, the arrangement 5300 may comprise at least one computer program product 5308 in the form of a non-volatile or volatile memory, e.g., an Electrically Erasable Programmable Read-Only Memory (EEPROM), a flash memory and/or a hard drive. The computer program product 5308 comprises a computer program 5310, which comprises code/computer readable instructions, which when executed by the processing unit 5306 in the arrangement 5300 causes the arrangement 5300 and/or the UE in which it is comprised to perform the actions, e.g., of the procedure described earlier in conjunction with FIG. 52 or any other variant.

The computer program 5310 may be configured as a computer program code structured in computer program modules 5310A to 5310B. Hence, in an exemplifying embodiment when the arrangement 5300 is used in the UE, the code in the computer program of the arrangement 5300 includes: a module 5310A configured to determine whether SL DRX is to be applied for the SL communication or not at least based on multiple associated TX profiles, at least one of the multiple associated TX profiles being mapped to a feature or a feature group; and a module 5310B configured to perform the SL communication with or without the SL DRX applied at least based on the determination of whether the SL DRX is to be used for the SL communication or not.

The computer program modules could essentially perform the actions of the flow illustrated in FIG. 52, to emulate the UE. In other words, when the different computer program modules are executed in the processing unit 5306, they may correspond to different modules in the UE.

Although the code means in the embodiments disclosed above in conjunction with FIG. 53 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU, but could also comprise two or more processing units. For example, the processor may include general purpose microprocessors; instruction set processors and/or related chips sets and/or special purpose microprocessors such as ASICs. The processor may also comprise board memory for caching purposes. The computer program may be carried by a computer program product connected to the processor. The computer program product may comprise a computer readable medium on which the computer program is stored. For example, the computer program product may be a flash memory, a RAM, a ROM, or an EEPROM, and the computer program modules described above could in alternative embodiments be distributed on different computer program products in the form of memories within the UE.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| BS | Base Station |
| CAM | Cooperative Awareness Message |
| CE | Control Element |
| CN | Core Network |
| CSI-RS | Channel State Information Reference Signal |
| DM-RS | Demodulation Reference Signal |
| DRX | Discontinuous Reception |
| eNB | e-Node B |
| gNB | g-Node B |
| ID | Identity |
| ITS | Intelligent Transport Systems |
| L2 | Layer 2 |
| LCH | Logical Channel |
| LCG | Logical Channel Group |
| LTE | Long Term Evolution |
| MAC | Medium Access Control |
| NR | New Radio |
| NW | Network |
| PDU | Protocol Data Unit |
| PHY | Physical (layer) |
| PSBCH | Physical Sidelink Broadcast Channel |
| PSCCH | Physical Sidelink Control Channel |
| PSSCH | Physical Sidelink Shared Channel |
| PT-RS | Phase Tracking Reference Signal |
| RRC | Radio Resource Control |
| RS | Reference Signal |
| RX | Reception, receiver |
| SA | Scheduling Assignment |
| SL | Sidelink |
| S-PSS | Sidelink Primary Synchronization Signal |
| S-SSB | Sidelink Synchronization Signal Block |
| S-SSS | Sidelink Secondary Synchronization Signal |
| TX | Transmission, transmitter |
| UE | User Equipment |
| V2V | Vehicle-to-Vehicle |
| V2X | Vehicle-to-Anything |

1. A method at a User Equipment (UE) for sidelink (SL) communication, the method comprising:
determining whether SL discontinuous reception (DRX) is to be applied for the SL communication or not at least based on multiple associated transmitter (TX) profiles, at least one of the multiple associated TX profiles being mapped to a feature or a feature group; and
performing the SL communication with or without the SL DRX applied at least based on the determination of whether the SL DRX is to be used for the SL communication or not.

2. The method of claim 1, wherein when the UE is a TX UE in the SL communication, the step of determining whether SL DRX is to be applied for the SL communication or not at least based on multiple associated TX profiles comprises:
determining whether the multiple associated TX profiles support the SL DRX or not; and
determining that the SL DRX is to be applied for the SL communication in response to determining that all of the multiple associated TX profiles support the SL DRX.

3. The method of claim 1, wherein when the UE is a TX UE in the SL communication, the step of determining whether SL DRX is to be applied for the SL communication or not at least based on multiple associated TX profiles comprises:
determining whether the multiple associated TX profiles support the SL DRX or not; and
determining that the SL DRX is not to be applied for the SL communication in response to determining that at least one of the multiple associated TX profiles does not support the SL DRX.

4. The method of claim 1, wherein when the UE is a Receiver (RX) UE in the SL communication, the step of determining whether SL DRX is to be applied for the SL communication or not at least based on multiple associated TX profiles comprises:
determining whether multiple TX profiles that are associated with all service types and/or L2 identifiers (IDs) of interest support the SL DRX or not; and
determining that the SL DRX is to be applied for the SL communication in response to determining that all of the multiple associated TX profiles support the SL DRX.

5. The method of claim 1, wherein when the UE is an RX UE in the SL communication, the step of determining whether SL DRX is to be applied for the SL communication or not at least based on multiple associated TX profiles comprises:
determining whether multiple TX profiles that are associated with all service types and/or L2 IDs of interest support the SL DRX or not; and
determining that the SL DRX is not to be applied for the SL communication in response to determining that at least one of the multiple associated TX profiles does not support the SL DRX.

6. The method of claim 1, wherein the SL communication is SL groupcast communication or SL broadcast communication.

7. The method of claim 1, wherein each of the multiple associated TX profiles indicates at least one of:
a unique index and/or ID associated with the communication profile;
one or more service types and/or traffic types;
one or more L2 destination IDs;
one or more L2 source IDs;
one or more indices or indicators of one or more Third Generation Partnership Project releases;
one or more SL feature groups and/or functionalities;
one or more transmission parameters;
one or more hybrid automatic repeat request (HARQ) retransmission modes;
one or more resource pool identifiers;
one or more cast types;
one or more indices and/or IDs of one or more logical channels;
one or more indices and/or IDs of one or more logical channel groups;
one or more indices and/or IDs of one or more radio bearers;
one or more service priority levels and/or traffic priority levels;
one or more Quality of Service (QoS) indicators and/or requirements; and
a priority level associated with the communication profile.

8. The method of claim 1, wherein a service type of the SL communication is mapped to at least one of the multiple TX profiles.

9. The method of claim 8, wherein the service type is at least one of:
Vehicle-to-Everything (V2X); and
Proximity Service (ProSe).

10. The method of claim 1, wherein the multiple associated TX profiles comprises at least one of:
one or more TX profiles indicated by an upper layer to an access stratum (AS) layer at the UE;
one or more TX profiles that are received by the UE from another UE for the D2D communication; and
one or more TX profiles that are received by the UE from a network node for the D2D communication.

11. A user equipment (UE), comprising:
a processor;
a memory storing instructions which, when executed by the processor, cause the processor to:
determine whether sidelink (SL) discontinuous reception (DRX) is to be applied for the SL communication or not at least based on multiple associated transmitter (TX) profiles, at least one of the multiple associated TX profiles being mapped to a feature or a feature group; and
perform the SL communication with or without the SL DRX applied at least based on the determination of whether the SL DRX is to be used for the SL communication or not.

12. A computer program comprising instructions which, when executed by at least one processor, cause the at least one processor to:
determine whether sidelink (SL) discontinuous reception (DRX) is to be applied for the SL communication or not at least based on multiple associated transmitter (TX) profiles, at least one of the multiple associated TX profiles being mapped to a feature or a feature group; and
perform the SL communication with or without the SL DRX applied at least based on the determination of whether the SL DRX is to be used for the SL communication or not.

13. (canceled)
